(19) United States
(12) Patent Application Publication
(10) Pub. No.: US 2022/0008172 A1
(43) Pub. Date: Jan. 13, 2022

(54) SYSTEMS, DEVICES, AND METHODS FOR DESIGNING AND MANUFACTURING A DENTAL IMPLANT

(71) Applicant: iDentical, Inc., Mountain View, CA (US)

(72) Inventors: Todd Wedeking, Mountain View, CA (US); Iris Wedeking, Mountain View, CA (US); Michael Collins, San Marcos, CA (US); Brian Bowman, Carlsbad, CA (US); Colin Murphy, San Diego, CA (US); David Sanderson, San Diego, CA (US)

(21) Appl. No.: 17/073,235

(22) Filed: Oct. 16, 2020

Related U.S. Application Data
(60) Provisional application No. 63/049,081, filed on Jul. 7, 2020.

(51) Int. Cl. A61C 8/00; A61C 9/00; A61C 13/34

(52) U.S. Cl. CPC A61C 8/0036; A61C 8/005; A61C 13/34; A61C 9/0053

(57) ABSTRACT

Dental implants may be designed using a three-dimensional scan of an extracted tooth root and/or a corresponding socket site. The dental implant may include a root portion designed to sit below the patient's gum line, a connector portion positioned above the root portion and designed to sit above a rim of a socket site and/or gum line, and an abutment portion positioned above the connector portion upon which a crown may be placed. The root portion may include three sections that correspond to three areas of a three-dimensional scan of an extracted tooth root. The first and third sections of the implant may have a size and shape that corresponds to a first and third portions of the three-dimensional scan, respectively. A circumference of the second section of the implant may be smaller than a corresponding circumference of the second section of the three-dimensional scan of the tooth root.

### RELATED APPLICATION

This application is a NON-PROVISIONAL of U.S. Provisional Patent Application No. 63/049,081 filed on 7 Jul. 2020 and entitled “SYSTEMS, DEVICES, AND METHODS FOR DESIGNING AND MANUFACTURING A DENTAL IMPLANT,” which is incorporated in its entirety herein.

### TECHNICAL FIELD

The invention generally relates to the field of dentistry, and more particularly to the field of dental implants. The invention further relates to the field of computer-assisted designing or machining of dental implants.

### BACKGROUND

Historically, traditional dental implants are placed within a socket site vacated by an extracted tooth after a prolonged healing phase following initial tooth extraction. During this healing phase, the bony structure of the tooth socket site is reabsorbed by the body and replaced with a layer of bone and soft tissue covering the site of tooth extraction. Because these traditional implants come in standard shapes and sizes, a drill must be used to create an appropriately-sized hole (i.e., osteotomy) within the healed-over bone to accommodate the implant. Unfortunately, the native hard and soft tissues around the socket site are not supported during this drilling process, often resulting in bone and gumline defects commonly affecting esthetics and functional aspects of the tooth gumline. In addition, this methodology requires placement of the implant into soft medullary bone, which requires significant time to fully integrate with the dental implant (i.e., osseointegration) and provide the strength and stability required for normal function. Placement of traditional implants may be achieved by screwing or press-fitting the implant into the drilled osteotomy. Following osseointegration, a permanent crown is attached to the implant via an attachable abutment.

This methodology may require long waiting and healing times between extraction of a damaged tooth, performance of the osteotomy, placement of the implant, and placement of a permanent crown for the patient. In addition, nerve damage is an inherent risk associated with drilling the required osteotomy. There remains a need for tooth replacement that overcomes many of these disadvantages.

### SUMMARY

Dental implant systems, devices, and methods for making same are herein described. An exemplary dental implant may be designed using a three-dimensional scan of an extracted tooth root. The tooth/tooth root may be extracted from a socket site and, in many cases, extraction of the tooth/tooth root is atraumatic. In some cases, the three-dimensional scan of the extracted tooth root may be modified to generate a three-dimensional model of the extracted tooth root, which may be used to design, generate, and/or fabricate the implant. At times, a length of the root portion of the implant is smaller than a length of the extracted tooth root in order to, for example, accommodate anticipated bone loss at a rim of the socket site from which the tooth was extracted.

The dental implant may include three portions: 1) a root portion designed to sit within and adjacent to the bony structure of the socket site (e.g., at and below the patient's gum line or rim of the socket site); 2) a connector, or transgingival, portion positioned above the root portion and designed to sit above rim of the socket site and within the patient's gum tissue and 3) an abutment portion positioned above the connector portion upon which a temporary and/or permanent crown may be placed. A root portion of a dental implant may be comprised of three sections that correspond to three areas of the scanned tooth root and/or the three-dimensional model of the extracted tooth root. Connector portion may include a horizontal “V”-shaped edge configured to allow gum tissue to fill into the “V”-shaped edge. When gum tissue fills into the “V”-shaped edge, the gum tissue may seal the implant within the socket site and prevent entry of pathogens or foreign material into the socket site.

In some embodiments, an abutment portion of the implant may be configured to attach to a carrier/mount for the implant via a grasping or locking mechanism on the carrier/mount. The carrier/mount may be useful in transferring the tooth from the sterile packaging to the patient's mouth or socket site whereupon it may then be removed. The abutment portion may be configured to have a mating feature with the insertion tool which may be configured to direct an impact (e.g., one or more pulses of energy/force delivered to the implant that drives the implant into the socket site) via, for example, an impact driver and/or vibrate the dental implant at a frequency (e.g., ultrasonic) as it is inserted into the socket site of a patient from which the tooth was extracted.

A topmost (when oriented with the apex of the tooth root pointing downwards), or first, section of a root portion of a dental implant may correspond to a corresponding shorted first section of a three-dimensional scan or model of the extracted tooth root, which may correspond to a section of the extracted tooth root that engages with cortical bone within the alveolar socket from which the tooth was extracted (sometimes referred to herein as “socket site”). Shortening of the first section of the three-dimensional scan may be achieved by removing a topmost (when oriented with the apex of the tooth root pointing downwards) layer (e.g., 0.5 mm-3 mm) from the three-dimensional scan of the tooth root and/or shortening the overall length of the first section by, for example, compressing the first section of the three-dimensional model by, for example, 0.05-3 mm. At times, the three-dimensional scan may be modified to remove portions that correspond to the crown of the tooth that reside above a rim of the socket site and the topmost layer of the first section of the three-dimensional scan may be the portion of the three-dimensional scan proximate to the tooth.

The first section of the root portion of the implant may be approximately 2-4 mm in length. A diameter, circumference, cross-sectional area, and/or volume of a widest area of the first section of the root portion of the implant may be larger than a corresponding diameter, circumference, cross-sectional area, and/or volume of the first section of the three-dimensional scan and/or model of the tooth root. In some embodiments, an exterior surface of the first section of the root portion of the implant may have a cortical taper relative to the native root form along the length of the first section with a largest diameter, circumference, cross-sectional area, and/or volume of the first section occurring at or near the top of the first section of the root portion of the implant and then a diameter, circumference, cross-sectional area, and/or volume of the first section of the root portion of the implant becoming gradually smaller along the length of the first section of the root portion of the implant. The cortical taper may be achieved with an orientation of part, or all, of an exterior surface of first section of the root portion of the implant at an angle (e.g., 1-8 degrees) relative to the exterior surface of second section. The second section of the implant may correspond to a middle of the extracted tooth root which may have resided within trabecular bone within the alveolar socket and below the harder cortical bone in the socket site. In some embodiments, the cortical taper may be a Morse taper.

A third section of the root portion of the implant may be positioned below the second section of the root portion of the implant at the bottom, or apex, of the implant and may have a length of approximately 2-4 mm. The third section of the root portion of the implant of the implant may have a size and shape corresponding to a third section of the three-dimensional scan and/or model of the extracted tooth root and may resides within and at the bottom of the alveolar socket. In some instances, the third section of the root portion of the implant may be configured to have a size and shape substantially similar to a bottom portion of the tooth root. Additionally, or alternatively, the third section of the root portion of the implant may be configured to provide strong anchoring between the third section of the root portion of the implant and a bottom of the socket site from which the tooth was extracted. At times, this strong anchoring may be achieved by a third section that is configured to closely, if not exactly, match the dimensions and/or geometry of the corresponding section of the extracted tooth and/or socket site. In some embodiments, the third section of the root portion of the implant may be configured to have a diameter, circumference, cross-sectional area, and/or volume that is 0.1-7% smaller than a corresponding third section of the three-dimensional scan and/or model of the extracted tooth root. In some cases, the third section of the implant may be designed to mimic the shape and contours of the extracted tooth root so that it directly abuts the bottom of the alveolar socket. This may assist with anchoring the implant within the alveolar socket by providing a strong support to, for example, prevent lateral shifting of the implant.

The second section of the root portion of the implant may be positioned below the first section and above the third section of the root portion of the implant and may have a size and shape approximately corresponding to a second section of the three-dimensional scan and/or model of the extracted tooth root. A diameter, circumference, cross-sectional area, and/or volume of the second section of the root portion of the implant may be smaller than a corresponding diameter, circumference, cross-sectional area, and/or volume of the second section of the three-dimensional scan and/or model of the tooth root. In some instances, the second section of the root portion of the implant may have a diameter, circumference, cross-sectional area, and/or volume that is 3-7% smaller than a corresponding second section of the three-dimensional scan and/or model of the extracted tooth root.

In some embodiments, a length of the second section of the root portion of the implant may vary depending on a length of the extracted tooth root and, in many cases, may correspond to a length of the extracted tooth root minus the length of the first section of the root portion of the implant (2-4 mm) and the length of the third section of the root portion of the implant (2-4 mm). In some cases, a length of the second section of the root portion of the implant may also be shortened to accommodate anticipated cortical bone loss at the upper edge of a socket site following extraction.

In some embodiments, the dental implant may include a plurality of retentive elements positioned on an exterior surface of, for example, the second section of the root portion of the implant. In some cases, the retentive elements may be configured to engage with, for example, lamina dura and/or trabecular bone present in a socket site of a patient from which the tooth was extracted when the dental implant is positioned within the socket site. The retentive elements may have, for example, a circular, triangular, trapezoidal, and/or teardrop shape. The retentive elements may be arranged in, for example, linear, random, columnal, and/or spiral fashion along a length or area of, for example, the second section of the root portion of the implant.

Exemplary methods for designing a dental implant may include receiving a three-dimensional scan of an extracted tooth root and generating a three-dimensional model of the extracted tooth root using the three-dimensional scan. The three-dimensional model of the tooth root may be partitioned to include a first section corresponding to an upper portion of the tooth root, a second section corresponding to a portion of the tooth root below the first section, and a third section corresponding to a portion of the tooth root below the second section and a bottom portion of the three-dimensional scan of tooth root.

A modified three-dimensional model of the extracted tooth root may then be generated by, for example, modifying the three-dimensional model so that a diameter, circumference, cross-sectional area, and/or volume of a widest portion of the first section is larger than a corresponding diameter, circumference, cross-sectional area, and/or volume of the three-dimensional scan of the corresponding section of the tooth root and modifying the three-dimensional model so that a diameter, circumference, cross-sectional area, and/or volume of the second section is smaller than a corresponding diameter, circumference, cross-sectional area, and/or volume of the corresponding three-dimensional scan of the tooth root, wherein the diameter, circumference, cross-sectional area, and/or volume of the third section may remain unchanged. The modified three-dimensional model of the extracted tooth root may then be converted into a design specification for the dental implant. The design specification may also include a design for a connector portion positioned above the root portion of the implant and an abutment portion of the implant to be positioned above the connector portion of the implant. The design specification for the dental implant may then be formatted into a format compatible with an implant fabrication tool like implant fabrication tool 1630 and the formatted design specification for the dental implant may be communicated to the implant fabrication tool.

In some cases, generating the modified three-dimensional model may include adding a plurality of retentive elements to the second section of the modified three-dimensional model. The retentive elements may be configured to engage with and/or be proximal to the bony walls present in a socket site of a patient from which the tooth was extracted.

In some embodiments, generating the modified three-dimensional model may include removing irregularities (e.g., fragments of tissue, irregularities in tooth surface, hooked portions of the tooth root, etc.) in a shape of the three-dimensional model so that, for example, the root portion of the model has a smooth, or nearly smooth, exterior surface prior to placement of retentive elements (if using).

In some embodiments, generating the modified three-dimensional model may include configuring an exterior surface of the first section, or a portion thereof (e.g., the mesial side, the distal side, the lingual side, and/or the buccal side) to have a taper (which may be referred to herein as a “cortical taper”) relative to the walls of the corresponding section of the three-dimensional model of the tooth root scan, along its length, where the widest portion of the taper (i.e., portion of the implant with the largest cross-sectional area) may be positioned at, or near, the top of the first section and the width of the taper may gradually narrow along the length of the taper. This taper may be configured to increase a cross-sectional area of the modified three-dimensional model at the top of the modified three-dimensional model so that relative dimensions of the modified three-dimensional model are increased in cross-sectional area relative to the original three-dimensional scan of the extracted tooth root. The taper may be configured to directly abut and, in some cases, slightly push into, the cortical bone positioned at the top of the socket site, thereby forming a tight seal between the implant and the socket site that, in some cases, may serve to lock the implant in place. Additionally, or alternatively, the taper may be configured to anchor the implant in the socket site so that it does not move when, for example, the patient chews or moves his or her jaw.

In some embodiments, generating the modified three-dimensional model may include configuring a series of grooves or ridges on an exterior surface of the first section, or a portion thereof (e.g., the mesial side, the distal side, the lingual side, and/or the buccal side). The grooves or ridges may be configured to provide additional engagement between the bone and implant, thereby forming a tight seal between the implant and the socket site that, in some cases, may additionally serve to lock the implant in place. Additionally, or alternatively, the grooves or ridges may be configured to anchor the implant in the socket site so that it does not move when, for example, the patient chews or moves his or her jaw.

Additionally, or alternatively, generating the modified three-dimensional model may include configuring an upper surface of the first section of the root portion of the implant for acceptance of and/or integration with a connector portion, which may be configured for acceptance of and/or integration with an abutment portion. In many instances, the connector and abutment portions are integrated into the implant model so that the root portion, connector portion, and abutment portion of the implant may be fabricated as one piece where the first portion may be inserted into a socket site, the second portion may be positioned within the patient's gums and part or all of the third portion may be positioned above the gums and may be used to attach a prosthetic, crown or other restorative device.

Additionally, or alternatively, generating the modified three-dimensional model may include determining an expected change in a length (or depth) of a socket site of a patient from which the tooth was extracted. This change may be due to bone loss at an upper edge, or rim, of the socket site that may be caused by, for example, an inflammatory response of the body following the extraction of the tooth root. A size and shape of the root portion of the implant may be responsive to the expected change in the size and/or shape of the socket site.

In some embodiments, generating the modified three-dimensional model may include determining a feature of a socket site of a patient from which the tooth was extracted wherein the modified three-dimensional model is responsive to the feature of the socket site. Additionally, or alternatively, generating the modified three-dimensional model may include adjusting a diameter, circumference, cross-sectional area, and/or volume of the second section so that it has a diameter, circumference, cross-sectional area, and/or volume that is 3-7% smaller than a corresponding diameter, circumference, cross-sectional area, and/or volume of the three-dimensional scan of the tooth root. Additionally, or alternatively, generating the modified three-dimensional model may include adjusting a diameter, circumference, cross-sectional area, and/or volume the third section to have a diameter, circumference, cross-sectional area, and/or volume that is 0.1-7% smaller than the extracted tooth root.

In some embodiments, the third section may be configured to have a size and shape substantially similar to a bottom portion of the tooth root.

A method for treating a patient who has had a tooth atraumatically extracted from a socket site may include inserting a dental implant using an implant insertion tool such as a mallet and/or a piezo-electric and/or ultrasonic energy generator. In some cases, the implant may be inserted following a period of time (e.g., 1-35 days) to allow an inflammatory response of the socket site to the atraumatic extraction to become partially, or fully, abated. A temporary crown may then be placed on the abutment portion of the implant and the temporary crown may later be replaced with a permanent crown.

The dental implant may be designed and/or manufactured using one or more methods, systems, and/or devices disclosed herein. At times, the dental implant may be designed using a three-dimensional scan of an extracted native tooth and the dental implant may include one or more retentive elements configured to engage with lamina dura present in a socket site of a patient from which the tooth was extracted when the dental implant is positioned within the socket site and, in some instances, the retentive elements may be arranged in a spiral pattern or configuration along the length of the dental implant. In some instances, a portion of the dental implant (e.g., around a circumference of an upper, or first, portion of the dental implant) may have a taper relative to the corresponding surface of the three-dimensional root scan that may be configured to improve retention of the dental implant within the socket site.

In some embodiments, a dental implant may be designed by, for example, a computer, processor that may be running, for example, a computer-assisted design (CAD) program that may be capable of designing dental implants and/or specifically configured to design dental implants according to one or more methods disclosed herein. For example, a dental implant may be designed following receipt of a three-dimensional scan of an extracted tooth. Often times, the tooth is extracted via an atraumatic extraction. The three dimensional scan may be used to generate a preliminary three-dimensional model of the extracted tooth. The preliminary three-dimensional model may include a first section corresponding to an upper portion of a tooth root of the extracted tooth, and a second section corresponding to a portion of the tooth root below the first section. At times, the preliminary three-dimensional model may further comprise a third section corresponding to a portion of the tooth root below the second section and a bottom portion of the three-dimensional scan of the extracted tooth.

A modified three-dimensional model of the tooth root may then be generated adding a relative taper to the first section and reducing one or more cross-sectional areas of the preliminary three-dimensional model along the second section by removing a predetermined volume from the second section at a facial/buccal side of the preliminary three-dimensional model, so that a cross-sectional area of the second section of the modified three-dimensional model is smaller than a corresponding cross-sectional area of the preliminary three-dimensional model.

In some embodiments, generating the modified three-dimensional model may include removing areas of the three-dimensional scan corresponding to portions of the extracted tooth above the tooth root and/or removing a top portion of the preliminary three-dimensional model so as to shorten a distance from a bottom of the preliminary three-dimensional model to a top of the preliminary three-dimensional model. This shortening may serve to, for example, remove portions of the preliminary three-dimensional model that do not correspond to the extracted tooth root (i.e., the tooth or a portion thereof that extends from the rim of the socket site).

In some embodiments, generation of the modified three-dimensional model may include adding an abutment above the first section, the abutment may be configured to cooperate with a dental crown by, for example, being an interface between the dental implant the dental crown. The abutment may be configured to facilitate attachment of the dental crown thereto via, for example, a chemical and/or mechanical bond.

Additionally, or alternatively, the modified three-dimensional model may further comprise adding a connector portion to an upper portion (e.g., edge) of the first section. The connector portion may be positioned between the first section and the abutment. At times, the connector portion may have shape and/or position configured to facilitate healing of the socket site and/or gum tissue surrounding the socket site and/or configured to facilitate retention of the dental implant in the socket site.

In some instances, the connector portion comprises a lower connector section and an upper connector section. In these instances, adding the connector portion modified three-dimensional model may include positioning the lower connector portion on top of the first section and positioning the upper connector portion on top of the lower connector portion. In some instances, a cross-sectional area of the lower connector section may be gradually reduced along the first length from a bottom of the lower connector section to a top of the lower connection section and the upper connector portion may extend upwards from the lower connector portion by a second length to form the upper connector section, wherein a cross-sectional area of the upper connector section is gradually increased along the second length from a bottom of the upper connector section to a top of the upper connector section. In some cases, the first length and the second length are the same.

In some embodiments, a plurality of retentive elements may be positioned on an exterior surface of the second section of the modified three-dimensional model of the first portion of the implant. The retentive elements may have, for example, a circular, triangular, trapezoidal, scallop, and/or teardrop shape and, in some instances, may be arranged in a spiral configuration along a length of the second section. In instances, the retentive elements and/or an arrangement of the retentive elements may be configured to engage with and/or be proximal to lamina dura present in a socket site of a patient from which the tooth was extracted when the dental implant is positioned within the socket site.

In some embodiments, a design check of the modified three-dimensional model and/or fabrication information may be performed by, for example, comparing one or more parameters of the modified three-dimensional model against one or more parameters of a standard, or base model of a dental implant and/or recommended parameters. The design check parameters may be selected to ensure proper function of the implant during and following insertion of the implant in the socket site. For example, design parameters may be selected to ensure 1) the implant may be inserted into the socket site without, or with minimal, damage to the socket site that may lead to, for example, fracture of bone, 2) proper seating of the implant within the socket site following insertion, 3) positioning of the inserted implant will promote the healing process such as osseointegration of the implant and the socket site, and/or 4) the implant attains stable anchorage to the bone within the socket site. At times, the design check parameters may include analysis of the bone morphology of a patient via, for example, a CAT (Computerized Tomography) scan, CBCT (Cone Beam Computerized Tomography) and/or MRI (Magnetic Resonance Imaging) to determine whether the socket site may withstand the force of the implant upon insertion and/or when resident within the socket site. Additionally, or alternatively, design check parameters may include analysis of how the implant fits within the socket site to determine whether, for example, there are gaps between the socket site and the implant that may allow bacteria to enter the socket site and/or implant/bone interface. At times, the modified three-dimensional model may be modified or adjusted based on the design check so that, for example, the modified three-dimensional model complies with one or more design requirements.

Fabrication information may then be communicated to an implant fabrication tool such as a three-dimensional printer and/or milling machine. The fabrication information may comprise parameters for fabricating a dental implant that corresponds to the modified three-dimensional model. At times, the fabrication information may be generated by, for example, converting the modified three-dimensional model of the tooth root into a design specification for the dental implant and/or formatting the design specification for the dental implant into a format compatible with an implant fabrication tool.

### BRIEF DESCRIPTION OF THE DRAWINGS

FIG. 1A provides a front plan view of an exemplary root portion with identified first, second, and third sections that may be included in an implant, consistent with some embodiments of the invention;

FIG. 1B provides a front plan view of another exemplary root portion that may be included in an implant showing a taper on an exterior portion of the first section, consistent with some embodiments of the invention;

FIG. 2A1 provides a cross-section, side-view of a first exemplary retentive element, consistent with some embodiments of the invention;

FIG. 2A2 provides a front plan view of the first exemplary retentive element, consistent with some embodiments of the invention;

FIG. 2B1 provides a cross-section side-view of a second exemplary retentive element, consistent with some embodiments of the invention;

FIG. 2B2 provides a front plan view of the second exemplary retentive element, consistent with some embodiments of the invention;

FIG. 2C1 provides a cross-section side-view of a third exemplary retentive element, consistent with some embodiments of the invention;

FIG. 2C2 provides a front plan view of the third exemplary retentive element, consistent with some embodiments of the invention;

FIG. 2D1 provides a cross-section side-view of a fourth exemplary retentive element, consistent with some embodiments of the invention;

FIG. 2D2 provides a front plan view of the fourth exemplary retentive element, consistent with some embodiments of the invention;

FIG. 2E1 provides a cross-section view of a fifth exemplary retentive element, consistent with some embodiments of the invention;

FIG. 2E2 provides a front plan view of the fifth exemplary retentive element, consistent with some embodiments of the invention;

FIG. 3A provides a front plan view of another exemplary root portion that may be included in an implant that has a plurality of retentive elements positioned on an exterior surface of the exemplary implant, consistent with some embodiments of the invention;

FIG. 3B provides a front plan view of another exemplary root portion that may be included in an implant that has a plurality of retentive elements positioned on an exterior surface, consistent with some embodiments of the invention;

FIG. 3C provides a front plan view of a portion of an exemplary second section of an implant, consistent with some embodiments of the invention;

FIG. 3D provides a front plan view of a portion of an implant with three rows of projecting interlocking teardrop-shaped retentive elements that extend outward from the exterior surface of the implant interleaved with three rows of teardrop-shaped divots that extend into the exterior surface of implant portion, consistent with some embodiments of the invention;

FIG. 4A provides a front view of an exemplary implant, consistent with some embodiments of the invention;

FIG. 4B provides a top view of the exemplary implant of FIG. 4A, consistent with some embodiments of the invention;

FIG. 4C provides a cross-section view of a portion of the exemplary implant of FIG. 4A, consistent with some embodiments of the invention;

FIG. 5A provides a block diagram of an exemplary implant insertion tool, consistent with some embodiments of the invention;

FIG. 5B provides a perspective view of an exemplary carrier/mount, consistent with some embodiments of the invention;

FIG. 5C provides a perspective, side, and top view of a screw cap, consistent with some embodiments of the invention;

FIG. 6A provides a side plan view of an exemplary system that includes an implant, consistent with some embodiments of the invention;

FIG. 6B provides a side plan view of another exemplary system that includes an implant, consistent with some embodiments of the invention;

FIG. 6C provides a side plan view of another exemplary system that includes an implant, consistent with some embodiments of the invention;

FIG. 7 provides a side plan view of an exemplary implant model, consistent with some embodiments of the invention;

FIG. 8 provides a cross-sectional view of an exemplary dental implant assembly that includes an implant and a crown positioned within a socket site, consistent with some embodiments of the invention;

FIG. 9 provides a flowchart showing an exemplary process for placing an implant, consistent with some embodiments of the invention;

FIG. 10 provides a flowchart that illustrates an exemplary process for designing an implant and/or a component thereof, consistent with some embodiments of the invention;

FIG. 11A provides a cross-section image of a tooth that will be extracted via an atraumatic extraction, consistent with some embodiments of the invention;

FIG. 11B provides a cross-section image of the extracted tooth, consistent with some embodiments of the invention;

FIG. 11C provides an image of an outline of a shape of a socket site, consistent with some embodiments of the invention;

FIG. 12A is a top plan view of exemplary shaped sections that may be included in an implant, consistent with some embodiments of the invention;

FIG. 12B is a front plan view of exemplary shaped sections that may be included in an implant, consistent with some embodiments of the invention;

FIG. 13 provides an exploded and assembled view of a portion of an implant comprising three sections, consistent with some embodiments of the invention;

FIG. 14 provides perspective views of exemplary shapes for a bottom, or apical, portion of an implant, consistent with some embodiments of the invention;

FIG. 15 provides a front plan view of an implant positioned within a socket site, consistent with some embodiments of the invention;

FIG. 16 is a block diagram of an exemplary processor-based system that may store data and/or execute instructions for the processes disclosed herein, consistent with some embodiments of the present invention;

FIGS. 17A and 17B provide a flowchart that illustrates a process for designing a dental implant, consistent with some embodiments of the present invention;

FIGS. 18A-18O provide front plan views that depict a series of iterations to a model of a dental implant as may occur during an exemplary dental implant design process, consistent with some embodiments of the present invention;

FIG. 19A provides a cross section view of a tooth to be extracted from a socket site, consistent with some embodiments of the present invention;

FIG. 19B shows tooth being extracted from socket site and shows the cavity, or open space, of the socket site, consistent with some embodiments of the present invention;

FIGS. 20A-20L provide front plan views that depict a series of iterations to a model of a dental implant as may occur during an exemplary dental implant design process, consistent with some embodiments of the present invention;

FIGS. 21A-21C provide front plan views of an implant model being compared with a three-dimensional scan of an extracted tooth as part of, for example, a design check process, consistent with some embodiments of the present invention;

FIG. 22A provides a cross-section view of an implant as it is inserted into a socket site, consistent with some embodiments of the present invention;

FIG. 22B provides a cross-section view of an implant after it is inserted into a socket site, consistent with some embodiments of the present invention;

FIG. 23 illustrates a five-part process to place implant into a layer of gingiva and a socket site using a carrier/mount and an implant placement tool, consistent with some embodiments of the present invention; and

FIG. 24 illustrates a five-part process to place implant into a layer of gingiva and a socket site using a recess in abutment configured to cooperate with a component of an implant placement tool.

### DETAILED DESCRIPTION

The dental implant system and devices such as dental implants, carrier/mounts for dental implants and dental implant devices, described herein may be used to replace a failed tooth with one or more roots, such as an anterior tooth or a molar tooth. In some cases, the failed tooth may have been previously treated via a root canal and has subsequently fractured at the gum line. The implant may provide a patient with a faster, less invasive, and safer tooth replacement solution than a traditionally used drill-and-screw or press-fit dental implant and may provide similar or better results in form and/or function. The implants disclosed herein may be designed using one or more of the dental implant design process(es) disclosed herein.

In some instances, the implants described herein may be inserted into a socket site (i.e., where, in the mouth, the tooth is extracted from) in a much shorter time period than the 3.5-6 months patients typically wait between tooth extraction and placement of traditional drill-and-screw dental implants. For example, in some embodiments, the implants described herein may be placed in a socket site immediately following an atraumatic tooth extraction. In other instances, the implants described herein may be inserted into a socket site prior to significant remodeling of the lamina dura lining the socket site which typically occurs approximately 35 days post-extraction. Thus, in some instances, the implants described herein may be inserted into a socket site within, for example, 0-35 days of an atraumatic tooth extraction with most implants described herein being inserted into a socket site 7-23 days post-extraction. In some cases, an initial waiting period of 7 days or more may allow an inflammatory response of the socket site to the extraction to subside. This reduction in the inflammatory response of the socket site may facilitate easier and less painful insertion of the implant into the socket site. Insertion of the implant prior to the conclusion of 35 days may enable placement of the implant prior to reformation and/or deformation of the lamina dura (i.e., while the socket site retains its original shape), which may reduce or eliminate the need to drill, or otherwise modify, a shape of the socket site prior to placement of the implant.

The implants disclosed herein may not require an osteotomy for the reshaping of a healed over socket site prior to insertion of the implant. Instead, the implants disclosed herein are designed to fit within the existing, native socket site. In this way, the hard and soft tissue contours of the gum line are preserved, which can lead to more positive aesthetic outcomes when the final crown is placed, particularly for anterior teeth. In contrast, with traditional dental implants, the osteotomy performed following the healing of the socket site and deformation of the lamina dura causes an alteration or reformation of the hard and soft tissues of the gum line. This bone deformation may cause alteration of the gum line, which can lead to sub-optimal aesthetics, particularly for anterior teeth. Aside from preserving the hard and soft tissue contours of the gumline, placing an implant disclosed herein has many other benefits when compared with traditional screw-form dental implants including, but not limited to, avoidance of potential complications (e.g., temporary or permanent nerve injury) that may be caused by the osteotomy procedure and an ability to fit the implant with a permanent crown much sooner than with traditional screw-form implants which may enable an implant/crown combination to resume regular functionality as was formerly provided by the extracted tooth. Also, because the placement procedure for the implants described herein is often less complicated than the placement procedure for traditional screw-form implants, there is an increased possibility of having the full dental implant treatment completed in the patient's family dentist's office (as opposed to the office of a dentist who specializes in the osteotomy procedures required to place traditional screw-form implants), since more family dentists will be able to place the implants disclosed herein with minimal training due to the removal of the osteotomy from the procedure. Additionally, or alternatively, the implants disclosed herein may not require bone grafting to properly seat an implant; another potential cause of complications and increased cost to the patient.

Following insertion of the implants disclosed herein in a corresponding socket site, a temporary crown may be affixed to an abutment portion of the implant, such that the temporary crown may not be in occlusion with the teeth in the opposing arch. The implant may subsequently graft to the socket site and/or osseointegrate with the lamina dura surrounding the socket site. Once full osseointegration has occurred, the temporary crown may be replaced with a permanent crown, which is designed to be in full occlusion with the teeth in the opposing arch. The permanent crown may be affixed to an abutment portion of the implant that extends above the gum line of the socket site, and the implant, with the permanent crown attached thereto, may function similarly to the replaced native tooth root.

In some embodiments, the implants described herein may first be placed in a socket site so that the implant is manually seated approximately 70-90% within the socket site (i.e., the implant is pushed into the socket site so that the first section of the implant initially engages with the cortical bone at the rim of the socket site) by a dental professional. After being initially placed within the socket site, in some embodiments, the dental professional may apply impact, piezo-electric and/or ultrasonic vibration energy to a carrier/mount attached to the implant using an impact, piezo-electric and/or ultrasonic device. The piezo-electric and/or ultrasonic vibration may act to push the remaining 10-30% of the implant into the socket site so that, for example, the implant is fully engaged and forms tight contact with the cortical bone of the socket site so that the implant is securely fixed into the socket site. Additionally, or alternatively, the implant may be fully pushed into the socket site via a manual application of force by the dental professional via, for example, hammering of the implant into the socket site and/or patient via biting down on an attachment to the implant.

In some embodiments, the stability of an inserted implant may be sufficient to enable placement of a permanent crown thereon soon (e.g., same day, a few days, a week). This may allow the patient to, for example, chew food normally immediately post-implant insertion. In other embodiments, a temporary crown is placed on the implant the same day the implant is inserted, which is out of occlusion, such that a patient may not bite down normally on the crown and thus potentially limit the amount of force placed on the implant during the osseointegration period. Once the implant is fully integrated with the surrounding bone, which may take, for example, 8-16 weeks, a temporary crown may be replaced with a permanent crown, and a patient may chew food normally again with the replaced tooth that is in occlusion.

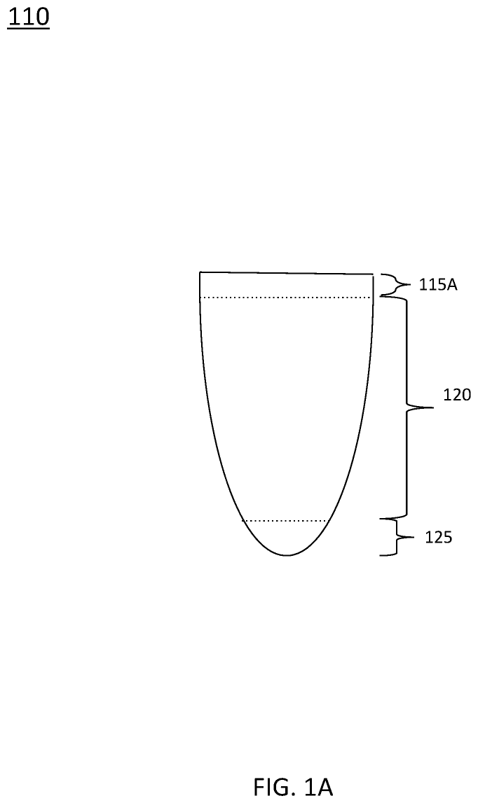

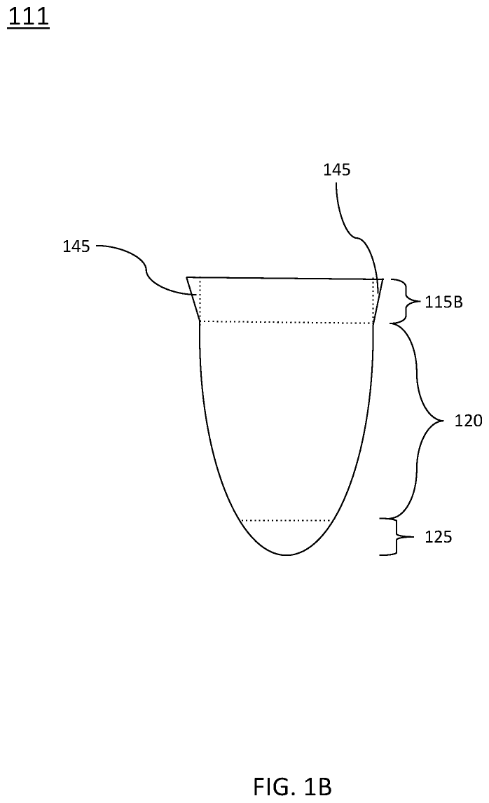

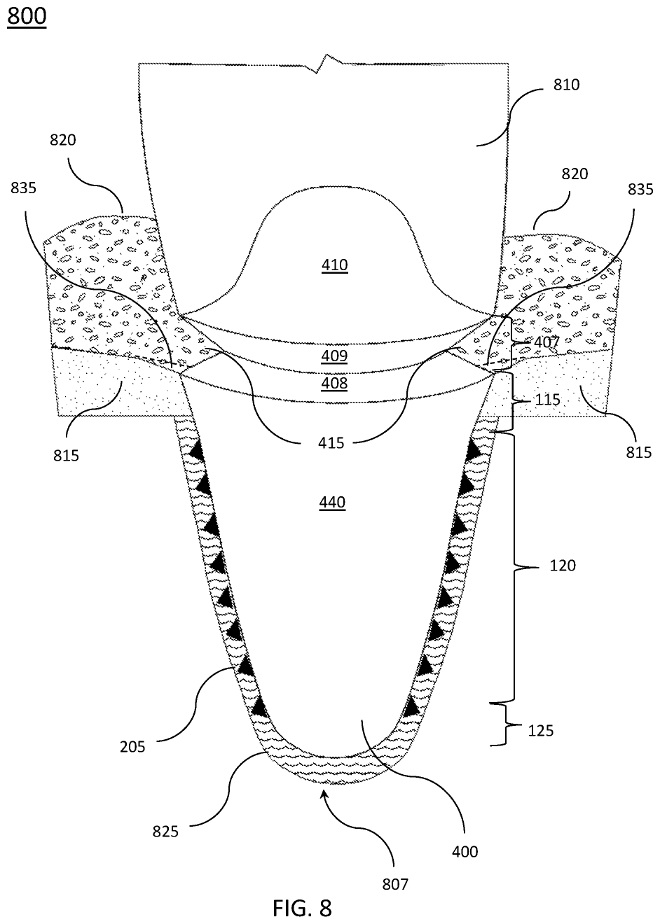

Turning now to the figures, FIGS. 1A-7 provide illustrations of exemplary implants and implant components such as retentive elements that are not in-situ and FIG. 8 provides an illustration of an exemplary implant positioned, in situ, within a socket site. An approximate shape and length of the implants may approximate, or otherwise correspond to, a shape and/or size of an extracted tooth root and/or corresponding socket site, a three-dimensional scan of the extracted tooth root and/or a three-dimensional model of the extracted tooth root.

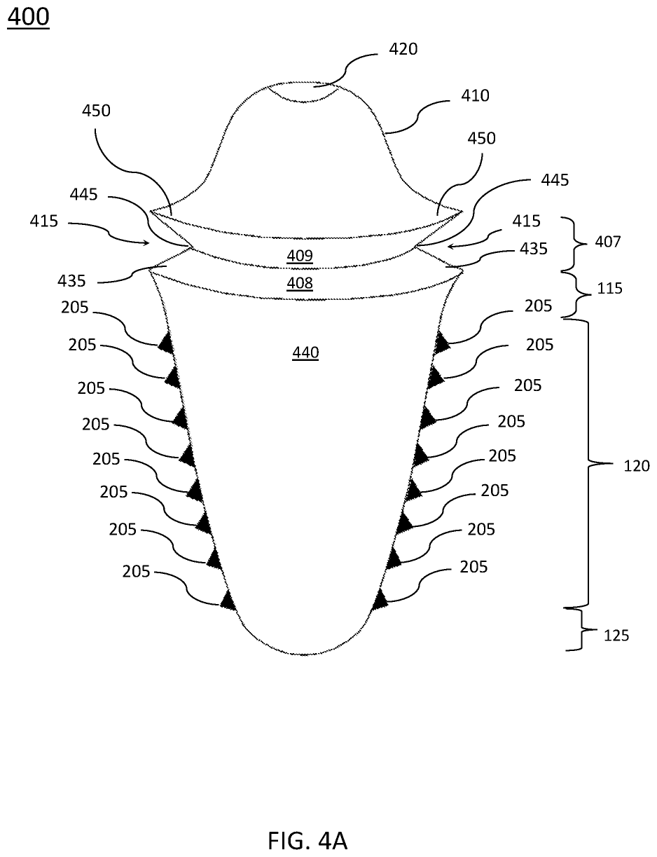

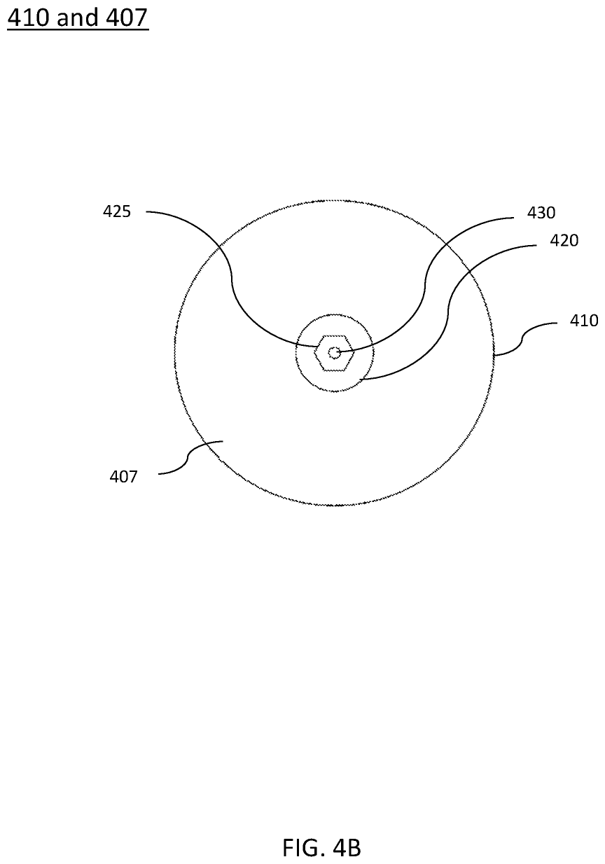

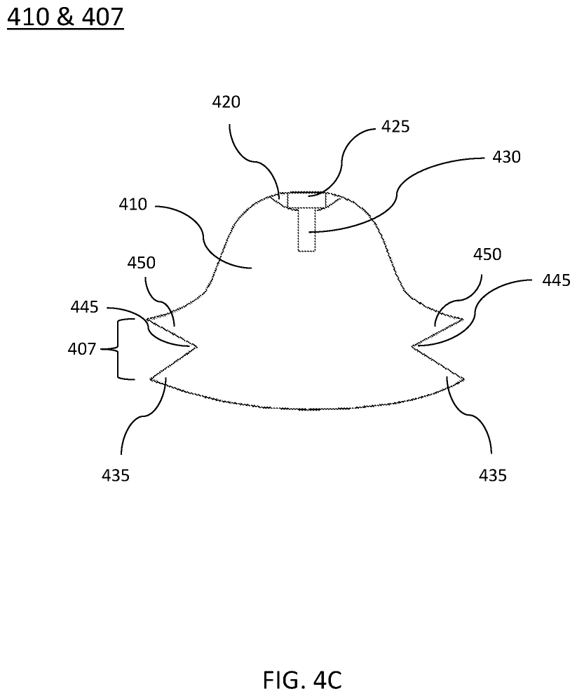

More particularly, FIG. 1A provides a front plan view of a root portion 110 of an exemplary implant. Root portion 110 may cooperate with a connector portion that resides above root portion 110 and an abutment portion that resides above the connector portion. Further details regarding connector portions and abutment portions, or abutments, are provided with regard to, for example, FIGS. 4A-4C and their respective descriptions herein.

Root portion 110 may be configured to sit entirely below the gum tissue and an upper surface of the cortical bone of a socket site as will be discussed in further detail below with reference to, for example, FIG. 8. Root portion 110 may be designed using a three-dimensional scan, a three-dimensional model, or other information (e.g., X-ray and MRI) of an extracted tooth and/or tooth root as disclosed herein. In this way, an implant may be customized to a patient and/or socket site.

Root portion 110 may include, for example, three sections or segments: a first section 115A, a second section 120, and a third section 125, with first section 115A residing at a top of root portion 110, second section 120 residing between first section 115A and third section 125, and third section 125 residing at a bottom of root portion 110. In some embodiments, first section 115A may reside below an abutment (not shown) that is configured to couple to, for example, a temporary and/or permanent crown. Additionally, or alternatively, first section 115 may reside below a connector portion (not shown) which may be resident between root portion 110 and an abutment of an implant. The connector portion may be configured to, for example, facilitate sealing of an implant within a socket site. An exemplary implant 400 that includes an exemplary abutment 410, connector portion 415, and a root portion 440 (that may be similar to root portion 110) is shown in FIGS. 4A-4C and discussed further below.

In some embodiments, root portion 110 may be configured to have a length that is less (e.g., 0.25-1 mm) than the length of the extracted tooth root and/or corresponding socket site. At times, this shortening of the length of root portion 110 may be responsive to an anticipated receding of a patient's cortical bone following extraction of his or her tooth. This shortening of the length of root portion 110 may allow for section 115A to be configured to sit entirely below the gum tissue following the patient's healing from the tooth extraction and subsequent receding of the cortical bone. Additionally, or alternatively, configuring section 115A to sit entirely below the gum tissue may serve to reduce a likelihood that the gum tissue will become irritated by root portion 110, which may reduce the risk of inflammation and/or bacterial infection that may be caused by an interaction of root portion 110 with gum tissue, which can lead to discomfort for the patient and/or implant failure. If a portion of root portion 110 sits within and/or above the gum tissue, an interface between the gum tissue and root portion 110 may provide a breeding ground for bacteria or other irritants that may cause the gum tissue to become infected and/or inflamed, which may lead to subsequent implant failure. By configuring section 115A to sit entirely below the gum tissue the possibility of inflammation and/or infection caused by interaction of the gum tissue and root portion 110 is reduced.

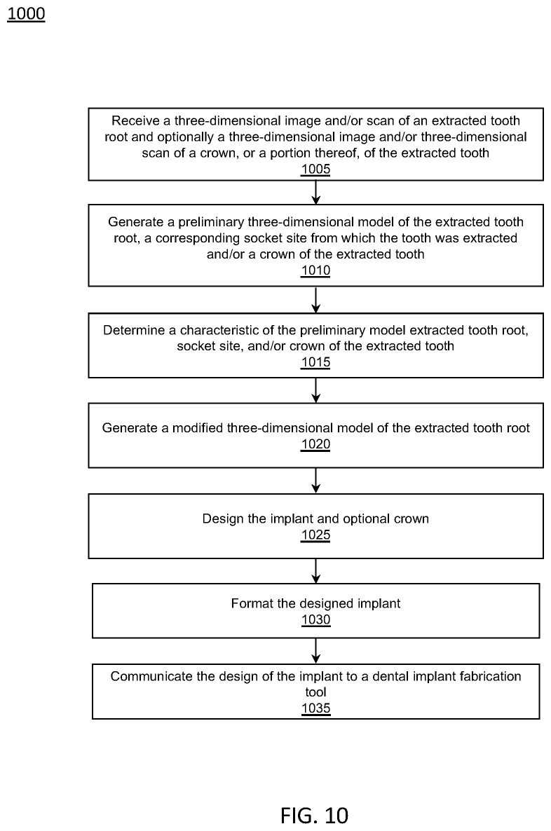

In some instances, root portion 110 and/or a portion thereof may not be an exact replica of the extracted tooth root and/or a three-dimensional scan of the extracted tooth root. For example, root portion 110, or a portion thereof, may be designed so that it does not include native tooth irregularities, protrusions, and/or depressions that may make it difficult to insert the root portion 110 into a socket site and/or may impede osseointegration of root portion 110 to the socket site. Further details regarding this design process are provided below with regard to FIG. 10 and the associated discussion.

In some embodiments, a diameter, circumference, cross-sectional area, and/or volume of first section 115A may be configured to be larger (e.g., 0.01-3% larger) than the native, extracted tooth root and/or corresponding socket site. Enlargement of first section 115A may be configured to occupy/fill in space previously occupied by the periodontal ligament that attached the native tooth root to the lamina dura prior to extraction so that first section 115A of the root portion 110 may form an extremely tight fit within the socket site. Additionally, or alternatively, the circumference and/or diameter of section 115A may be configured to abut and/or contact the cortical bone of the socket site, which may assist with achieving implant stability.

In some embodiments, the second section 120 may be configured to have a diameter, circumference, cross-sectional area, and/or volume that is smaller (e.g., 3-7%) than the native, extracted tooth root and/or corresponding socket site. This decrease in diameter, circumference, cross-sectional area, and/or volume may, for example, facilitate insertion of root portion 110 and/or an implant including root portion 110 into the socket site and may allow for blood to enter the space between root portion 110 and the lamina dura of the socket site, which may facilitate healing of the socket site and adhesion of implant to the socket site.

Third section 125 may be configured to be proximate to, coincident with, and/or touch a bottom, or apex, of the socket site. In some embodiments, third section 125 may be configured to taper (or reduce its diameter, circumference, cross-sectional area, and/or volume along its length) so that, for example, the very bottom of the implant is approximately the same size and/or shape as a corresponding portion of the bottom of the socket site. Third section 125 may be further configured to provide strong engagement between the third section 125 and the lamina dura at the bottom of the socket site. Engagement between third section and the lamina dura at the bottom of the socket site may, for example, facilitate stability for an implant including third section 125 when it is inserted into the socket site and assist with osseointegration of the root portion 110 and/or an implant including root portion 110. In addition, seating an implant including root section 110 and/or third section 125 may prevent damage to the socket site and/or damage to tissue positioned proximate to the socket site (e.g., nerve or bone) because when a dental professional inserts an implant including root portion 110 and/or third section 125, he or she may push the implant into the socket site until the lamina dura at the bottom of the socket site is reached but, in most cases, will not push through or breach the lamina dura of the socket site to seat the implant in the socket site. This preserves the integrity of the lamina dura and socket site. This is in contrast with the insertion of traditional implants (e.g., drill and screw implants) because placement of these traditional implants requires osteotomy or drilling into softer medullary bone to create an appropriately-sized hole for the insertion of the traditional implant. However, there is a risk that when the traditional implant is seated into the appropriately-sized hole, it will be pushed too far into the medullary bone and come into contact with a nerve, which may cause nerve injury.

In some embodiments, third section 125 may have a volume that is smaller (e.g., 0.1-7% smaller) than the extracted tooth and/or socket site. At times, in some embodiments, a portion of an extracted tooth root corresponding to third section 125 may have one or more irregularly shaped portions and/or extensions (e.g., a bulbous root tip or a curved root tip). Third section 125 may be designed to remove these irregularly shaped portions and/or extensions to, for example, facilitate easier insertion of the implant and/or osseointegration with the socket site.

FIG. 1B provides a front plan view of another exemplary root portion 111. Like root portion 110, root portion 111 includes a first section 115B, second section 120, and third section 125. Root portion 111 is similar to root portion 110 except that an exterior surface of first section 115B is tampered with, for example, a cortical taper along the length of the first section so that an exterior surface of first section 115B is oriented at an angle 145 (e.g., 1-8 degrees) relative to the exterior surface of second section 120. In some embodiments, angle 145 may facilitate a strong fixation between root portion 111 and a ridge of cortical bone 415 along the top of the socket site as shown in FIG. 8. This fixation of root portion 111 and the cortical bone may contribute to lateral stability and retention for root portion 111 within the socket site, which may thereby protect against the lateral compressive loading on root portion 111 when, for example, the patient is chewing.

In some embodiments, one or more dental implants described herein may include one or more retentive elements positioned on the root portion thereof. A retentive element may be a projection that extends outwardly from a surface of a root portion like root portion 110 and/or 111 and/or a depression, or divot, that extends inwardly into the surface of a root portion of an implant like root portion 110 and/or 111. Retentive elements, whether they project from, or into, an implant, may be configured to enhance the stability of an implant within a socket site after osseointegration and/or a patient's bone or otherwise enhance stability of the implant with the socket site and/or increase stability of an inserted implant. In some embodiments, a root portion like root portion 110 and/or 111 and/or a retentive element may include a surface texturing or coating that may facilitate osseointegration of bone to the respective retentive element and/or root portion of the implant. For ease of discussion projecting retentive elements and depression or divot retentive elements may be herein referred to simply as “retentive elements”

Retentive elements may be of any appropriate shape including, but not limited to, scales, barbs, hooks, ribs, and/or spikes. In some embodiments, the retentive elements may facilitate engagement of the implant with the bone within a socket site to, for example, facilitate retention of the implant in the socket site, which may, for example, improve initial and/or long-term stability of the implant within the socket site. In some embodiments, a retentive element may be configured to allow for intimate engagement of an implant with the lingual/palatal side of the socket site and may further be configured to lock the implant into the lingual/palatal side of the socket site, which may assist with stabilization of the implant and may prevent shifting of an implant toward a buccal/facial side of the socket site. At times, projecting retentive elements and divot retentive elements may cooperate with one another so that bone that is shifted by a projecting retentive element may be redirected to a proximate divot, or depressive, retentive element when, for example, the implant is pushed into a socket site and/or during the healing process. This repositioning of displaced bone may foster greater engagement of the implant with the socket site by, for example, fostering osseointegration.

Retentive elements may have dimensions of length, width, and height, with length describing the distance from the topmost point to the bottommost point, width describing the distance across from the leftmost point to the rightmost point and height describing the distance from the surface of root portion 110 and/or 111 to the outermost point the retentive element extends outwardly away from root portion 110 and/or 111. Exemplary dimensions of retentive elements are 0.25-5 mm in length, 0.25-3 mm in width, and 0.25-1 mm in height. In some cases, retentive elements larger than 3 mm in length/width and 1 mm in height may cause too much friction with the lamina dura during insertion which may damage the lamina dura and/or and make insertion of the implant difficult; both of which may lead to socket site inflammation. When the lamina dura is inflamed, there is an increase in osteoclastic activity (process of breaking down bone), which can inhibit osseointegration of the implant and thus may increase a risk of implant failure.

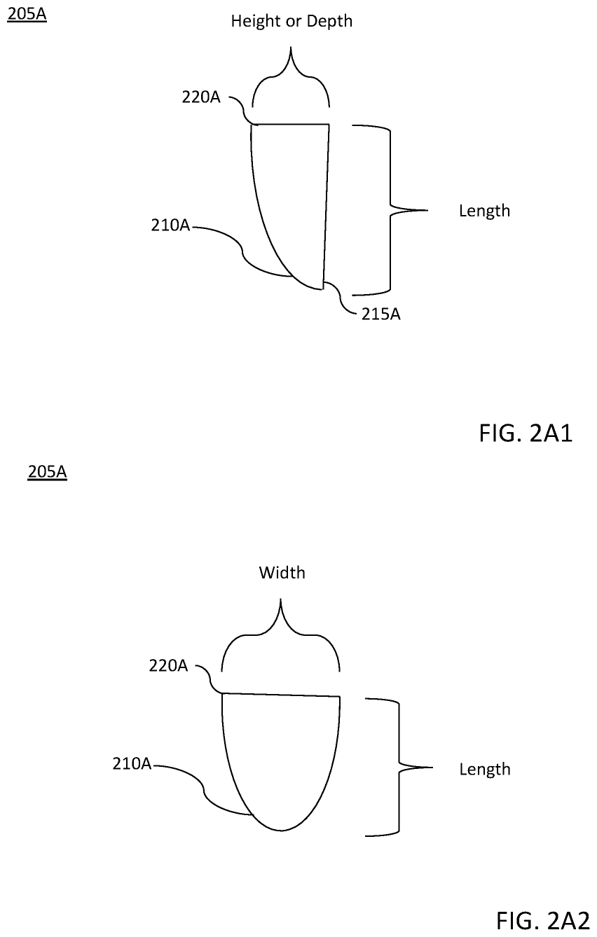

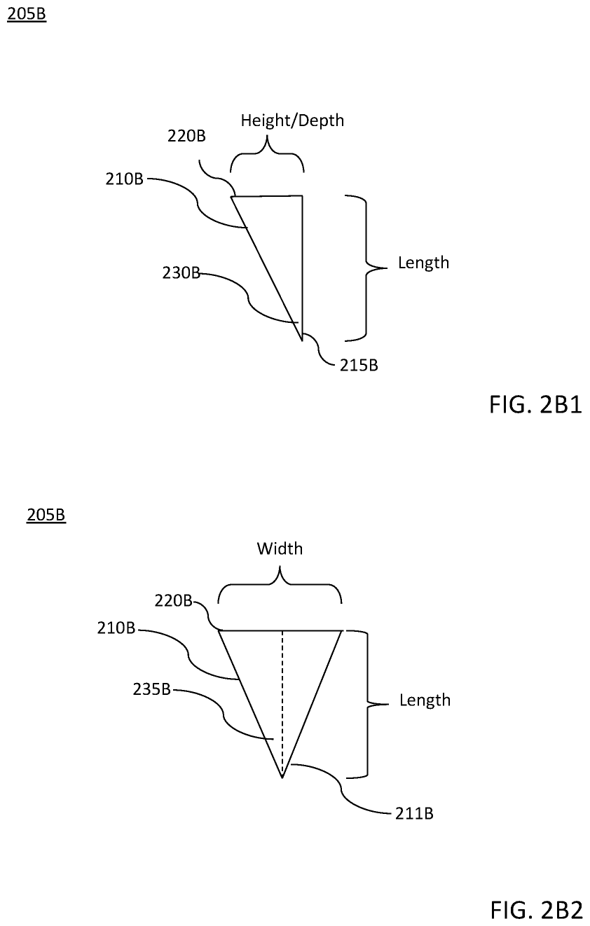

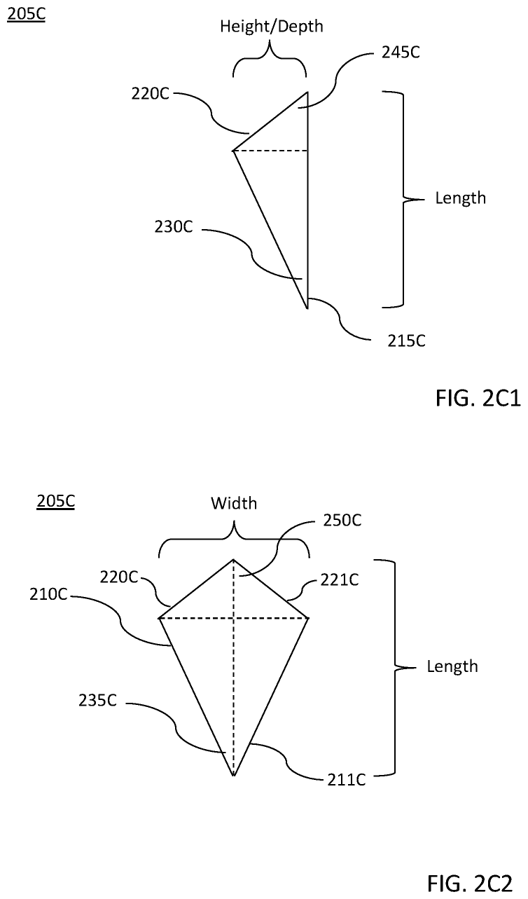

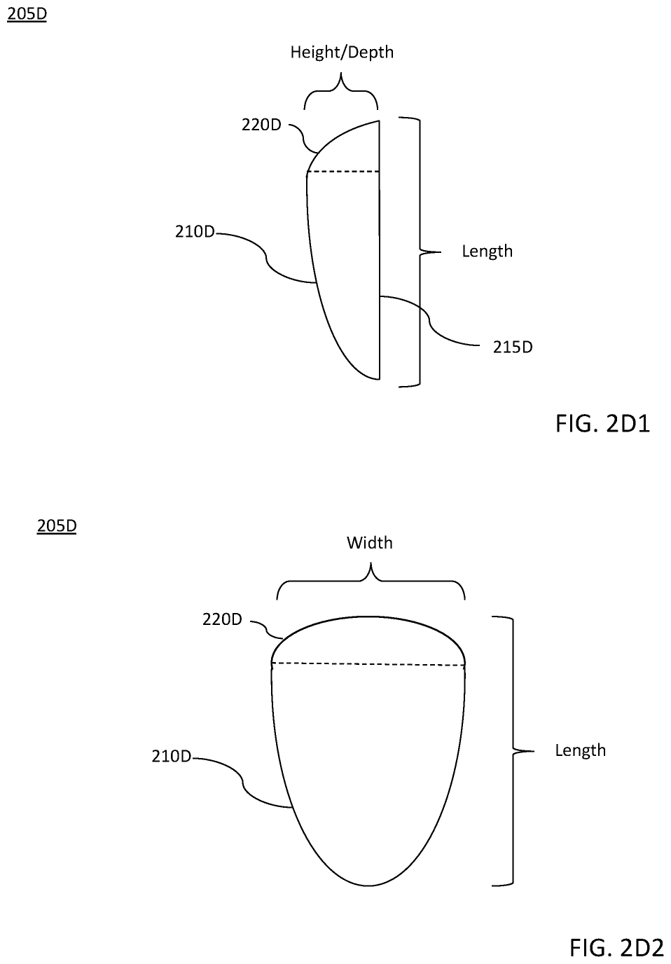

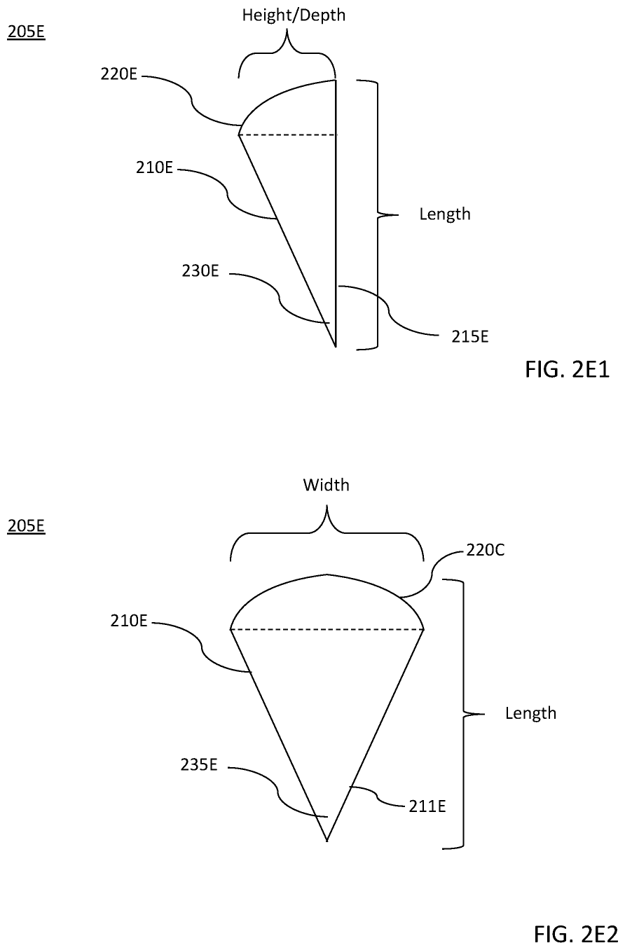

In some embodiments, the retentive elements may be sized and/or shaped such that they may allow for easy insertion into the socket site and may be of any appropriate shape and/or size. Five exemplary retentive element shapes are provided by FIGS. 2A1, 2A2, 2B1, 2B2, 2C1, 2C2, 2D1, 2D2, 2E1 and 2E2, respectively wherein FIG. 2A1 provides a cross-section view of a first exemplary retentive element 205A, FIG. 2A2 provides a front plan view of the first exemplary retentive element 205A, FIG. 2B1 provides a cross-section view of a second exemplary retentive element 205B, FIG. 2B2 provides a front plan view of the second exemplary retentive element 205B, FIG. 2C1 provides a cross-section view of a third exemplary retentive element 205C, FIG. 2C2 provides a front plan view of the third exemplary retentive element 205C, FIG. 2D1 provides a cross-section view of a fourth exemplary retentive element 205D, FIG. 2D2 provides a front plan view of the fourth exemplary retentive element 205D, FIG. 2E1 provides a cross-section view of a fifth exemplary retentive element 205E, and FIG. 2E2 provides a front plan view of the fifth exemplary retentive element 205E. The retentive elements 205 disclosed herein may extend out from an exterior surface of an implant as a projection and/or may be depressed into an exterior surface of an implant as a divot. The discussion of 2A1, 2A2, 2B1, 2B2, 2C1, 2C2, 2D1, 2D2, 2E1 and 2E2 below refers to a back of a retentive element 215. It will be understood that the back of any retentive element refers to a surface of the retentive element that aligns with an exterior surface of the implant, whether that retentive element projects from the surface of the implant or is depressed into the surface of the implant. Stated differently, the “back” of a retentive element that is a divot refers to the portion of the retentive element/divot where the surface of the implant begins to curve inward to form the divot.

First retentive element 205A is shaped like a truncated ellipse with a lower curved portion that extends out from or in to an exterior surface in three dimensions as shown in the cross section of FIG. 2A1 and a flat upper edge 220A. An edge 210A of the lower curved portion of first retentive element 205A may have a truncated elliptical shape and a top 220A that is substantially perpendicular to a central axis of first retentive element 205A. Back 215A may be configured to abut, extend from, or otherwise be coincident with, a root portion like root portion 110 and/or 111. First retentive element 205A may have a length of 0.25-2 mm, a width of 0.25-3 mm, and a height and/or depth of 0.25-5 mm at its apex.

In some embodiments, first retentive element 205A may be configured to enable easy insertion of an implant into a socket site and flat upper edge of first retentive element 205A may be configured to prevent removal of an inserted implant by, for example, fostering engagement with the lamina dura of the socket site.

As shown in FIGS. 2B1 and 2B2, second retentive element 205B has a truncated-diamond shape with a flat upper edge 220B that extends out from or in to an exterior surface in three dimensions. The truncated-diamond shape of second retentive element 205B may be configured to enable easy insertion of an implant into a socket site and flat upper edge of second retentive element 205B may be configured to prevent removal of an inserted implant by being configured to, for example, engage with the lamina dura of a socket site in a manner that makes removal of the implant from the socket site difficult.

Second retentive element 205B may have a length of 0.25-2 mm, a width of 0.25-3 mm, and a height and/or depth of 0.25-5 mm at its apex. Second retentive element 205B has a top 220B, a left side 210B and a right side 211B and a back 215B. Back 215B may be configured to abut, or otherwise be coincident with, a root portion like root portion 110 and/or 111. Left and right sides 210B may extend outward from the lowermost point of second retentive element 205B at an angle 235B of 4-30 degrees between the left and right sides 210B and 211B relative to one another and at an angle 235B of 5-40 degrees relative to back 215B.

Third retentive element 205C is shaped like a diamond with a lower and an upper triangularly-shaped portion both of which extends out from or in to an exterior surface in three dimensions out in three dimensions as shown in FIG. 2C1. Lower triangularly-shaped portion of third retentive element 205C may be configured to enable easy insertion of an implant into a socket site and the upper triangularly-shaped portion of third retentive element 205C may be configured to facilitate removal of an inserted implant.

Third retentive element 205C may be 0.25-3 mm in length with the upper portion being 0.25-3 mm in length and the lower portion being 0.25-3 mm in length. An exemplary width for third retentive element 205C is 0.25-3 mm at its apex and an exemplary height and/or depth for third retentive element 205C is 0.25-5 mm at its apex.

Third retentive element 205C has a left top side 220C, a right top side 221C, a left lower side 210C, a right lower side 211C, and a back 215C. Back 215C may be configured to abut, extend out from, or into, an exterior surface in three dimensions, or otherwise be coincident with, a root portion like root portion 110 and/or 111. Left and right upper sides 220C and 221C may extend out from, and/or into an exterior surface of an implant in three dimensions from the upper-most point of third retentive element 205C at an angle 250C of 40-80 degrees between the left and right upper sides 220C and 221C relative to one another and at an angle 245C of 5-40 degrees relative to back 215C. Left and right lower sides 210C and 211C may extend outward from the lowermost point of second retentive element 205C at an angle 235C of, for example, 4-30 degrees between the left and right sides 210C and 211C relative to one another and at an angle 235B of 5-40 degrees relative to back 215C.

Fourth retentive element 205D is shaped like an irregular oval with a lower, larger portion and an upper smaller portion, both of which extend out from or into an exterior surface of an implant in three dimensions as shown in FIG. 2D1. Lower curved portion of second retentive element 205D may be configured to enable easy insertion of an implant into a socket site and the upper curved portion of fourth retentive element 205D may be configured to facilitate removal of an inserted implant. Back 215D may be configured to abut, extend from, or otherwise be coincident with, a root portion like root portion 110 and/or 111.

Fourth retentive element 205D may be 0.25-3 mm in length with the upper portion being 0.25-3 mm in length and the lower portion being 0.25-3 mm in length. An exemplary width for fourth retentive element 205D is 0.25-3 mm at its apex and an exemplary height and/or depth is 0.25-5 mm at its apex.

Fifth retentive element 205E has a truncated diamond-shaped lower portion and a curved upper portion that extends out from or into an exterior surface of an implant in three dimensions as shown in FIG. 2E1. Lower truncated diamond-shaped portion of fifth retentive element 205E may be configured to enable easy insertion of an implant into a socket site and the upper curved portion of fifth retentive element 205E may be configured to facilitate removal of an inserted implant.

Fifth retentive element 205E may be 0.25-3 mm in length with the upper portion being 0.25-3 mm in length and the lower portion being 0.25-3 mm in length. An exemplary width for fifth retentive element 205E is 0.25-3 mm at its apex and an exemplary height and/or depth for fifth retentive element 205E is 0.25-5 mm at its apex. Fifth retentive element 205E has a top 220E, a left lower side 210E, a right lower side 210E, and a back 215E. Back 215E may be configured to abut, extend from, or otherwise be coincident with, a root portion like root portion 110 and/or 111. Left and right lower sides 210E and 211E may extend outward from the lowermost point of second retentive element 205E at an angle 235E of 4-30 degrees between the left and right sides 210E relative to one another and at an angle 235E of 5-40 degrees relative to back 215E.

One or more retentive elements like retentive elements 205A, 205B, 205C, 205D, and/or 205E may be positioned on and/or extends out from or into an exterior surface of an implant and/or a root portion like root portion 110 and/or 111. Retentive elements may be positioned in any arrangement (e.g., rows, columns, randomly, pseudo-randomly, etc.) on the exterior surface of an implant. For example, retentive elements may be positioned in columns that span the full length of second section 120 of a root portion like root portion 110 or 111, or in rows (like rings) that span a portion and/or the full circumference of second section 120 of a root portion like root portion 110 or 111, or in a spiral arrangement positioned on an exterior surface of second section 120 of a root portion like root portion 110 or 111, and/or in randomized positions throughout the surface area of the second section 120 of a root portion like root portion 110 or 111. Further, the size, shape and/or spacing of retentive elements may vary.

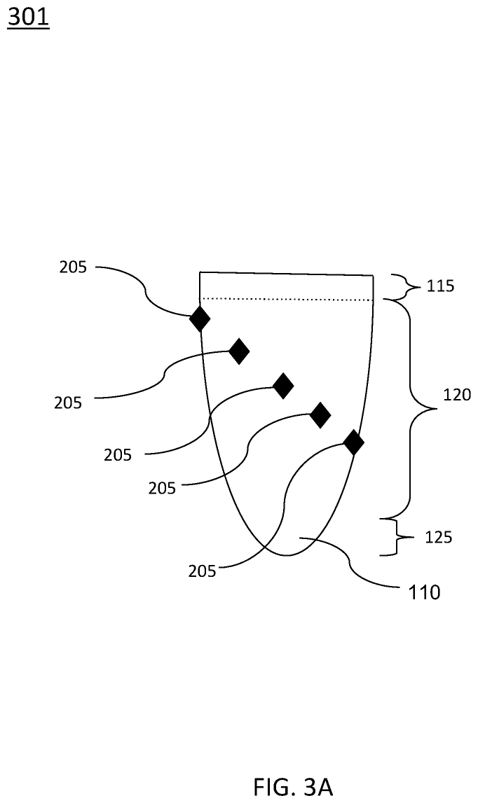

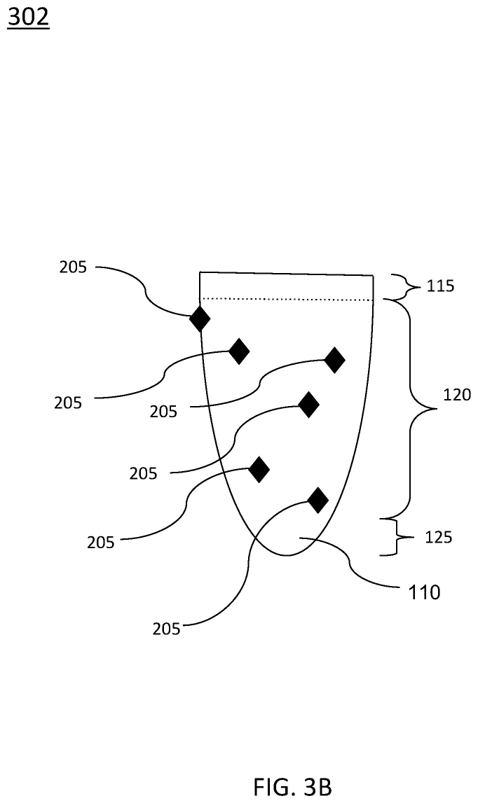

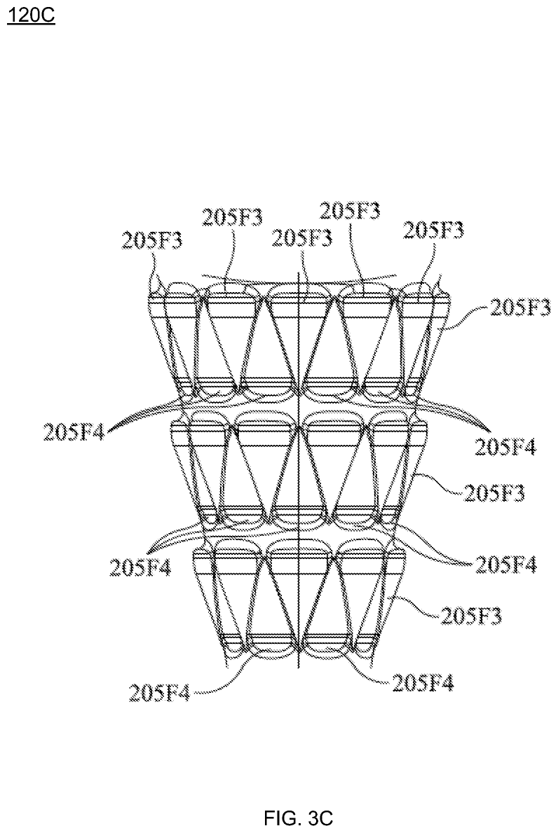

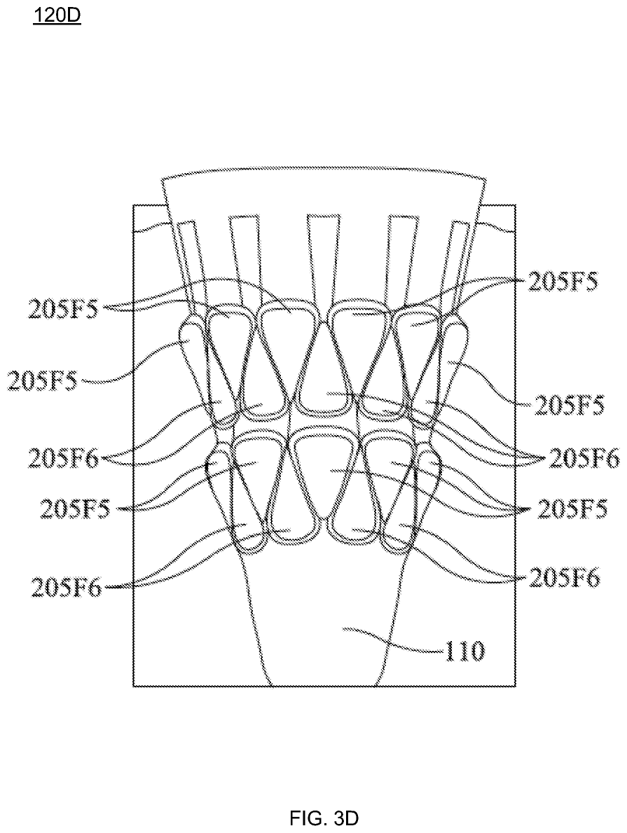

FIG. 3A provides a front plan view of a root portion 301. Root portion 301 is similar to root portions 110 and/or 111 as described herein and may have a cortical taper. Unlike root portions 110 and 111, root portion 301 has a plurality of retentive elements 205 that extend out from an exterior surface of the second section 120 of root portion 301 in an exemplary spiral-like arrangement. The spiral-like arrangement of retentive elements 205 shown in FIG. 3A may facilitate insertion of root portion 301 into a socket site that preserves the lamina dura (e.g., does not damage, or otherwise abrade against, the lamina dura) for each individual retentive element. For example, in some instances when two or more retentive elements 205 are positioned in a vertical column, when the implant, or root portion thereof, is inserted in the socket site, a lower positioned retentive element 205 that extend outward from the surface of an implant may scrape into the lamina dura, and a retentive element 205 positioned directly above it may have less bone to engage in. In contrast, when the retentive elements are positioned in a spiral configuration that wraps around the circumference of a section of a root portion of an implant as shown in FIG. 3A, each retentive element 205 that extends outward from the surface may have a unique opportunity to engage with the lamina dura as the implant, or root portion thereof, is inserted in the socket site. In this way, engagement of a retentive element 205 with the lamina dura may not be compromised or decreased by the path of insertion of a retentive element preceding it. In addition to, or alternatively, the height and/or depth of the retentive elements may gradually decrease along the length of an implant with, for example, shorter projecting retentive elements oriented distal to taller projecting retentive elements.

FIG. 3B provides a front plan view of a root portion 302 that has a plurality of retentive elements 205 positioned on an exterior surface of the implant in an exemplary random arrangement. Root portion 302 is similar to root portion 301 with the exception of the arrangement of retentive elements 205. It will be understood that any arrangement of retentive elements 205 may be used for an implant like the implants disclosed herein.

FIG. 3C provides a front plan view of a portion of an exemplary second section 120C of an implant and/or implant model as, for example, disclosed herein disclosed. Exemplary second section 303 includes three rows of interlocking teardrop-shaped projecting retentive elements that project outward from the exterior surface of the implant/second section 120C, wherein three rows of teardrop-shaped projecting retentive elements that point downwards 205F3 are interleaved with three rows of upwardly pointing teardrop-shaped projecting retentive elements 205F4 so that upwardly pointing teardrop-shaped projecting retentive elements 205F4 fit between downwardly pointing teardrop-shaped projecting retentive elements 205F3 as shown in FIG. 3C. Retentive elements 205F3 and 205F4 may resemble retentive elements 205E. This arrangement of projecting retentive elements 205F3 and 205F4 allows for enhanced bonding with the socket site because, for example, bone that may be displaced by, for example, the wide portion of projecting retentive element 205F3 may be pushed into a cavity, or depression, formed by the pointed section of inverted teardrop-shaped projecting retentive element 205F4.

FIG. 3D provides a front plan view of a portion of implant 304 with three rows of projecting interlocking teardrop-shaped retentive elements 205F5 that extend outward from the exterior surface of the implant arranged thereon interleaved with three rows of teardrop-shaped divots 205F6 that extend into the exterior surface of implant portion 304. Retentive elements 205F5 and 205F6 may resemble retentive elements 205E. More specifically, implant section 304 includes three rows of teardrop-shaped retentive elements 205F5 that are positioned so that the point of the tear drop shape points downwards. In each row of projecting teardrop shaped retentive elements 205F5, there are teardrop shaped depressions, or divots, 205F6 which are adjacent to, and interleaved with, the projecting teardrop shaped retentive elements 205F5 and oriented with the point of the teardrop pointing downwards. Projecting teardrop-shaped retentive elements 205F5 and teardrop-shaped divots 205F6 are interleaved in an alternating pattern around a circumference of root body 110 as shown in FIG. 3D. The teardrop-shaped depressions 205F6 provide additional surface area to the implant to enhance osseointegration and retentive stability once osseointegration of the implant has been achieved.

FIGS. 4A, 4B, and 4C provide a front, top, and cross-section view of an exemplary implant 400 that includes an abutment portion 410 which may be referred to herein as abutment 410, a connector portion 407, and a root portion 440 which may have characteristics of root portion 110, 102, 310, and/or 302. For example, like root portions 110, 102, 301, and/or 302, root portion 440 includes first section 115, second section 120, third section 125 and, like root portions 301 and 301, root portion 400 includes a plurality of retentive elements 205 positioned on an exterior surface of second section 120. As shown in FIG. 4A, retentive elements 205 are positioned on the leftmost and rightmost sides of second section 120 of root portion 440 however, retentive elements 205 may be positioned anywhere on the exterior surface of root portion 400. Connector portion 407 includes a V-shaped depression 415 that goes around the circumference of connector portion 407. Abutment 410 includes an abutment opening 420 which is described in greater detail below with regard to, for example, FIGS. 4B and 4C.

Root portion 440 may be configured to sit below the patient's gum line and/or an upper edge, or rim, of the socket site when implant 400 is seated within a socket site. Connector portion 407 may be positioned above root portion 440 and may be configured to sit above the gum line, or rim, of the socket site as shown in, for example, FIG. 8. Abutment portion 410 may be positioned above connector portion 407 and may be configured to couple to, and support, a temporary and/or permanent crown as shown in, for example, FIG. 8.

First, second, and third sections 115, 120, and 125, of root portion 440 may correspond to three areas of a three-dimensional scan of an extracted tooth root and/or a three-dimensional model of an extracted tooth root with a first section of the three-dimensional scan/model corresponding to an upper region of the extracted tooth root and a third section three-dimensional scan/model corresponding to a bottom region of the extracted tooth root. The first section 115 and third section 125 of implant 400 may have a size and shape that closely corresponds to, or otherwise resembles, the first and third portions of the three-dimensional scan of the extracted tooth root, respectively. Second section 120 may correspond to a second portion of the three-dimensional scan of the extracted tooth root. A circumference of second section 120 may be being smaller than a corresponding circumference of the second section of the three-dimensional scan of the tooth root.

Abutment 410 and connector portion 407 may be configured to extend above gum tissue 420 and abutment 410 may be configured to connect to a dental crown like crown 810 as shown in FIG. 8. In most cases, implant 400 is fabricated with connector portion 407 and abutment 410 as one complete entity. Alternatively, abutment 410 and/or connector portion 407 may be fabricated as separate piece(s) that are affixed via, for example, a screw and a fixture mount that may attach connector portion 407 to root portion 400 and/or abutment 410 to connector portion 407. An approximate length of connector portion 407 is 1-4.5 mm and a length of abutment 410 may be responsive to dimensions of the socket site and/or the patient's dental anatomy (e.g., height, depth, or other dimensions of neighboring teeth and/or the socket site, bite characteristics, anticipated bone loss from the socket site, etc.).

An exterior surface of connector portion 407 may have a sideways “V”-like shaped depression 415 that may be shaped, sized, and positioned to coincide with a position within/adjacent to a socket site where the patient's cortical bone 815 and gum tissue 820 meet the implant as shown in FIG. 8. The shape of depression 415 may be configured to allow gum tissue 820 to grow, or otherwise fill, into the depression 415 as shown in FIG. 8. This “filling in” of gum tissue 820 may create a seal between the gum tissue near the socket site and implant 400, which may prevent infiltration of, for example, food and/or pathogens into the area where the bone of the socket site and implant 400 interface. In some instances, depression 415 may be configured to preserve alveolar bone within the socket site and/or surrounding the implant, which is sometimes referred to as platform switching with regard to traditional implants.

Connector portion 407 may be configured to have a first section 409 and a third section 408 that join together at an angle 445 to form the sideway V-shaped depression 415. Angle 445 may be, for example, 40-150 degrees. An outer edge of first section 409 may oriented at an angle 450 of, for example, 30-80 degrees relative to an outer edge of abutment 410. An outer edge of third section 408 may oriented at an angle 435 of, for example, 30-100 degrees relative to an outer edge of root portion 400. In some embodiments, connector portion 407 may be configured to be a platform that the patient's gingiva may grow over in order to, for example, seal the socket site/implant interface thereby preventing entry of bacteria or other material in the socket site and/or increasing the likelihood of proper healing of the socket site post-implantation and retention of the implant within the socket site.

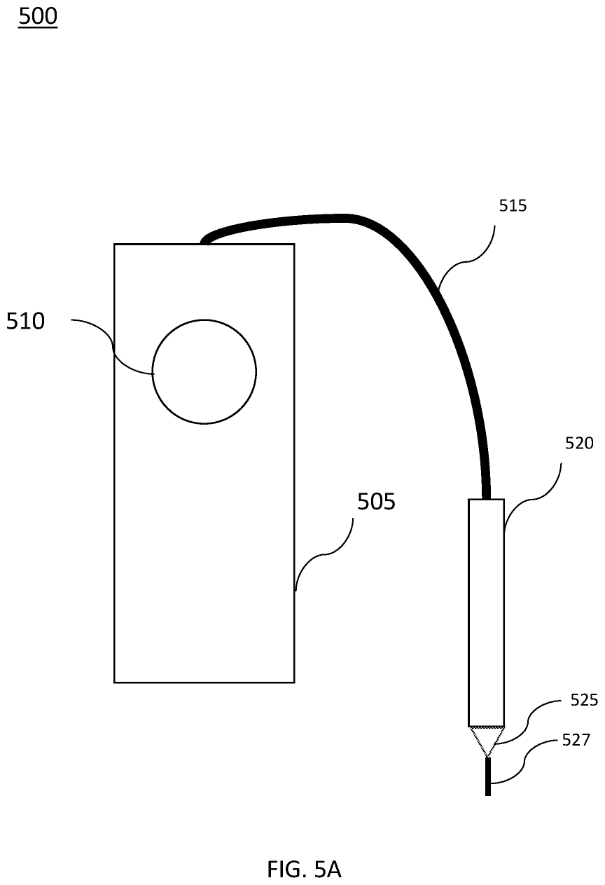

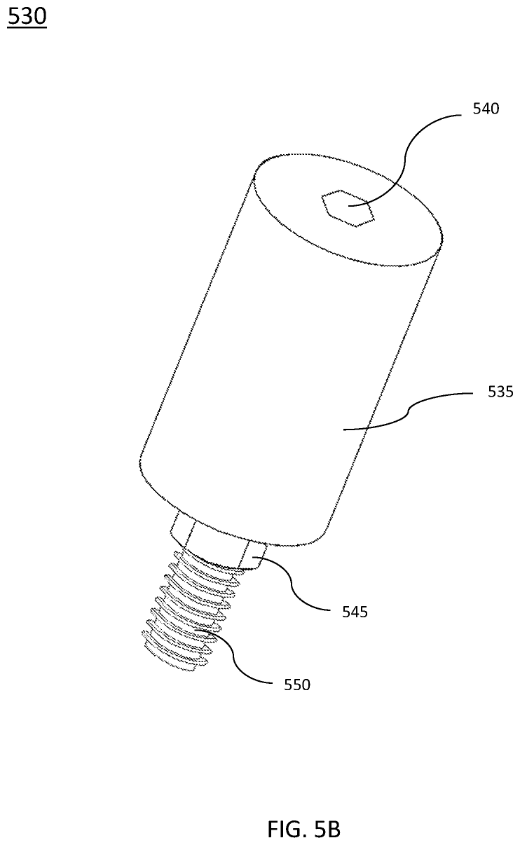

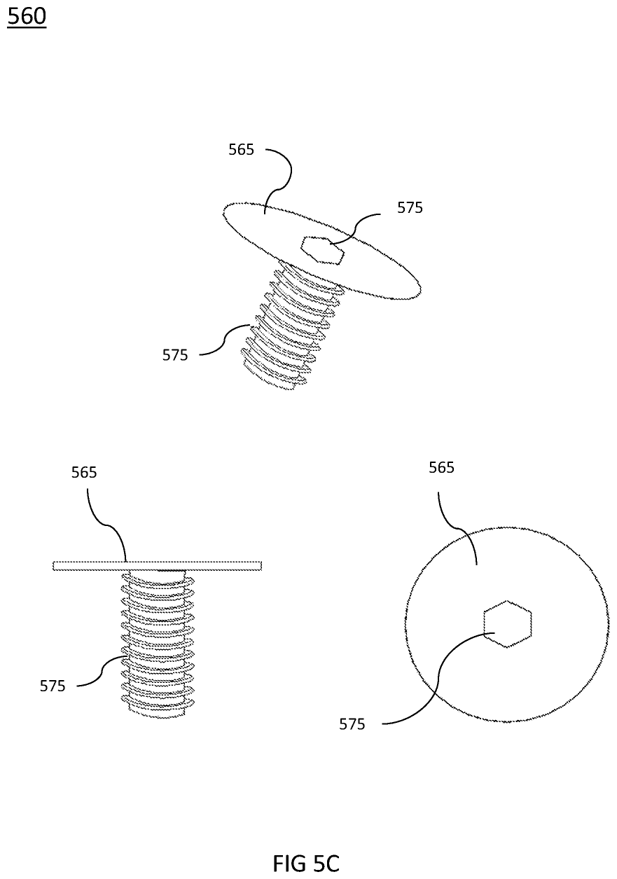

FIG. 4B provides a top view of implant 400 and shows abutment opening 420 with an abutment orifice 425 and opening 430 positioned therein and FIG. 4C provides a cross-section view of abutment 410 that shows an arrangement of abutment opening 420, abutment orifice 425, and opening 430 positioned within abutment 410. Abutment orifice 425 and opening 430 may be configured to cooperate with an engagement mechanism and a screw of a carrier/mount like carrier/mount 530 shown in FIG. 5B and discussed below.

FIG. 5A is a block diagram of an exemplary implant insertion tool 500 that includes an energy and/or force generator 505, a power and/or time control selector 510 for energy and/or force generator 505, a handpiece 520, a cord 520 connecting energy and/or force generator 505 and handpiece 520, a tip 525, and an optional post 527 mechanically coupled to tip 525.

Energy and/or force generator 505 may be configured to generate piezo-electric and/or ultrasonic energy that may result in vibrations that are transferred to tip 525 and post 527 via cord 515 and handpiece 520. Exemplary ultrasonic frequencies generated by energy and/or force generator 505 include, but are not limited to, 20-60 kHz. These ultrasonic frequency vibrations may vibrate an implant partially positioned within a socket site to ease insertion of the implant fully into the socket site as described with regard to process 900, described below. Control dial 510 may be used to adjust an amount, amplitude, duration, and/or frequency of piezo-electric and/or ultrasonic energy delivered by handpiece 520. Additionally, or alternatively, implant insertion tool 500 may be configured to generate an impact force, or thrust, that may be exerted through tip 525 and/or post 527. When this impact/force is applied to the implant via, for example, the abutment and/or a carrier mount of the implant, the implant may be pushed into the socket site.

On some occasions, tip 525 may be configured to cooperate with an orifice present in a carrier, mounting device and/or the abutment portion. An example of a carrier or mounting device is shown in FIG. 5B which shows a carrier/mount 530 that includes a body 535, an orifice 540 positioned within an upper surface of the body 535, an engagement mechanism 545, and a screw 550. In the example of FIG. 5B, orifice 540 has a hexagonal shape configured for cooperation with a correspondingly hexagonally-shaped tip 525. Engagement between hexagonally-shaped tip 525 and orifice 540 may facilitate transfer of an impact force and/or vibrations created by piezo-electric and/or ultrasonic energy to carrier/mount 530.

Carrier/mount 530, and more specifically, engagement mechanism 545 and screw 550 may be configured to engage and/or otherwise cooperate with abutment orifice 425 and opening 430, respectively so that, for example, screw 550 is screwed into abutment orifice 425 and engagement mechanism 545 is seated within abutment orifice 425. In some embodiments, an implant such as implant 400 may be provided to a dental professional with carrier/mount 530 fully engaged with an abutment like abutment 410 in this manner. In this way, the dental professional may grasp, or otherwise handle, carrier/mount 530 to safely and easily remove an implant from its packaging and place it in a socket site without handling the implant directly or allowing the delivery device to touch the implant. Allowing the dental professional to indirectly handle the implant by grasping carrier/mount 530 may protect the implant from any potential damage or contamination that may be caused by handling the implant directly.

Alternatively, a carrier/mount like carrier mount 530 may be used to transfer the implant into the socket site (e.g., grasped by the dental professional when removing the implant from packaging and inserting the implant into the socket site). The carrier/mount may then be removed from the implant and tip 525 and/or post 527 may be inserted directly into a cooperating portion of an abutment. Exemplary cooperating portions of an abutment include, but are not limited to, an orifice and/or notch on, for example, an upper surface of an abutment configured for acceptance of tip 525 and/or post 527 so that, for example, ultrasonic energy may be transferred from tip 525 and/or post 527 to the implant to facilitate insertion of the implant into the socket site.

Carrier/mount body 535 may be configured to facilitate handling by a dental professional so that the dental professional does not have to directly handle the implant to, for example, remove the implant from packaging and/or insert the implant into the socket site. In some embodiments, carrier/mount body 535 may be configured to act as a heat sink to absorb heat that may be generated by energy and/or force generator 505 during the implant insertion process. This absorption of heat may serve to protect the bone of the socket site from heat that may otherwise be transferred to the bone of the socket site via the implant during the implant insertion process, which is advantageous because bone is very sensitive to heat.

Following complete insertion of an implant within the socket site, tip 525 may be removed from orifice 540 and carrier/mount 530 or, more specifically, engagement mechanism 545 and screw 550 may then be disengaged from an abutment by, for example, unscrewing engagement mechanism 545 and screw 550 from abutment orifice 425 and opening 430, respectively.

In some embodiments, implant insertion tool 500 may be configured to create ultrasonic frequencies for discrete intervals of time (e.g., 0.2-0.8 s) so that the ultrasonic frequencies are supplied to tip 525 in short bursts at the request of the user. For example, handpiece 520 may include a button, or other activation device (not shown), that when activated by a user triggers energy and/or force generator 505 to deliver the ultrasonic frequency to tip 525 for one discrete time. This feature may, for example, prevent the accidental application of the ultrasonic frequency to the implant for a time period longer than what is necessary to seat the implant within a socket site, which may cause damage to the socket site and/or excess discomfort to the patient.

FIG. 5C provides a perspective image of a screw cap 560. Screw cap 560 may include a screw head 565 that includes a screw head orifice 575 and a threaded extension 575 that extends downward from screw head. Threaded extension 575 may be configured to cooperate with abutment orifice 425 and opening 430. Screw head 565 may be shaped, or otherwise configured, to fit into and/or cover abutment opening 420 when threaded extension 575 is screwed into abutment orifice 425 and opening 430 following successful insertion of an implant like implant 400.

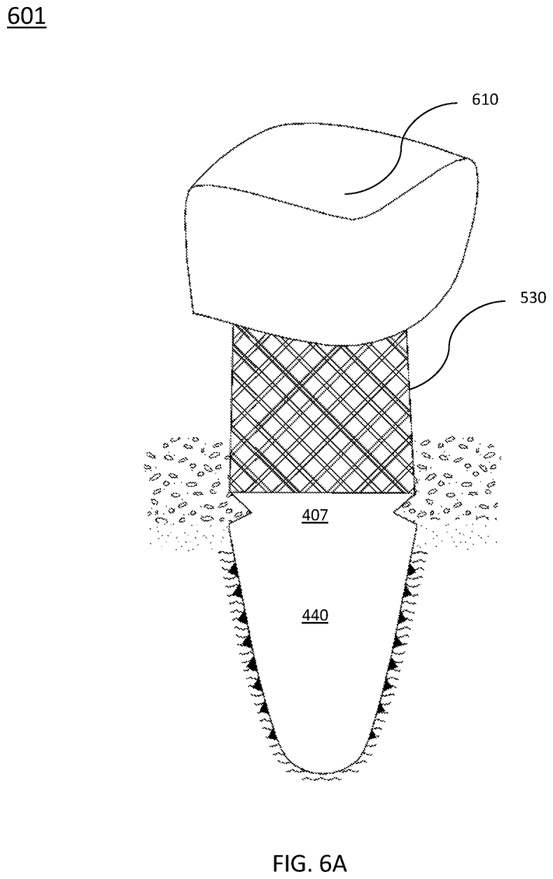

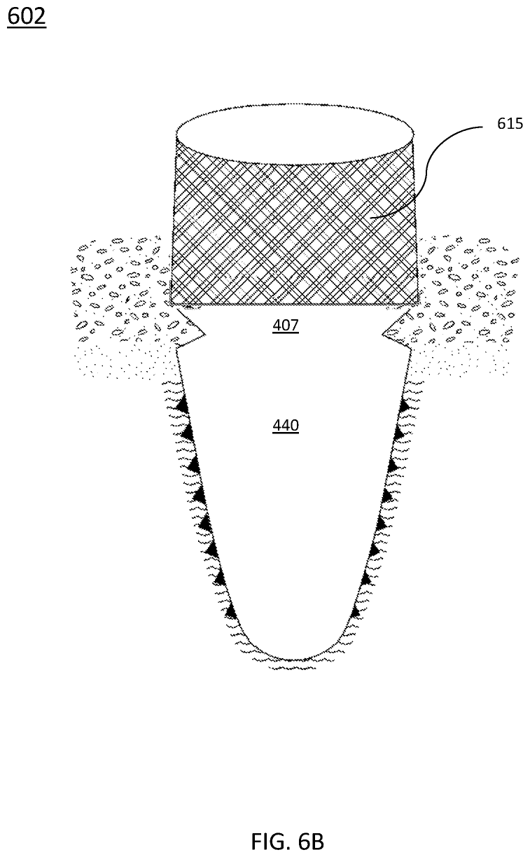

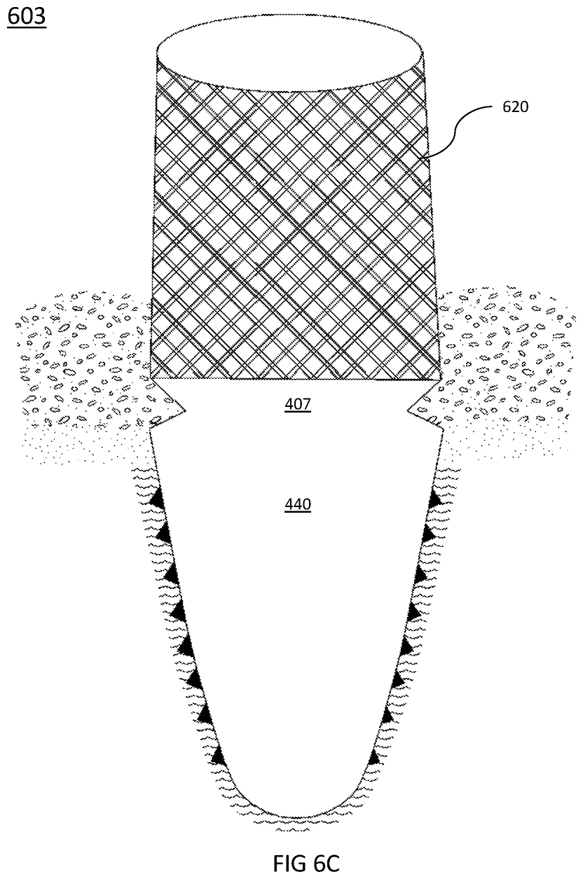

In some embodiments, screw 560 may be configured to prevent cement or other products that may be used when placing the crown or other device on an abutment like abutment 410 from getting into the implant. Additionally, or alternatively, screw 560 may be configured to create an even, flat upper surface for the abutment. This may facilitate attachment of a crown to the abutment and/or implant. FIGS. 6A, 6B, and 6C provide side plan views of exemplary systems 601, 602, and 603, respectively that include implants like implant 400 with exemplary temporary and/or permanent attachments affixed thereto. More specifically, system 601 shown in FIG. 6A includes implant 400 with carrier/mount 530 still attached to the abutment 410 with a temporary bite attachment 610 affixed to the top of carrier/mount 530 via, for example, carrier/mount orifice 540. Temporary bite attachment 610 may be configured for inserting implant 400 into the socket site as an alternative approach to using the implant insertion tool. Temporary bite attachment 610 may be configured to have a hard, solid surface top and have a length sufficient that it extends above the height of the adjacent teeth. Implant 400, or root portion 440, may be fully inserted into the socket site when the patient bites down on the top of temporary bite attachment 610, which may serve to push root portion 440 fully into the socket site. When implant 400 is correctly seated within the socket site, temporary bite attachment 610 may be removed from the abutment of the implant 400.

System 602 of FIG. 6B includes implant 400 and a customized cap 615 that substantially covers abutment 410 and is affixed thereto via, for example, screwing customized cap 615 into abutment orifice 425 and opening 430 and/or chemical bonding (e.g., cement or glue). In many cases, customized screw cap 615 is affixed to abutment 410 using a temporary cement designed to cement customized screw cap 615 in place until the patient is ready for the placement of a permanent crown which may occur when, for example, root section of implant 400 has osseointegrated with the lamina dura of the socket site. Customized cap 615 may be configured to temporarily reside within the patient's mouth to facilitate, for example, protection of implant 400 and/or chewing by the patient until a permanent crown may be attached to implant 400. Customized cap 615 may be configured to cover the abutment portion of an implant. Once customized cap 615 has been placed on the abutment portion of the implant, a dental professional may use standard composite material on top of the cap to make the area look similar to a tooth like a temporary crown. In some embodiments, customized cap 615 may be configured to be out of occlusion with other teeth in the patient's mouth so that it does not connect with other teeth in the patient's mouth when the patient chews. Having customized cap 615 out of occlusion may prevent the application of force to customized cap 615 and therefore implant 400 while the patient chews thereby protecting implant 400 from disturbance during the osseointegration process as implant 400 bonds to the socket site.

When a patient who has system 602 implanted in his or her mouth is ready for a permanent crown like permanent crown 810, customized cap 615 may be removed from abutment 410 via, for example, unscrewing customized cap 615 from abutment orifice 425 and opening 430 and/or releasing cement bonding customized cap 615 to abutment 410 and a permanent crown may be affixed to abutment 410 via, for example, screwing the permanent crown into abutment 410 via abutment orifice 425 and opening 430 and/or cementing the permanent crown into place. In many cases, the permanent crown is affixed to abutment 410 using a permanent cement designed to permanently cement the permanent crown in place.

System 603 of FIG. 6C includes implant 400 and a bite surface attachment/cap 620 that substantially covers abutment 410 and is affixed thereto via, for example, screwing bite surface attachment 620 into abutment orifice 425 and opening 430 and/or chemical bonding (e.g., cement or glue). Bite surface attachment/cap 620 may be configured for inserting the implant into the socket site as an alternative approach to using the implant insertion tool. Bite surface attachment/cap 620 may be configured to have a hard, solid surface top and have a length sufficient that it extends above the height of the adjacent teeth. The implant may be fully inserted into the socket site when the patient bites down on the top of bite surface attachment/cap 620, which may serve to push the implant into the socket site. When the implant is correctly seated within the socket site, bite surface attachment/cap 620 may then be removed from the abutment portion of the implant.

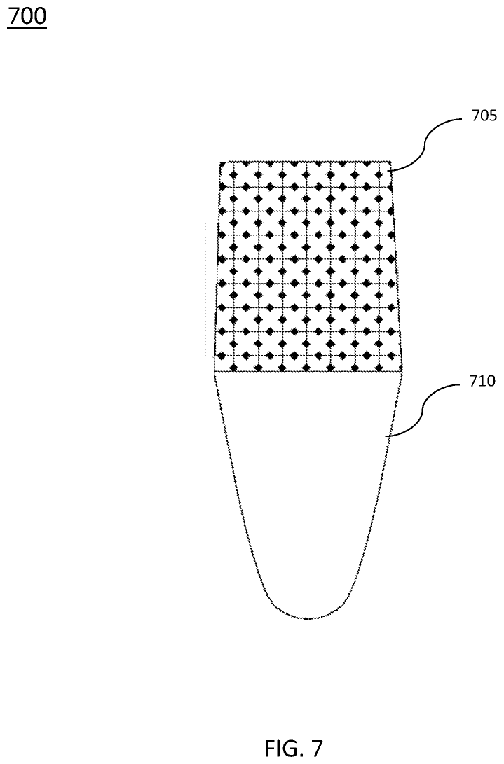

FIG. 7 provides a side plan view of an exemplary implant model 700 which may include an implant model handle 705 and an implant model root portion 710. Implant model 700 and, more specifically, root portion 710 may be configured to closely resemble (or exactly mimic) a root portion like root portion 110, 111, 301, 302, and/or 440, that is to be inserted into a socket site in shape and design. Implant model 700 may be configured so that it does not damage the socket site upon insertion and/or removal therefrom and may be fabricated using an elastically deformable material (e.g., latex, vinyl, plastic, and/or rubber) so that it may be inserted into and/or extracted from the socket site without scraping or otherwise damaging the lamina dura of the socket site. In some instances, implant model 700 may include, and/or may be coated with, a radio-opaque material.

Implant model handle 705 may be configured to facilitate handling of implant model 700 by a dental professional so that he or she may manually implant (e.g., push) model root portion 710 into the socket site and remove model root portion 710 from the socket site prior to seating an actual implant like implant 400 to verify that the implant model root portion 710 (and therefore a corresponding implant) fits properly within the socket site prior to placing the corresponding actual implant. After implant model 700 is inserted into the socket site, a dental professional may assess whether implant model root portion 710 correctly fits into the socket site via, for example, visual or tactile examination and may, in some instances, take an x-ray of the socket site to confirm the implant model root portion 710 dimensions fit appropriately within the socket site. Following this assessment, the dental professional may remove implant model 700 from the socket site via handling of implant model handle 705.

In some embodiments, a dental professional who is inserting an implant like implant 400 into a socket site may receive the implant and its respective carrier/mount as part of a kit. This kit may include a sterilized package including the implant and, in some cases, a carrier/mount like carrier mount 530 which may be affixed to the implant within the packaging as described herein. Optionally, the kit may also contain an implant model like implant model 700 within a sterilized package.

When the dental professional opens the implant packaging, he or she may grasp the carrier/mount and place the root portion of the implant into the socket site without directly touching the implant or root portion thereof. This configuration of the implant and carrier/mount attached to one another within the packaging allows a dental professional to safely and easily remove an implant from its packaging and place it in a socket site without handling the implant directly or allowing the delivery device, or another component, to touch the implant. This may protect the implant from any potential damage or contamination that may be caused by handling the implant directly.

The kit may also include a bite attachment like bite attachment 610, customized cap like customized cap 615, and/or a bite surface attachment like bite surface attachment 620 as described herein. In some cases, the kit may further include a container of composite material that may be placed on top of, for example, the customized cap to make it look and/or feel similar to a tooth like a temporary crown.

In some embodiments, the kit may also include an aliquot of calcium-based sealer, which may be injected into a socket site prior to inserting the implant or root portion thereof into the socket site. This sealer may act to cover the socket site and may fill in any micro-gaps between an implant, or root portion thereof, and the lamina dura socket site and may thereby create a stronger bond between the implant and the socket site when the sealer cures, which may help to lock the implant in place and provide strong initial stability. This stronger bond may be especially helpful for implants placed in areas of the mouth, such as the top two front teeth, where the facial plate of bone is relatively thin and osseointegration may be more difficult and/or take longer than in other places in the mouth. In some embodiments, the calcium-based sealer may be configured to dissolve over time (e.g., 7-12 months), at which point the implant, or root portion thereof, may be fully integrated with the surrounding bone.

Additionally, or alternatively, the kit may contain an aliquot of anti-inflammatory and/or antibiotic medicament, which may be injected into the socket site prior to application of the calcium-based sealer (if using) and inserting the implant in the socket site. The anti-inflammatory and/or antibiotic medicament may be configured to, for example, reduce any inflammation in a socket site and/or prevent bacterial growth and may thereby aid in the prevention of infection of the socket site and/or osseointegration of the implant, or root portion thereof, with the socket site.

FIG. 8 provides a cross-section view of an exemplary dental implant system 800 that includes implant 400 positioned within a socket site 807. Tissue included in and around socket site 807 includes a layer of lamina dura 825 that lines the inside of socket site 807, a layer of cortical bone 815 at the top of the socket site, and a region anticipated of bone loss 835. As may be seen in FIG. 8, the plurality of retention elements 205 of implant 400 are pressed into and/or engaged with a layer of lamina dura 825 of socket site 807.

Implant 400 has been positioned within socket site 807 for a time period sufficient for bone loss of cortical bone 815 around socket site 807 to have occurred as shown with region of anticipated of bone loss 835. This bone loss may be due to, for example, an inflammatory response following extraction of the native tooth that may cause osteoclastic activity causing a portion of cortical bone 815 to recede.

Implant system 800 also includes an abutment 410 and a permanent crown 810 (a portion of which is shown in FIG. 8). Permanent crown 810 is configured to resemble the top portion of a tooth that resides above the cortical bone and extends through gum tissue 820.

As may be seen in FIG. 8, a lower point of third section 408 of connector portion 407 aligns with the upper edge of the region of anticipated bone loss 835 of the crestal cortical bone 815. FIG. 8 also shows how gum tissue 820 has filled into depression 415 thereby sealing implant 400 within socket site 807. Additionally, FIG. 8 shows how abutment 410 cooperates with crown 810 within the gum 820 to provide a stable body for crown 810 that can withstand the forces exerted upon crown 810 and implant 400 when, for example, the patient chews.

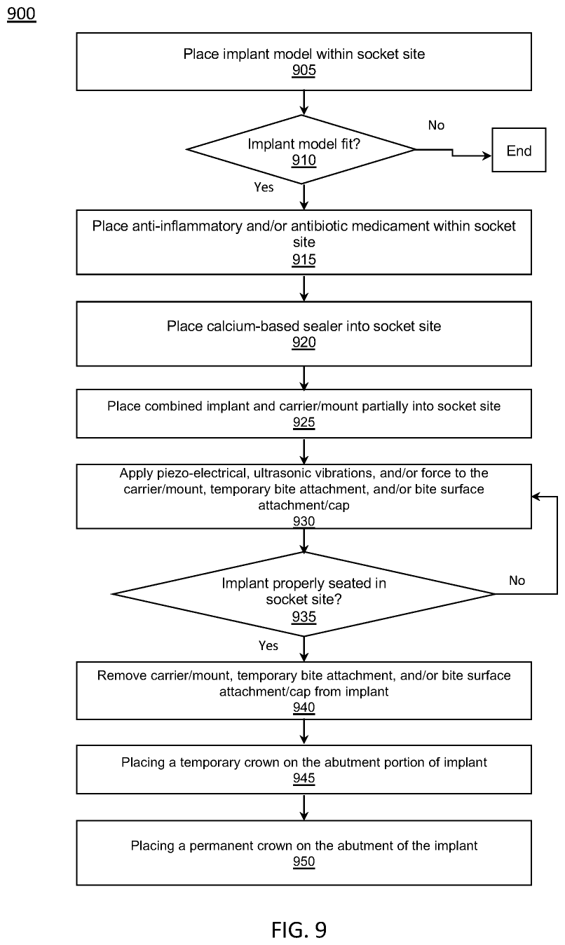

FIG. 9 provides a flowchart showing an exemplary process 900 for placing an implant like implant 400, or a root portion thereof like root portion 101, 102, 301, 302, and/or 440 into a socket site. Optionally, in step 905, an implant model like implant model 700 may be placed within a socket site like socket site 807 of an extracted tooth by a dental professional via, for example, grasping the implant model handle 705 to extract the implant model 700 from its packaging and manually placing (e.g., pushing) an implant model root portion like implant model root portion 710 into the socket site. When step 905 is executed, it may be determined whether the implant model correctly fits within the socket site (step 910). Step 910 may be executed by a visual inspection of the implant model within the socket site by the dental professional, a tactile inspection (e.g., wiggling the implant model back and forth), and/or examination of an image of the socket site taken by, for example, an x-ray to assess whether the implant dimensions fit appropriately in a socket site. When implant model does not correctly fit within the socket site, process 900 may end. When implant model correctly fits within the socket site, process 900 may proceed to step 915 (when executed), step 920 (when executed), or step 925.

Optionally, in step 915, anti-inflammatory and/or antibiotic medicament may be placed within the socket site to potentially aid in reducing any inflammation and/or infection in a socket site and thus potentially aid in the osseointegration of an implant with a socket site. The anti-inflammatory and/or antibiotic medicament may be placed within the socket site using any appropriate method including, but not limited to, squirting the anti-inflammatory and/or antibiotic medicament into the socket site using a delivery device (e.g., syringe) and/or application by an applicator (e.g., a cotton swab).

Optionally, in step 920, a calcium-based sealer may be placed within the socket site. This sealer may act to cover the socket site and may fill in micro-gaps between an implant and the lamina dura socket site and, as the sealer cures, it may create a stronger bond between the implant and the socket site, which may help to lock the implant in place and provide strong initial stability. The calcium-based sealer may be placed within the socket site using any appropriate method including, but not limited to, squirting the calcium-based sealer into the socket site using a delivery device (e.g., syringe) and/or application by an applicator (e.g., a cotton swab).

In step 925, an implant and, optionally, a carrier/mount (like carrier/mount 530) that may be affixed thereto may be partially (e.g., 70-90%) placed within the socket site by the dental professional. In some instances, a temporary bite attachment like temporary bite attachment 610 and/or a bite surface attachment/cap like bite surface attachment/cap 620 may be affixed to the carrier/mount. In some instances, step 925 may be executed by the dental professional manually inserting the implant into the socket site by exerting pressure, or force, on the implant or, when used, a carrier/mount body like carrier/mount body 535 of carrier/mount 530. In some embodiments, step 925 may be executed by inserting a tip (like tip 525) of an implant insertion tool like implant insertion tool 500 in the hole (like orifice 540) at the top of the carrier/mount configured to accept the tip of the implant insertion tool and then placing a system of the implant, carrier/mount, and the tip of implant insertion tool into the patient's mouth so that a root portion of the implant may be pushed into the socket site via, for example, application of force to the handpiece of the implant insertion tool, which is then transferred to the carrier/mount, which transfers the force to the implant so that it may be pushed into the socket site.

Alternatively, step 925 may be executed by the dental professional inserting the implant and carrier/mount into the patient's mouth, pressing the root portion of the implant into the socket site via application of force to the carrier/mount. Then the temporary bite attachment may be affixed to the carrier/mount as shown in FIG. 6A.

Alternatively, step 925 may be executed by the dental professional inserting the implant and carrier/mount into the patient's mouth, pressing the root portion of the implant into the socket site via application of force to the carrier/mount. Then, the carrier/mount may be removed from the implant and a bite surface attachment/cap may be affixed to the carrier/mount.

In step 930 the implant may be fully (100%) seated within the socket site by the application of bite force generated by a user biting down on the temporary bite attachment or bite surface attachment/cap or the application of downward force upon a handpiece and therefore tip of the implant insertion tool coupled to the carrier/mount and piezo-electric and/or ultrasonic vibrations applied by the implant insertion tool following activation (e.g., turning on or engaging an activation switch) of the implant insertion tool.

When an implant insertion tool is used to execute step 930, piezo-electric and/or ultrasonic vibrations applied to the carrier/mount may cause vibrations in the carrier/mount and, by extension, the implant. This may make the force applied to the carrier/mount more effective when inserting the implant into the socket site and may help with inserting the implant, or root portion thereof, fully within the socket site. These vibrations may also make insertion of the implant into the socket site less dangerous to the bony structure of the socket site because it ensures that a consistent and measured amount of downward force is applied to the implant to properly position, or seat, the implant in the socket site. It is also a more pleasant and comfortable experience for the patient than hammering the implant into the socket site as may be done presently with press-fit dental implants.

In step 935, it may be determined whether the implant is properly positioned, or seated, in the socket site, and if not, step 930 may be repeated. Then, in step 940, any equipment used to insert the implant into the socket site may be removed so that only the implant remains in the socket site. Exemplary equipment used to insert the implant includes, but is not limited to, the implant insertion tool, carrier/mount, temporary bite attachment and/or bite surface attachment/cap. Optionally, a temporary crown like temporary crown 615 may then be placed on the abutment (step 945). In step 950 a permanent crown like crown 810 may be placed upon abutment and affixed thereto using, for example, permanent cement or other chemical bonding agent. In embodiments where a temporary crown is used in step 945, it will be removed prior to execution of step 950.

FIG. 10 provides a flowchart that illustrates a process 1000 for designing an implant, such as implant 400 and/or a component thereof such as a root portion like root portion 101, 102, 301, 302, and/or 440. Process 1000 may be executed by, for example, a processor or computer executing a set of instructions stored on a memory in communication with the processor.

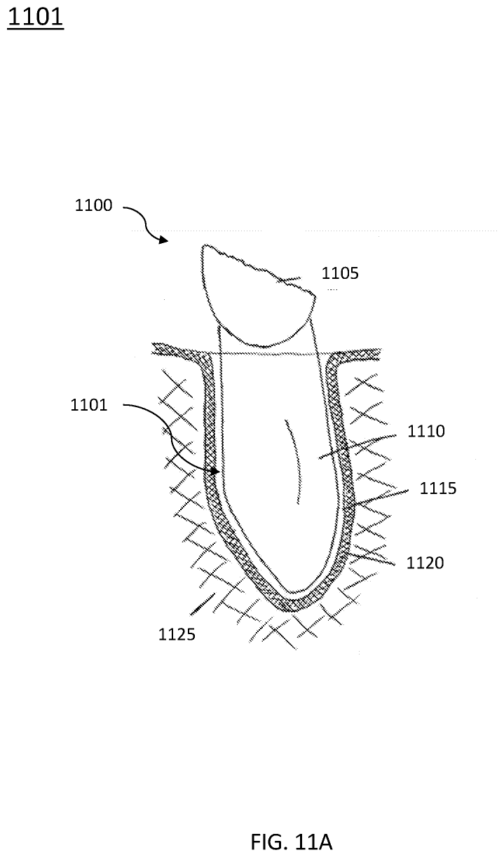

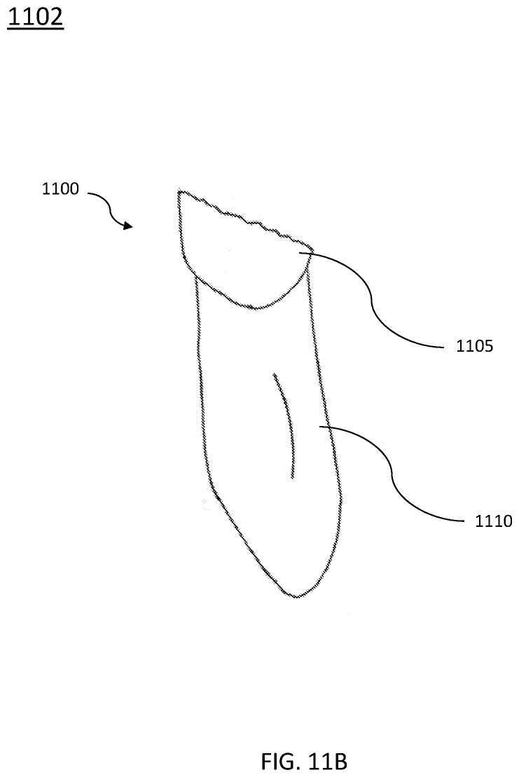

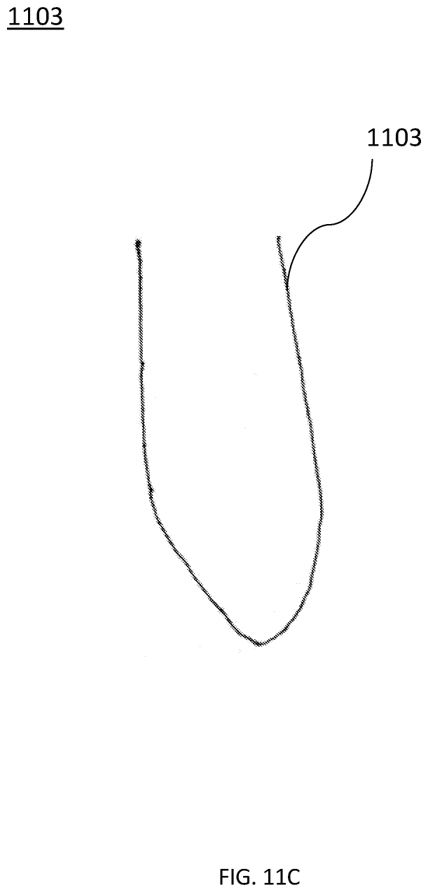

In step 1005, a three-dimensional drawing and/or scan of an extracted tooth root, or fractured pieces of an extracted tooth root may be received by, for example, a processor-based system like processor-based system 1600, which in some embodiments may include a processor configured as a computer-aided design (CAD) module. FIG. 11A provides a cross-section drawing 1101 of an exemplary tooth that may be extracted via an atraumatic extraction and may be used to generate the three-dimensional image and/or scan of the extracted tooth root received in step 1005. Tooth 1100 includes a broken crown 1105 and a tooth root 1110. Tooth root 1110 is resident within socket site 1120, which may be similar to socket site 807, which is lined with a periodontal ligament space 1115, a lamina dura layer 1120, and medullary bone 1125. A cross-section drawing 1102 depicts tooth 1100 when extracted from socket site 1120 as shown in FIG. 11B. A three-dimensional drawing and/or scan of extracted tooth root 1110 may be received in step 1005. In some embodiments, the extracted tooth root may include an indication of the bone height line for the extracted tooth root which may be, for example, an upper edge of the cortical bone, like cortical bone 415, of the socket site that may be incorporated into the three-dimensional image/scan. The indication may be, for example, a marking or scoring of the extracted tooth made by a dentist prior to extracting the tooth to mark the upper edge of the socket site. FIG. 11C provides a cross-section drawing 1103 of an exemplary socket site 1120 corresponding to extracted tooth 1100.

In many instances, the extracted tooth root may be free from any bone ankylose to it. Optionally, in some embodiments, information regarding a socket site from which the tooth was extracted is also received in step 1005. The tooth may have been extracted via an atraumatic extraction that preserves the integrity of the corresponding socket site. The three-dimensional image and/or scan of an extracted tooth root may be captured by, for example, a three-dimensional scanner that may produce core design data of the tooth root that may be received in step 1005. In some embodiments, a three-dimensional scan of the crown, or a portion thereof, of the extracted tooth root may also be received in step 1005.

In step 1010, a three-dimensional model of the extracted tooth root and/or a corresponding socket site from which the tooth was extracted may be generated using the images and/or scans received in step 1005. In some embodiments, the three-dimensional model may be modified to remove one or more elements, or features, of the extracted tooth root except for the outline, or profile, of the extracted tooth root. Exemplary elements/features that may be removed include, but are not limited to, dentin, pulp chamber, and root canal. In some embodiments, this modified three-dimensional model may represent the shape of the native tooth root and/or the architecture of a corresponding socket site and may be used during execution of steps 1015, 1020, and/or 1025, described herein.

In step 1015, one or more characteristics of the three-dimensional model of the extracted tooth root and/or corresponding socket site may be determined and/or defined. Exemplary characteristics include, but are not limited to, a shape (e.g., length, width, height, circumference, diameter, and/or volume) of the modeled extracted tooth root, dimensions for the modeled extracted tooth root, protrusions from the extracted tooth root, irregularities in the surface of the extracted tooth root, and bone ankylose to the surface of the extracted tooth root.

In step 1020, a modified three-dimensional model of the extracted tooth root may be generated. In some embodiments, execution of step 1020 includes removing one or more elements, or features, of the three-dimensional scan of extracted tooth root in order to, for example, generate a smooth outline, or profile, of the extracted tooth root. Exemplary elements/features that may be removed include, but are not limited to, irregularities of the tooth root (e.g., bumps dents, and/or protrusions) dentin, pulp chamber, and root canal. Additionally, or alternatively, execution of step 1020 may include adjusting an overall length of the three-dimensional model of the extracted tooth root to make the length of the three-dimensional model of the extracted tooth root shorter than the length of the extracted tooth root and/or corresponding socket site.

In some embodiments, execution of step 1020 may include dividing the three-dimensional model of the extracted tooth root into a plurality of sections such as first section 115, second section 120, and third section 125 and, in some instances, modifying one or more characteristics of one or more sections of the three-dimensional model. The first section of the model may correspond to a first portion of the three-dimensional model of the extracted tooth root which may be approximately 2-4 mm in length. In some embodiments, the first section may have a size and shape corresponding to a first portion of the three-dimensional model of the extracted tooth root without much, or any modification other than, for example, removal of irregularities when necessary or desired. Alternatively, an exterior surface of the first section may be modified to have a cortical taper along the length of the first section with a largest circumference of the first section occurring at the top of the first section. The third section of the model may have a size and shape corresponding to a third portion of the three-dimensional model of the extracted tooth root and may correspond to a bottom region of the extracted tooth root. In some embodiments, the third section of the model may be modified to have a circumference that is 0.1-7% smaller than the third portion of the three-dimensional scan of the extracted tooth root. Additionally, or alternatively, the third section of the model may be modified to have a tapering bottom section responsively to a determination that, for example, additional strength or support for the implant is needed within the socket site. The taper may be designed to facilitate tight contact with the lamina dura at the bottom of the socket site and may provide compressive strength and stability to guard against the compressive forces of the jaw during, for example, chewing.

The second section of the root portion of the implant may be positioned below the first section and may have a size and shape approximately corresponding to a second section of the three-dimensional scan of the extracted tooth root. A diameter, circumference, cross-sectional area, and/or volume of the second section may be smaller than a corresponding diameter, circumference, cross-sectional area, and/or volume of the second section of the three-dimensional scan of the tooth root. In some instances, the second section may have a diameter, circumference, cross-sectional area, and/or volume that is 3-7% smaller than the second section of the three-dimensional scan of the extracted tooth root. A length of the second section may vary depending on a length of the extracted tooth root and, in many cases, may correspond to a length of the extracted tooth root minus the length of the first section (2-4 mm) and the length of the third section (2-4 mm). In some cases, a length of the second section may also be shortened to accommodate anticipated cortical bone loss at the upper edge of a socket site following extraction.

In step 1025, an implant may be designed using, for example, one or more design feature(s) and/or parameter(s). Design of the implant may be responsive to the determination(s) of step 1015 and, in some cases, execution of step 1025 may include further modification of the modified three-dimensional model of the extracted tooth root generated in step 1020 and/or addition of design features to the modified three-dimensional model of the extracted tooth root generated in step 1020. In some instances, the design feature and/or parameter added to the modified three-dimensional model of the extracted tooth root generated in step 1020 may be selected in order to, for example, ease insertion of the implant into the socket site, increase compatibility of an implant with a socket site, increase initial stability of the implant within the socket site, and/or optimize long-term osseointegration of the implant within the socket site.

In some embodiments, a design feature may be a selection of a type of surface texturing to apply to one or more surfaces and/or retentive elements of an implant. The surface texturing may be configured to assist with, for example, bone growth and/or inflammation reduction in the space between the implant and the lamina dura/alveolar process.

In some instances, design of the implant in step 1025 may include selection of one or more feature(s) including, but not limited to, a shape, size, quantity, and/or arrangement of retentive elements on an exterior surface of the implant. Design features of selected retentive elements may be responsive to, for example, characteristics determined in step 1015 and may be selected so as to establish an appropriate level of friction between the retentive elements and/or implant and the lamina dura of the socket site in order to, for example, maximize stability of the dental implant once it is inserted in the socket site.

Some retentive element designs may have more directional pull, pushing the implant in a particular direction. For example, a diamond-shaped retentive element like diamond-shaped retentive element 205C may be positioned at an angle or an association to one another so that, for example, the retentive element encourages or creates forces on the implant insertion path into the socket site, that pushes an inserted implant towards the lingual wall of the socket site. This may be advantageous because the lingual/palatal side of the socket site typically has a higher bone density and/or is thicker and has higher regenerative quality than the buccal/facial side of the socket site and can therefore withstand more force pushing up against it.

An implant may be designed so that retentive elements are positioned in columns with 0-3 mm between the bottom of one retentive element and the top of the next retentive element directly below it. Additionally, or alternatively, an implant may be designed so that retentive elements are arranged in rows around a circumference of the implant and the retentive elements may be positioned such that there is 0-3 mm between the right side of one retentive element and the left side of the retentive element directly next to it.

For example, where the model of the extracted tooth indicates there is bone matter attached to the tooth root in step 1015, the selected design feature of step 1020 may remove the bone or otherwise smooth a protrusion of the tooth root where the bone was attached to it. In another example, if the cortical bone is very dense, a diameter, circumference, cross-sectional area, and/or volume of a first section of the implant, like first section 115 may be designed with a parameter indicating that the volume of the first section be smaller (e.g., 0.1-3%) in volume than the extracted tooth root.

Step 1025 may be used to determine design parameters for the inclusion of one or more retentive elements like retentive elements 205 on an exterior surface of an implant. For example, if a characteristic of the socket site is that distal and mesial sides of the socket site have the strongest and/or densest bone, a design feature for a corresponding implant may be to include a high quantity of retentive elements on the distal and mesial sides of the implant, because the socket site can support strong forces at these locations that may be exerted by a plurality of retentive elements upon insertion of the implant.

In another example, if a characteristic of the socket site is that the bone becomes thicker and stronger along the length of the socket site so that the thickest and strongest bone of the socket site is at the bottom of the socket site, retentive elements may be concentrated in the lower portion of the second section because this portion of the socket site is better able to withstand the stress of a retentive element being inserted therein. Additionally, or alternatively, lingual and/or palatal sides of the implant may be designed to have a smaller quantity of retentive elements in the upper area of the second section of the implant because, for example, the bone at the upper portion of the socket site may not be able to withstand the force of more than a few retentive elements. In addition, fewer retentive elements in the lingual/palatal side of the upper area of the second section of the implant may help to ensure the implant is not pushed towards the buccal/facial side of the socket site, which is quite fragile due to the relatively thin lamina dura and underlying medullary bone in this area of the socket site.

In another example, a characteristic of the lamina dura on the buccal/facial side of the socket site may be that it is relatively thin or weak. A corresponding design feature of an implant configured to be placed in this socket site may be responsive to this characteristic and, as such, may include relatively fewer retentive elements in the area of the implant configured to correspond to the buccal/facial side of the socket site so as to minimize stress on this region of the socket site. The design may include creating space or room between the implant and the facial/buccal wall so as to have a sealing graft material to be placed either before or after the implant is placed. The sealer graft material is present primarily for bone stability but may aid in the stability of the implant.

In some embodiments, an upper portion (e.g., first section 115) of an implant may not include retentive elements and may have relatively smooth exterior surfaces to, for example, achieve intimate contact with the cortical bone thereby forming a seal between the upper portion of the root portion of the implant and the upper rim of the socket site.

Additionally, or alternatively, an implant may be designed to have one or more retentive elements extending from an exterior surface of the bottom tip (e.g., third section 125). These retentive elements may assist with engagement between the implant and the socket site. Alternatively, there may be no retentive elements in this section.

In some embodiments, designing the implant may include designing a connector section 407 positioned above the first section 115, and an abutment portion like abutment 410 positioned above connector section 407. In some embodiments an abutment may be designed based on a characteristic determined in step 1015. The abutment may be configured for cooperation with a temporary and/or permanent crown.

In step 1030, the modified three-dimensional model of the extracted tooth root may be converted into a design specification for the dental implant and the design specification may be formatted into a format compatible with an implant fabrication tool.

In step 1035, the formatted design specification for the dental implant to the implant fabrication may be communicated to the implant fabrication tool like a computer-aided manufacturing (CAM) module. The implant may then be fabricated using a suitable fabrication technique including, but not limited to, a micro-machining system (e.g., a CNC milling system), a rapid prototyping system (e.g., 3-D printing or electron-beam melting), a casting system, and/or other systems may be used singly or in combination to produce an implant, abutment, and/or other components associated with the implant. In some instances, a sintering system may be used to harden the material used to fabricate the implant.

In some embodiments, execution of step 1035 may include selection of a material and/or coating for an implant. In many instances, a material used to fabricate the implant will be a biocompatible material, such as titanium, zirconium, PEEK (polyetheretherketone) or a combination of zirconia and PEEK. At times, the implant may be coated or embedded with an osteophilic texture, such as hydroxyapatite, that may act to, for example, promote an osseointegration event.

An alternate way to execute process 1000 and, more specifically, steps 1015 and 1020 includes designing the implant using a series of shaped sections that may be, for example, 0.25-3.0 mm thick sections of a biocompatible material that are stacked on top of one another in a specified sequence that is responsive to the shape of the extracted tooth root and/or corresponding socket site so that, for example, shapes and/or dimensions of the sections may be selected to correspond to the shape and/or size of the socket site.

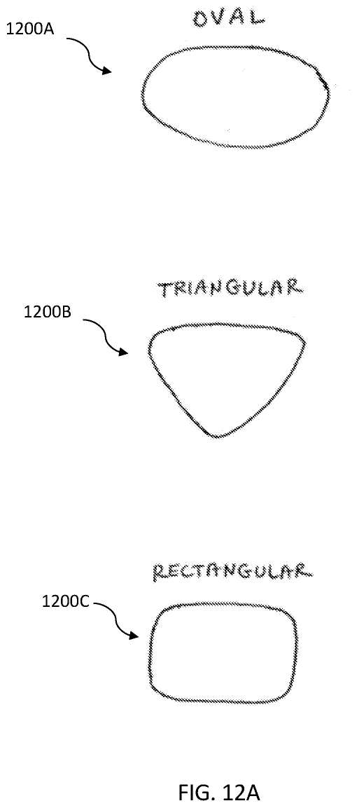

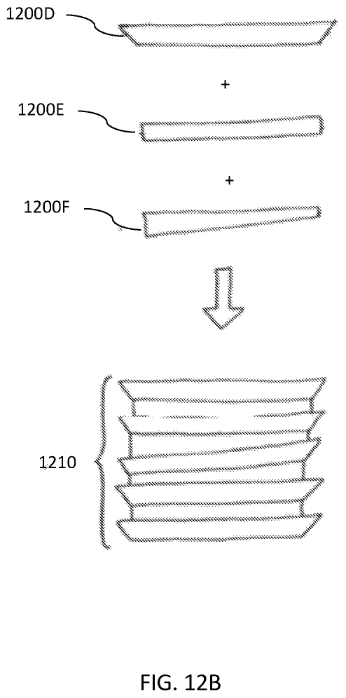

Examples of shaped sections are shown in FIGS. 12A and 12B. FIG. 12A provides a cross-sectional view of three exemplary shaped sections 700 wherein shaped section 1200A is oval-shaped, shaped section 1200B is triangularly-shaped, and shaped section 1200C is rectangularly-shaped. Additionally, or alternatively, shaped sections may have varying cross-sectional shapes including, but not limited to a trapezoidal, elliptical, rounded, triangular, and/or rectangular shape. In some instances, a shape of a first side of a shaped section may be different from a shape of a second side of the shaped section. FIG. 12B shows examples of cross-sectional shapes for shaped sections where shaped section 1200D has a trapezoidal shape, shaped section 1200E has a rectangular shape, and shaped section 1200F has a truncated right triangular shape with the left side being longer than the right side of the shaped section.

A shape and/or dimensions of each shaped section used to design an implant may be selected and/or positioned on the implant using various criteria including, but not limited to, tooth root dimensions, socket site dimensions, structural requirements, and/or pre-programmed design requirements (e.g., a shaped section occupies a percentage (80% to 115%) of a given area of the volume of the socket site).

FIG. 12B also shows a series of shaped sections assembled into a middle portion 1210 of an implant. In some instances, second section 1210 may resemble second section 120. Second section 1210 comprises a stack of shaped sections 1200D, 1200E, 1200D, 1200F, 1200D, 1200F, 1200D, 1200E, and 1200D. Second section 1210 may be fabricated as one piece via, for example, molding, machining, or 3D printing. Shaped sections may be fabricated from stock material using milling or other machining techniques, laser cutting, stamping or other subtractive manufacturing techniques. Alternatively, shaped sections may be cast or molded.

In some embodiments, second section 1210 may be 3-7% smaller in diameter, circumference, cross-sectional area, and/or volume than the corresponding area in the three-dimensional modeled profile of the native tooth root. This feature may, for example, allow the implant to be inserted easily in the socket site and/or may allow for blood to enter the space between the implant and the cortical bone, which may facilitate healing and/or stabilization of the implant within the socket site.

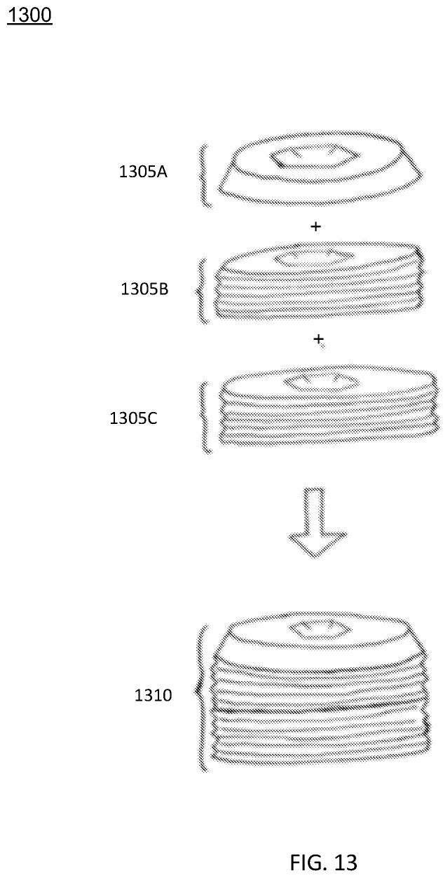

FIG. 13 provides an exploded and assembled view of an exemplary crestal portion 1310 of a root portion of an implant. Crestal portion 1310 may include three sections: first crestal portion section 1305A, second crestal portion section 1305B, and third crestal portion section 1305C, each of which may be 0.5-1.5 mm thick. In some embodiments crestal portion 1310 may resemble first section 115 of root portion 110.

First crestal portion section 1305A has a trapezoidal cross-section with an angled bevel 815 of approximately 33-55 degrees relative to a bottom surface. This bevel may extend inward, from the bottom of the top crestal section, towards the center of the implant by 0-3.0 mm around the entire circumference of the implant surface. First crestal portion section 1305A may form the upper part of an implant and, in some embodiments, may include an opening configured for cooperation with and/or acceptance of a connector portion like connector portion 407, mounting device for an abutment and/or an abutment like abutment 410. Alternatively, crestal portion 1310 and/or first, second, and/or third crestal portion section may be configured for cooperation with a connector portion (not shown) and/or an abutment (not shown) that is fabricated with crestal portion 1310 and/or implant 1500 as one piece.

In some embodiments, execution of step 1020 may include increasing a volume of second and third crestal portion sections 1305B and 1305C by, for example, 0.1-3% of the corresponding volume of the 3D modeled profile of the native tooth root where second and third crestal portion sections 1305B and 1305C may reside. This modification of step 1020 may occur responsively to a determination in step 1015 that there is a 30-50 micron space in the socket site between the extracted tooth root and the cortical bone that surrounds it. In addition, this portion of the implant may be smaller in volume than the extracted tooth root in order to, for example, compensate for very dense bone or very thin and/or sensitive bone.

In some embodiments, shaped sections 1200A, 1200B, 1200C, and/or 1200D and/or first crestal portion section 1305A, second crestal portion section 1305B, and/or third crestal portion section 1305C may have extensions at their respective outer edges configured to engage with the bone of the socket site when an implant is resident within the socket site. These extensions may act similarly to the retentive elements described herein and may be configured to allow an implant to unidirectionally engage with the socket cortical bone upon insertion and stabilize the implant to ensure it stays in the socket site. They may be configured and/or arranged to provide maximum initial stability of an inserted implant. In addition, the extensions may provide a greater surface area from which osseointegration may occur.

The extensions of the crestal and middle portions of an implant may be arranged, selected, and/or designed in step 1020 responsively to characteristics of the modeled extracted tooth root and/or socket site determined in step 1015. For example, extensions may be added to the distal and mesial sides of the crestal and/or middle portions of the crestal and/or middle portions of an implant because the corresponding portions of the modeled tooth root and/or socket site have the strongest, densest, and/or thickest cortical bone and underlying medullary bone. Additionally, or alternatively, fewer extensions may be added to the lingual/palatal side of the crestal portion of an implant and more extensions may be added to the lingual/palatal side of the middle portion of an implant because the cortical bone is stronger, denser, and/or thicker along the length of the socket site with the bottom of the socket site being the strongest, densest, and/or thickest.

Additionally, or alternatively, the buccal/facial side of the crestal and/or middle portions of an implant may have few, or no, extensions because the cortical bone in the upper area of the socket site is relatively thin and extensions pushing into this thin bone may cause irritation of the cortical bone.

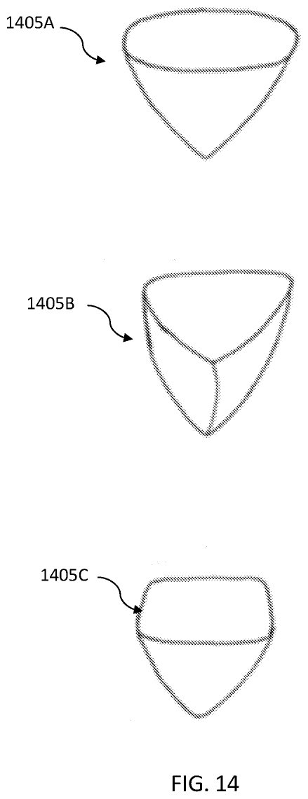

FIG. 14 provides perspective views of exemplary shapes for a bottom, or apical, portion 1405 of an implant which is also referred to herein as third section 125 configured for engagement with the lowest portion of a socket site. Apical section 1405 may be, for example, 0.5-3 mm long and 95-100% of the volume of the corresponding area in the modeled tooth root and/or socket site. More specifically, FIG. 14 shows an apical portion 1405A with an oval cross section that tapers to a point, an apical portion 1405B with a triangular cross section that tapers to a point, and an apical portion 1405C with a rectangular cross section that tapers to a point.

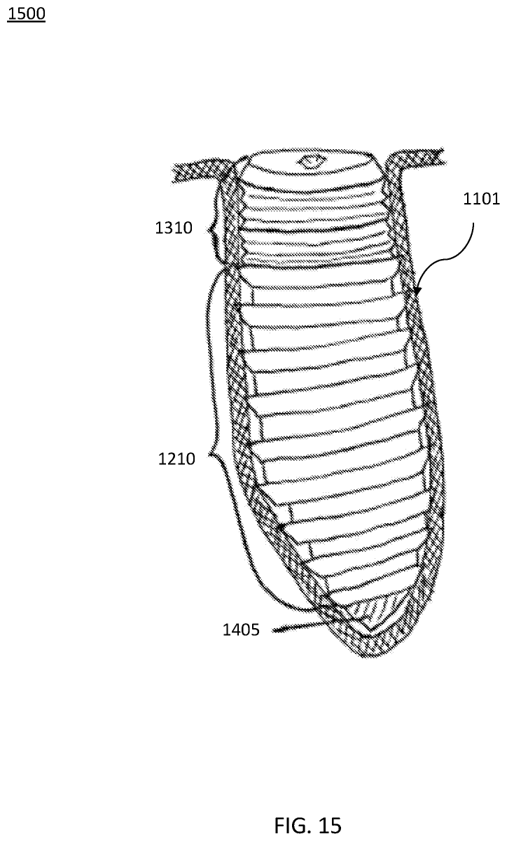

FIG. 15 provides a front plan view of an assembled implant 1500 positioned with socket site 1101 so that extensions of the apical 1310 and second sections 1210 are proximate to the bone of the socket site.

The dental implants disclosed herein may be placed by a dental professional (e.g., general dentist, oral surgeon, periodontist, prosthodontist or endodontist) within a socket site using any appropriate method.

In some embodiments, an implant may be placed in a socket site using a tool that impacts or vibrates the implant, such as implant insertion device 500, as it is pushed down into the socket site.

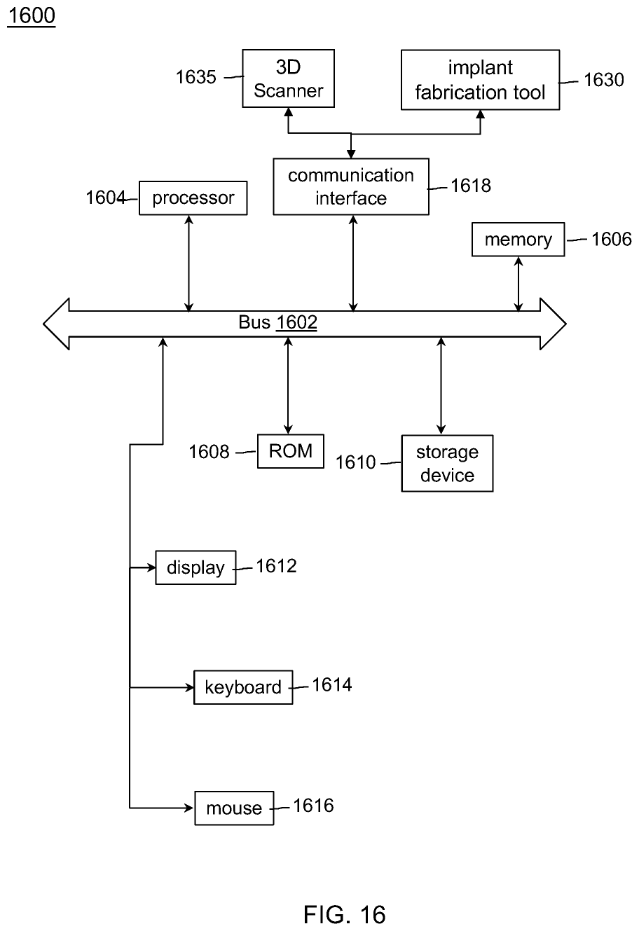

FIG. 16 provides an example of a processor-based system 1600 that may store and/or execute instructions for one or more of the processes described herein. Note, not all of the various processor-based systems which may be employed in accordance with embodiments of the present invention have all of the features of system 1600. For example, certain processor-based systems may not include a display inasmuch as the display function may be provided by a client computer communicatively coupled to the processor-based system or a display function may be unnecessary. Such details are not critical to the present invention.

System 1600 includes a bus 1602 or other communication mechanism for communicating information, and a processor 1604 coupled with the bus 1602 for processing information. System 1600 also includes a main memory 1606, such as a random-access memory (RAM) or other dynamic storage device, coupled to the bus 1602 for storing information and instructions to be executed by processor 1604. Main memory 1606 also may be used for storing temporary variables or other intermediate information during execution of instructions to be executed by processor 1604. System 1600 further includes a read only memory (ROM) 1608 or other static storage device coupled to the bus 1602 for storing static information and instructions for the processor 1604. A storage device 1610, which may be one or more of a hard disk, flash memory-based storage medium, a magnetic storage medium, an optical storage medium (e.g., a Blu-ray disk, a digital versatile disk (DVD)-ROM), or any other storage medium from which processor 1604 can read, is provided and coupled to the bus 1602 for storing information and instructions (e.g., operating systems, applications programs and the like).

System 1600 may be coupled via the bus 1602 to a display 1612, such as a flat panel display, for displaying information to a user. An input device 1614, such as a keyboard including alphanumeric and other keys, may be coupled to the bus 1602 for communicating information and command selections to the processor 1604. Another type of user input device is cursor control device 1616, such as a mouse, a trackball, or cursor direction keys for communicating direction information and command selections to processor 1604 and for controlling cursor movement on the display 1612. Other user interface devices, such as microphones, speakers, etc. are not shown in detail but may be involved with the receipt of user input and/or presentation of output.

The processes referred to herein may be implemented by processor 1604 executing appropriate sequences of processor-readable instructions stored in main memory 1606. Such instructions may be read into main memory 1606 from another processor-readable medium, such as storage device 1610, and execution of the sequences of instructions contained in the main memory 1606 causes the processor 1604 to perform the associated actions. In alternative embodiments, hard-wired circuitry or firmware-controlled processing units (e.g., field programmable gate arrays) may be used in place of or in combination with processor 1604 and its associated computer software instructions to implement the invention. The processor-readable instructions may be rendered in any computer language.

System 1600 may also include a communication interface 1618 coupled to the bus 1602. Communication interface 1618 may provide a two-way data communication channel with a computer network, which provides connectivity to the plasma processing systems discussed above. For example, communication interface 1618 may be a local area network (LAN) card to provide a data communication connection to a compatible LAN, which itself is communicatively coupled to other computer systems. The precise details of such communication paths are not critical to the present invention. What is important is that system 1600 can send and receive messages and data through the communication interface 1618 and in that way communicate with other controllers, etc.

System 1600 may also include an implant fabrication tool 1630 configured to receive instructions for the fabrication of one or more of the implants and/or implant components disclosed herein. Implant fabrication tool 1630 may be, for example, a 3D printer, a computer-aided manufacturing (CAM) module, and/or a milling machine.

Optionally, system 1600 may also include a three-dimensional scanner 1635 configured to scan an extracted tooth root in three dimensions and communicate three-dimensional scans to processor 1604 via communication interface 1616.

In some embodiments, not all components of system 1600 may be resident in the same place. For example, three-dimensional scanner 1635 may be resident in a dentist's office and may communicate the three-dimensional scan of the extracted tooth root to other components of system 1600 via a communication network (e.g., the Internet).

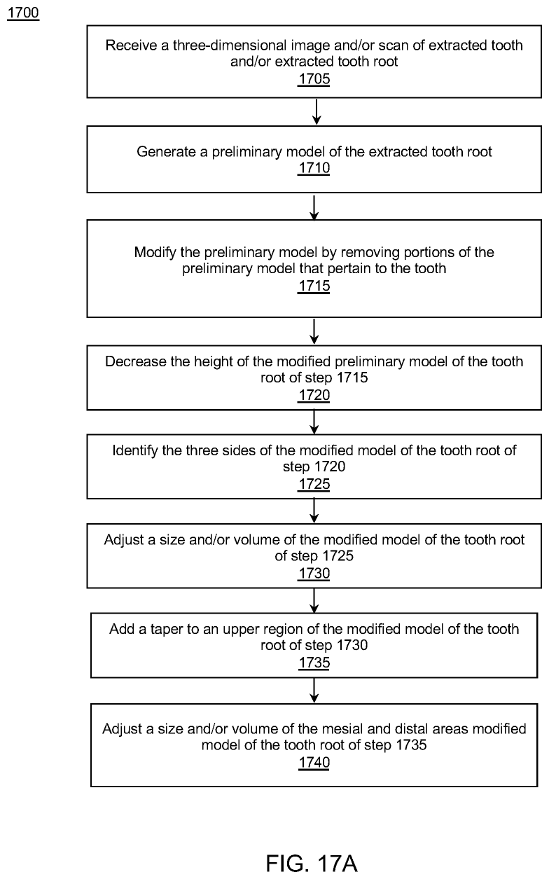

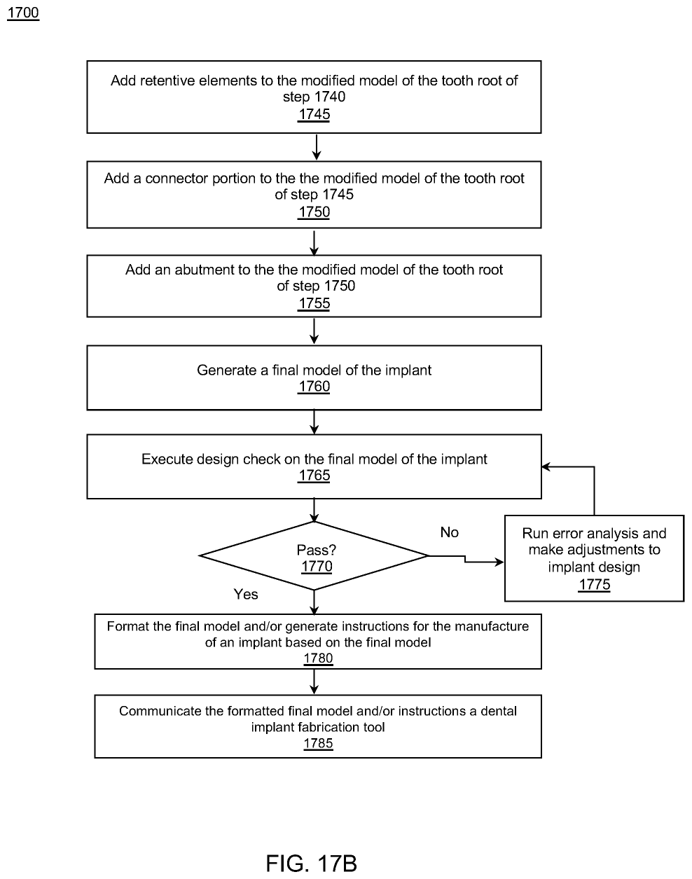

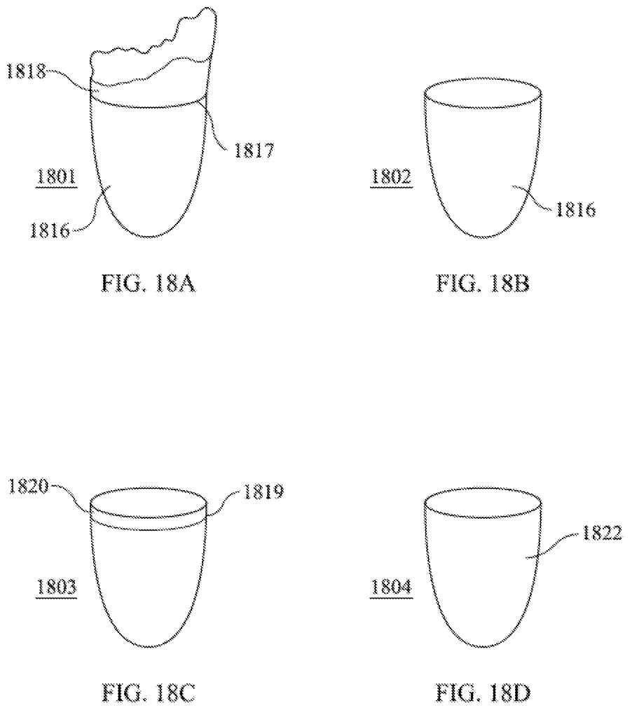

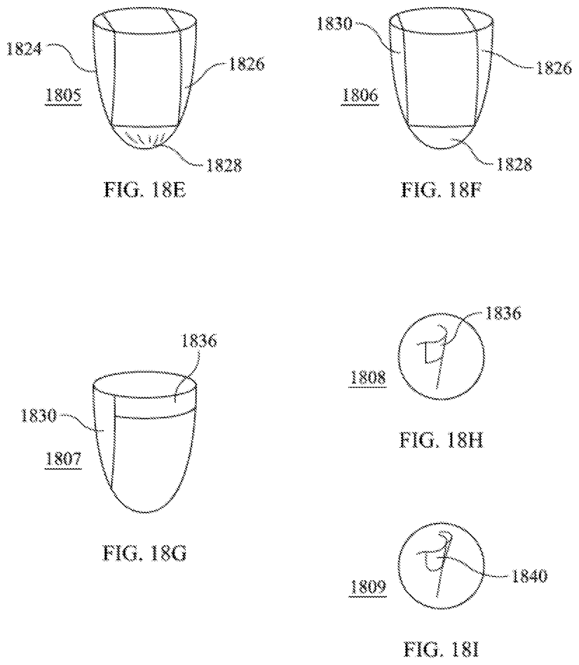

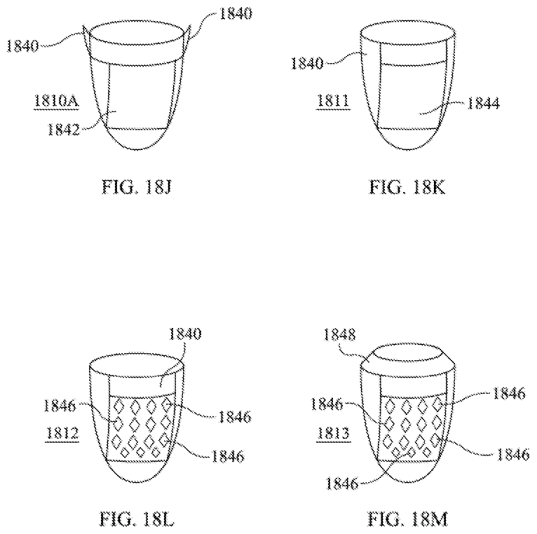

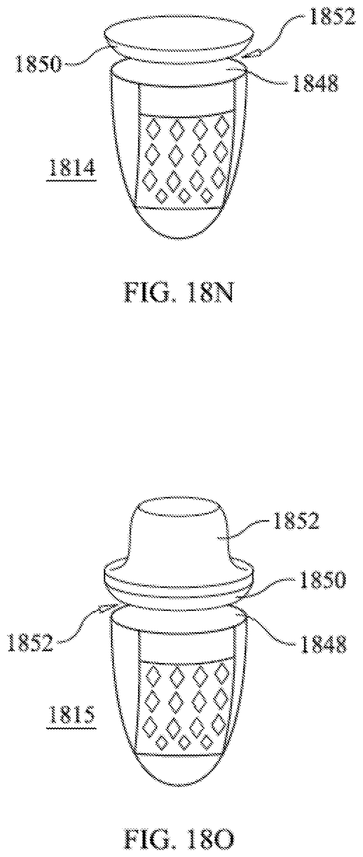

FIGS. 17A and 17B provide a flowchart that illustrates a process 1700 for designing a dental implant. Process 1700 may be executed by, for example, a processor or computer executing a set of instructions stored on a memory in communication with the processor. In some embodiments, process 1700 may incorporate steps of process 1000 as shown in FIG. 10 and discussed above. Additionally, or alternatively, process 1000 may incorporate steps of process 1700. FIGS. 18A-18O and FIGS. 19A, 19B, 20A-20L, 21A, and 21B provide a series of drawings that depict extracted teeth and a series of iterations to a model of a dental implant as may occur during execution of a dental implant design process like process 1700 and will be discussed below with regard to exemplary relevant steps of process 1700.

In step 1705, a three-dimensional image and/or scan of an extracted tooth root, or fractured pieces of an extracted tooth root may be received by, for example, a processor-based system, which in some embodiments may include a processor configured to incorporate a computer-aided design (CAD) module. FIG. 18A provides a front plan view of an exemplary three-dimensional extracted tooth root 1801 that includes a three-dimensional image of an extracted tooth root 1816 and a portion of a crown fragment 1818 of the extracted tooth positioned above root 1816. FIG. 18A shows a root line 1817 demarking where crown fragment 1818 ends, and the tooth root 1816 begins. Root line 1817 is present because the tooth root used to generate three-dimensional tooth root image 1801 was scored, or otherwise marked, by the dentist performing the tooth extraction to delineate where on the tooth the rim of the socket site sits (i.e., a point on the tooth where the crown of the tooth ends and the root begins). In many cases, the dental professional extracting the tooth may score the tooth to be extracted on the facial side of the tooth by using a marker or scoring a dot or line in the root.

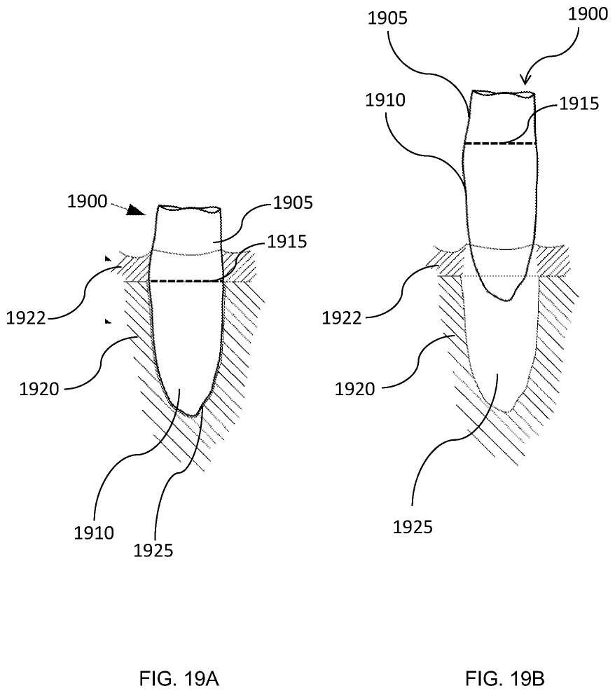

FIG. 19A provides a cross section view of a tooth 1900 to be extracted from a socket site 1925. Tooth 1900 includes a broken crown 1905, a root 1910, and a root line 1915 that marks a location of the rim of socket site 1925 on tooth 1900 that separates crown 1905 from root 1910. FIG. 19A also shows how tooth 1900 fits into a layer of gingiva 1922 positioned above a patient's jawbone 1920 that makes the walls of socket site 1925. FIG. 19B shows tooth 1900 being extracted from socket site 1925 and shows the cavity, or open space, of socket site 1925.

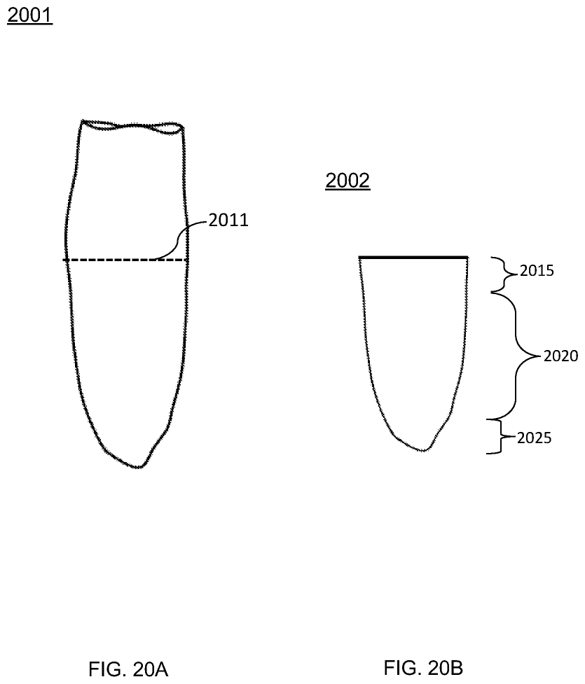

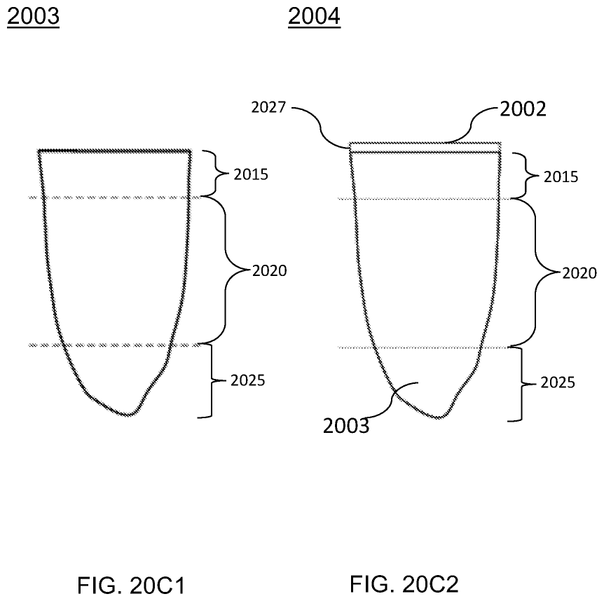

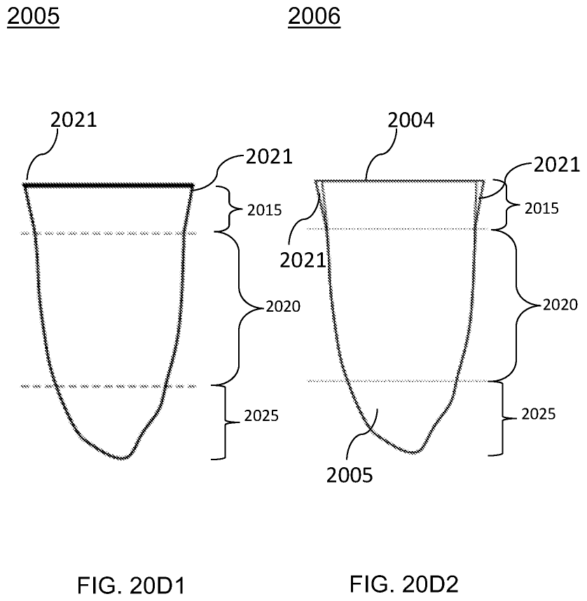

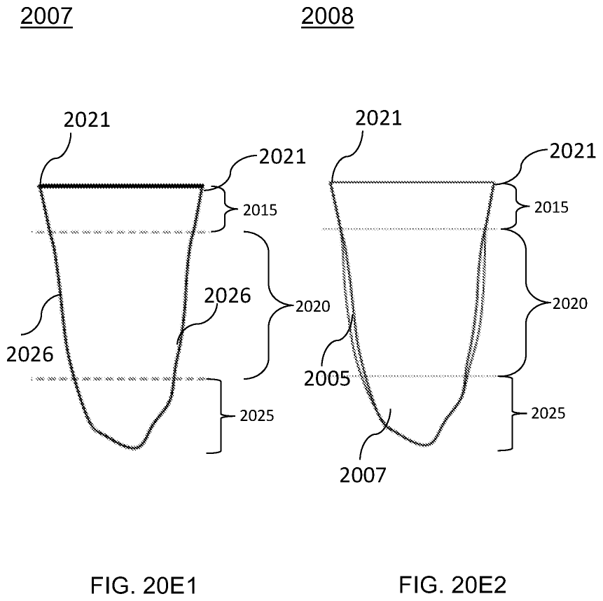

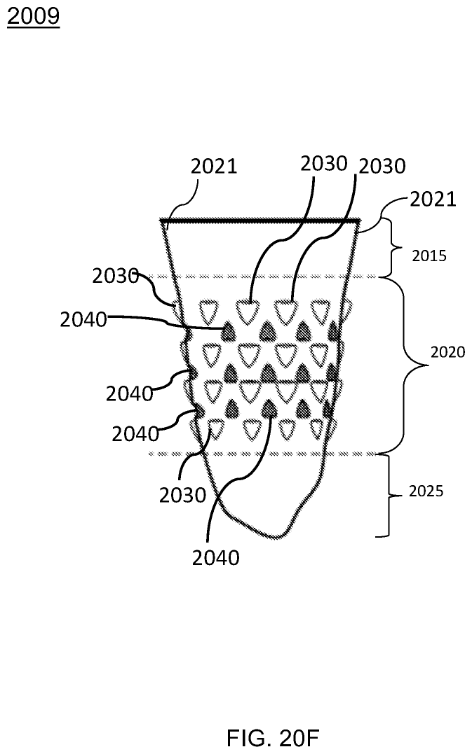

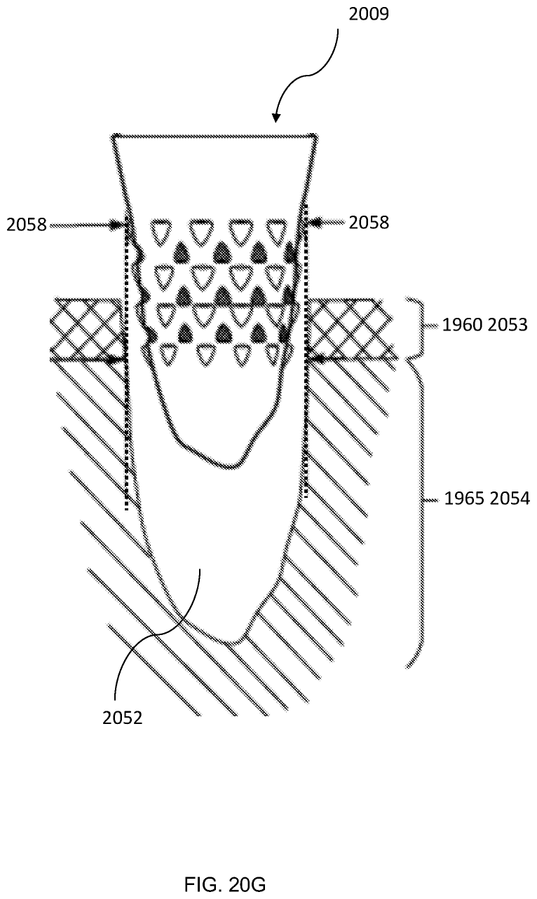

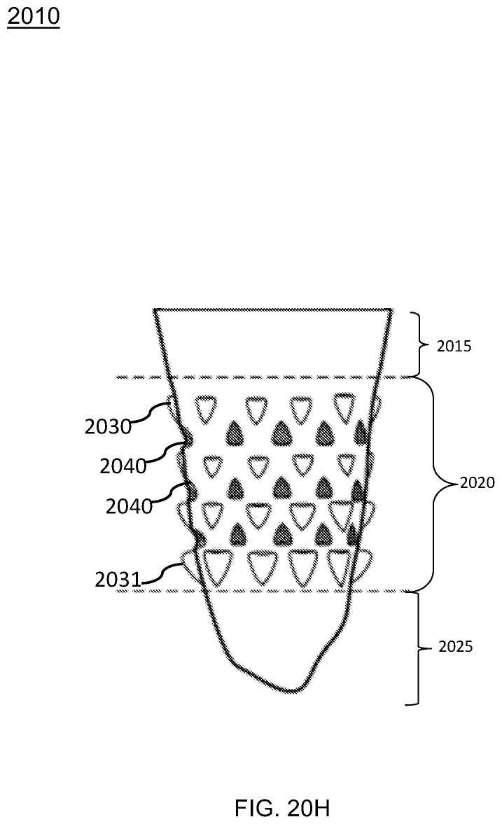

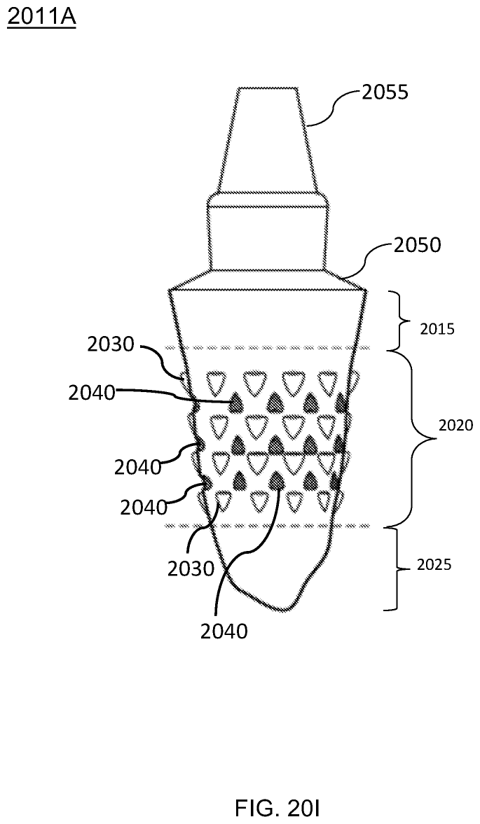

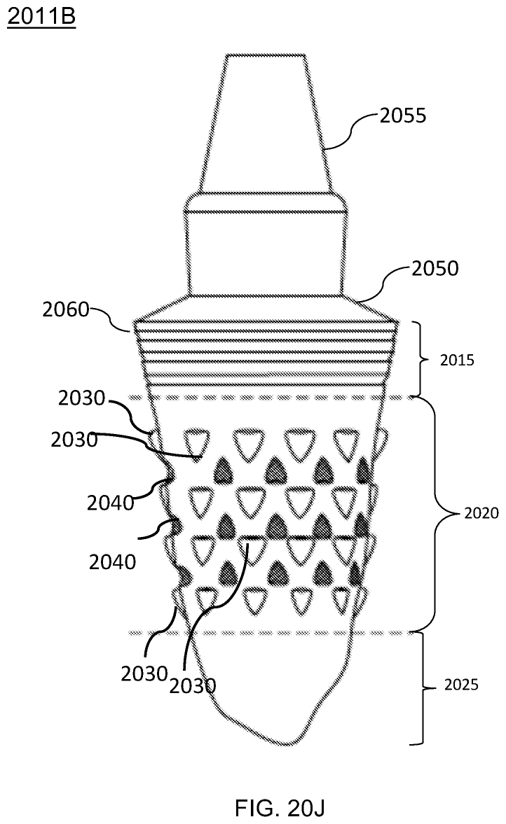

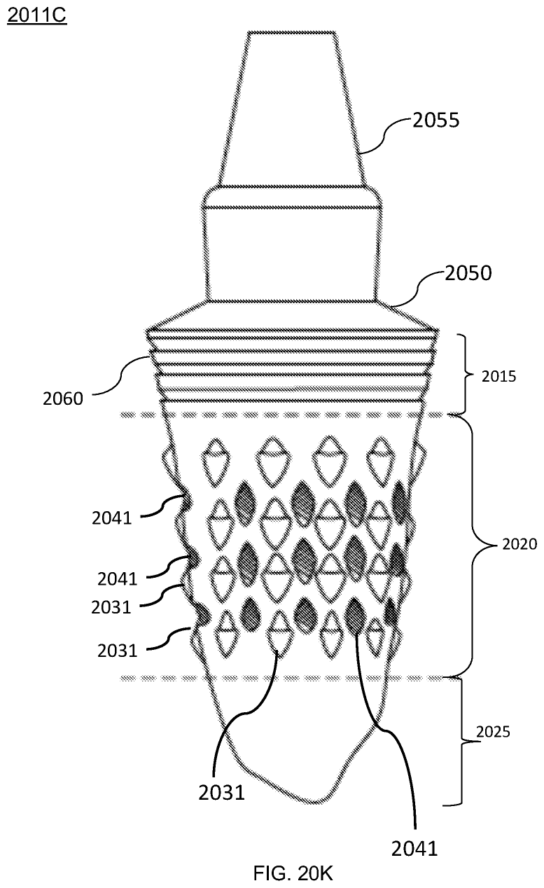

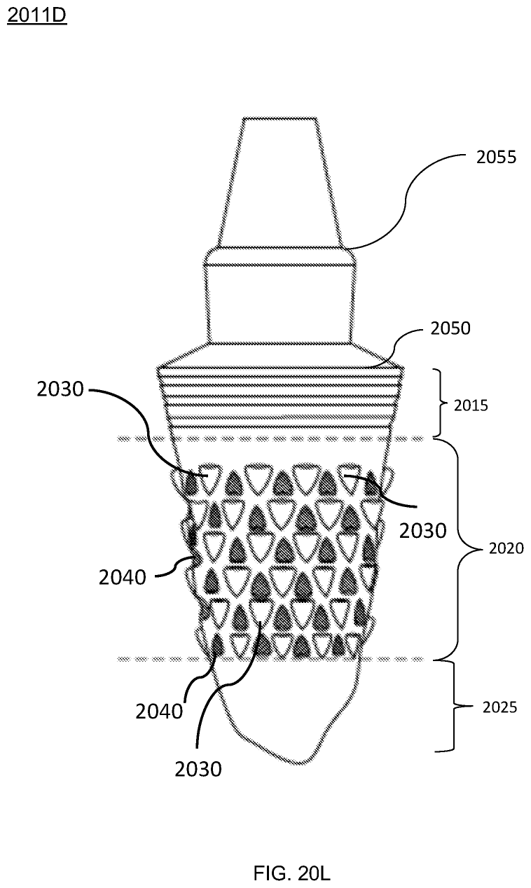

Next, in step 1710, a preliminary model of the extracted tooth root may be generated. In some embodiments, execution of step 1710 may include determining a portion of the three-dimensional image and/or scan received in step 1705 that pertains to the extracted tooth above the tooth root and a portion of the three-dimensional image and/or scan that pertains to the tooth root. For purposes of this disclosure, the tooth root is the portion of the tooth that lies below the rim of the socket site of the jaw bone in its natural state—i.e., when a tooth is in its natural position, the tooth root is the portion of the tooth that extends downward from the top of the jaw bone down to the apical side (or the bottom) of the tooth. In some embodiments, the differentiation between the portion of the three-dimensional image and/or scan that pertains to the root, as opposed to the tooth that extends above the jaw line may be made using an indication (e.g., a scored mark, a marking with a pen or indelible marker, etc.) the extracting dentist places on the native tooth, at the bone line, prior to extraction of the tooth. This indication may be referred to herein as a scoring mark or line. The preliminary model of the extracted tooth root may be modified to remove any, or all, portions of the preliminary model that do not pertain to the tooth root (i.e., remove portions of the preliminary model that reside above the root pertain to the portion of the tooth above the tooth root) (step 1715), thereby generating a modified model of the tooth root. FIG. 18B provides an image of a modified model of the tooth root 1802 where the crown fragment 1818 positioned above root line 1817 has been removed so that modified model of the tooth root 1802 only includes root 1816. Additionally, or alternatively, FIG. 20A provides a plan view of a three-dimensional scan 2001 of tooth 1900 that shows a root line 2011 that corresponds to the position of root line 1915.

In step 1720, a length (i.e., a distance from the bottom to the top of the tooth root) of the modified model of the tooth root of step 1715 may be adjusted by, for example, shortening a length of the modified model of the tooth root by, for example, 0.15 mm to 0.7 mm. Execution of step 1720 may include removing a top portion (e.g., 0.15 mm to 0.7 mm) from the modified model of the tooth root. In some embodiments, step 1720 may be executed in order to accommodate an anticipated change in the height of a socket site in which the implant may reside due to bone (reabsorption) that sometimes takes place following extraction of a native tooth root. FIG. 18C provides an illustration 1803 of the modified model of the tooth root 1816 with a line 1819 indicating the new height of the tooth root (i.e., how much of the top of the tooth root may be removed) via execution of step 1720 with a portion of the tooth root to be removed 1820 shown above line 1819. Additionally, or alternatively, FIG. 20B provides an illustration of a model 2002, which is a modified version of three-dimensional scan 2001 where the portion of the three-dimensional scan that corresponds to the crown portion of tooth 1900 (i.e., the portion of three-dimensional scan positioned above root line 2011) is removed. FIG. 20B also shows a first section 2015, a second section 2020, and a third section 2025 of model 2002. First section 2015 may be similar to first section 115, second section 2020 may be similar to second section 220, and third section 2025 may be similar to third section 115

FIG. 18D provides an illustration 1804 of the modified model 1822 of the tooth root of FIG. 18C with top portion 1820 removed. Additionally, or alternatively, FIG. 20C1 provides an illustration of a model 2003 where the top portion of model 2002 is removed so that a height of first section 2015 is reduced by, for example, 0.15-0.7 mm. FIG. 20C2 provides an image 2004 of modified model 2003 overlaid upon model 2002 so that a difference therebetween may be seen. More specifically, a difference in height 2027 between model 2002 and 2003 is shown by FIG. 20C2.

In step 1725, the individual sides of the modified model of the tooth root of step 1720 may be identified. The individual sides may be, for example, a facial/buccal side, a lingual side, and a root tip/apical area, which may correspond to the lowest portion of the modified model of the tooth root (e.g., lowest 1.5-4 mm of the tooth root). In some embodiments, the root tip/apical area may correspond to third section 125. FIG. 18E provides an illustration 1805 of a facial/buccal side of the modified model of the tooth root of FIG. 18D 1824, a lingual side of the modified model of the tooth root of FIG. 18D 1826, and a root tip/apical area of the modified model of the tooth root of FIG. 18D 1828.

In step 1730, a size, cross-sectional area, and/or volume of modified model of the tooth root of step 1725 may be modified in order to, for example, reduce a width and/or cross-sectional diameter of the modified model of the tooth root by reducing the width of the three-dimensional image and/or scan of an extracted tooth root by removing, for example, 0.3-0.7 mm from the edge of the facial/buccal side towards the center of the implant. In some embodiments, this adjustment may be made by moving the facial/buccal edge inward by, for example, 0.3-0.7 mm thereby reducing the overall volume, width, and cross-sectional area of the tooth root. As an example of how step 1730 may be executed, FIG. 18F provides an illustration 1806 of how the exterior surface of the facial side of the modified model of the tooth root of FIG. 18E 1824 is pushed inward to create a modified exterior surface of the facial side 1830 that acts to reduce the overall volume of the modified model of the tooth root of FIG. 18E. Such a reduction in overall volume may be useful in reducing pressure on the socket site generally, and in particular, at a region of the socket site corresponding to the reduced-volume side (e.g., the facial/buccal side). For example, bone density of the jawbone may be less on the facial side, and prolonged application of force (as created by the presence of the implant) may result in irritation, damage, and/or inflammation as the implant pushes against the bone in the socket site. Reducing the volume of the implant on the facial side may help prevent or alleviate these symptoms.

Following execution of step 1730, a profile, or exterior edge, of the facial/buccal side, the lingual side, and/or root tip/apical area of the modified model of the tooth root generated via execution of step 1730 may be locked to, for example, prevent further changes thereto. As these areas have not yet been modified during the execution of process 1700, when they are locked, they will retain their original shape and may thereby mimic the shape of the extracted tooth and when an implant is manufactured using the model of the extracted tooth root, these areas of the implant may provide direct contact points between the implant and the socket site. In some embodiments, these areas of direct contact may assist a practitioner (e.g., dentist) with proper placement and seating of the implant is placed in the socket site. In some instances, when, for example, the lingual side of the model of the implant (and the corresponding manufactured implant) is unmodified, but the buccal/facial side of the model of the implant is modified in, for example, step 1730, the practitioner may be able to determine which side of the manufactured implant is the buccal/facial side because the practitioner will see that the lingual side is unaltered, and the buccal/facial side is altered (due to, for example the adjustments of step 1730). Should further changes to one or more portions of the areas of the modified model of the tooth root be desired, the respective area may be unlocked to allow modification, or adjustment, thereto.

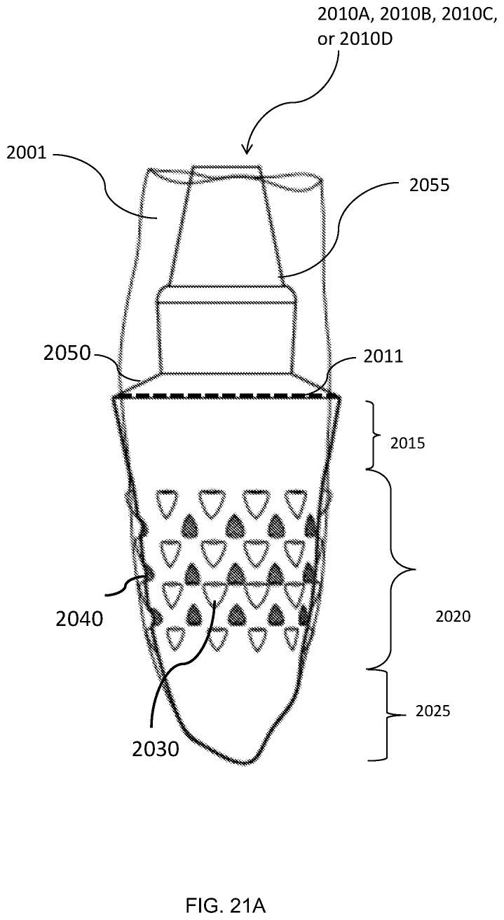

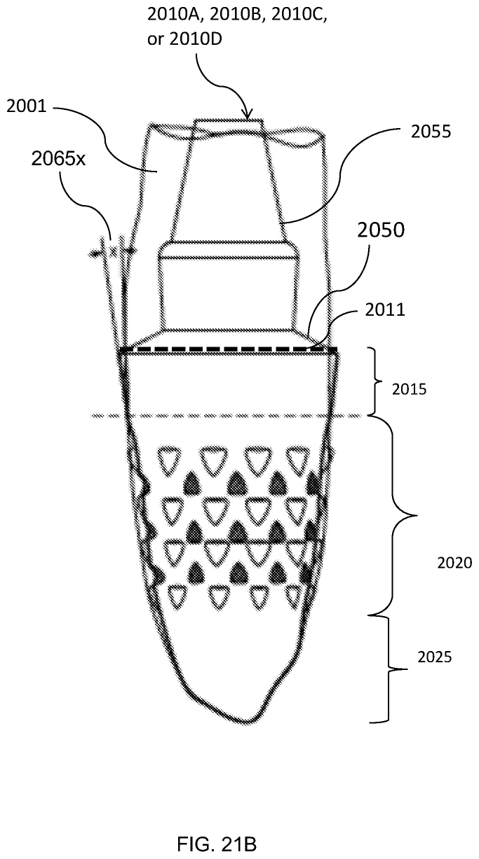

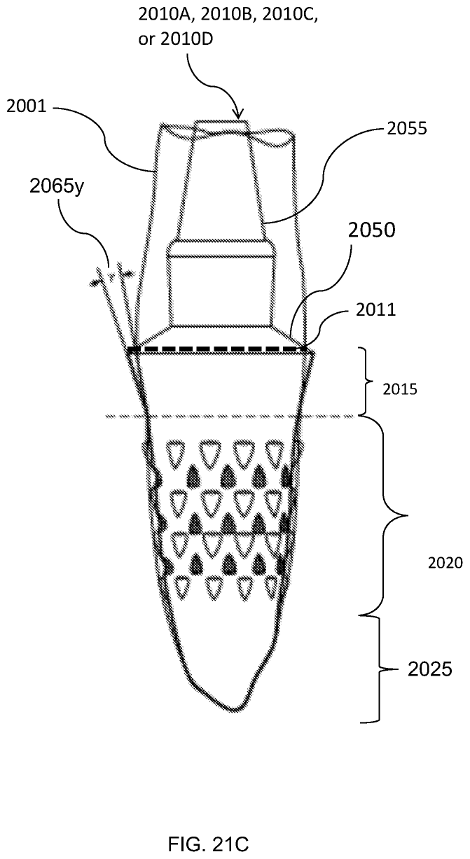

In step 1735, a cortical taper may be added to an upper portion of the modified model of the tooth root of step 1730. FIG. 18G provides a front plan illustration 1807 of the modified tooth root model of FIG. 18F that includes a delineation for a location 1836 on the model where a cortical taper may be added. FIG. 18H provides a side view 1808 of the modified tooth root model of FIG. 18F shown in FIG. 18G that shows cortical taper location 1836 and FIG. 18I provides a side view 1809 that shows a cortical taper 1840 added to the exterior upper portion of the modified tooth root model of FIG. 18F. In some embodiments, the cortical taper added in step 1735 may be similar to the cortical taper of first section 115 as shown in, for example, FIG. 4A. Additionally, or alternatively, FIG. 20D1 provides an illustration a model 2005, which is a version of model 2003 that has been modified to include a cortical taper to an exterior surface of first section 2015. FIG. 20D2 provides an illustration of model 2005 overlaid upon model 2004 so that a difference therebetween may be seen. The difference shown in FIG. 20D2 is how the exterior shape of model 2004 changes with the addition of cortical taper 2021. Additional information regarding the design and checks of a designed taper of the cortical taper is provided with regard to FIGS. 21A and 21B.

In step 1740, an exterior edge of the remaining mesial and distal areas of the modified model of the tooth root of step 1735 positioned below the cortical taper may be moved inward by, for example, 0.1 mm to 0.5 mm so that a volume of the remaining mesial and distal areas may be reduced by, for example, 3-5%. FIG. 18J provides a front plan view 1810A of where on the modified tooth root model of FIG. 18I the mesial or distal area 1842 of the modified tooth root model is located. FIG. 18K provides an illustration 1811 that shows a front plan view of a modified mesial or distal side of the tooth root model 1844 that is pushed inward so that the overall volume of the modified model for the tooth root is reduced. Also, it is noted that FIGS. 18J and 18K, only show one side of the modified model of the tooth root (i.e., either the mesial side or the distal side), but the disclosure contemplates that both sides (i.e., both mesial and distal sides) of the modified model may be similarly caused to be moved inward. For example, FIGS. 18J and 18K may be showing the mesial side, but it is to be understood that the distal side may also be moved inward. In some embodiments the mesial and distal areas that are moved inward may correspond to mesial and distal areas of second section 120. In some cases, execution of step 1740 may serve to create space between a fully inserted implant manufactured using the model and the socket site so that there may be blood flow between the manufactured implant and the socket site. This blood flow may reduce healing times and aid in the osteointegration, or bonding, of the manufactured implant to the socket site.

Additionally, or alternatively, FIG. 20E1 provides an image of a model 2007 where the shape of mesial and distal sides 2026 of model 2005 are modified and pushed inward thereby reducing the overall volume of second section 2020 of model 2005. FIG. 20E2 provides an image of model 2007 and 2005 overlaid upon one another so that differences therebetween may be seen. The difference between model 2005 and 2007 is that the width and cross-sectional volume of second section 2020 is reduced as may be seen in FIG. 20E2.

In step 1745, one or more retentive elements, like retentive elements 205 described above, may be added to an exterior surface of the modified model of the tooth root of step 1740. The retentive elements may be added to a portion of the modified model of the tooth root that corresponds to second section 120 of an implant. In some cases, the retentive elements may be added to the mesial and distal areas of the modified model of the tooth root of step 1740 and may be positioned below the cortical taper as shown in, for example, FIGS. 18L-18O where a plurality of retentive elements 1846 are shown as diamonds. The modified model of the tooth root of step 1740 may be a model used to generate a root portion of an implant such as root portions 710, 110, 111, 301, 302, and/or 440. FIG. 20F provides an image of a model 2009 with projecting retentive elements 2030 and depressing retentive elements 2040 (also referred to herein as divots or depressions) have been added to second section 2020 of model 2007. A pattern of four rows of projecting retentive elements 2030 alternates with three rows of divots 2040 and retentive elements 2030 and divots 2040 have a shape that resembles the shape of retentive elements/divots 205c and/or 205d.

In some embodiments, execution of step 1745 may include analysis of socket site 1925 in order to determine, for example, the dimensions (e.g., diameter, radius, circumference, position of irregular shapes within the opening, etc.) of the opening or top of socket site 1925 so that dimensions and/or configurations of projecting retentive elements 2030 and/or divots 2040 may be selected for addition to the surface of, for example, model 2007 and/or 1811 in a manner that accommodates the size and shape of the opening at the top of the socket site so that, for example, an implant with projecting retentive elements 2030 and/or divots 2040 will be able to pass through the opening of the socket site without damaging the bone at the rim of the socket site. For example, execution of step 1745 may include determining a line of draw 2058 for a socket site model 2052 as shown in FIG. 20G. Socket site model 2052 may be configured to correspond to a three-dimensional scan of the extracted tooth and, more particularly, to the portion of three-dimensional tooth scan positioned at, and below, tooth root line 2011 as shown in, for example, FIG. 20B. Socket site model 2052 shown in FIG. 20G includes a modeled layer of cortical bone 2053 and a modeled layer of cancellous bone 2054. In some cases, modeling of the socket site and/or one or more layers of the socket site may be done using three-dimensional tooth scan, an impression of the socket site take after removal of the tooth, and/or analysis of an image (e.g., MRI, X-ray, and/or CT scan) of the patient's mouth and/or jaw taken prior to, and/or following, extraction of the tooth.

Once the line, or lines, of draw are determined for the socket site model, one or more projecting retentive elements 2030 (particularly projecting retentive elements 2030 positioned near the interface of first and second sections 2015 and 2020) may be selected and/or configured so that they fit within the lines of draw 2058 and will not scratch or damage cortical bone 1960 positioned at the rim of socket site model 2052 when the implant is inserted into socket site 1925 and may engage with cancellous bone 1965 when seated within socket site 1925.

Additionally, or alternatively, execution of step 1745 may include determining a line of draw 2058 for socket site 1925 as shown in FIG. 20H and then selecting and/or configuring projecting retentive elements 2030 (particularly projecting retentive elements 2030 positioned near the interface of second and third sections 2020 and 2025) so that they fit within the lines of draw 2058, will not scratch or damage cortical bone 1960 positioned at the rim of socket site 1925 when the implant is inserted into socket site 1925, and may be large enough to engage with cancellous bone positioned toward the apex of the socket site when seated within socket site 1925. For example, FIG. 20I provides a model 2011A that has projecting retentive elements 2030 of varying sizes, wherein a first and second row of projecting retentive elements 2030 are relatively small, a third row of projecting retentive elements 2030 that are larger than the projecting retentive elements 2030 of the first two rows of projecting retentive elements 2030, and a fourth row of projecting retentive elements 2030 that are the largest projecting retentive elements 2030 of model 2011A. Model 2011A may be used for socket sites that are larger at the opening (corresponding to first section 2015) than at the apex or bottom of the model (corresponding to third section 2025). In these situations, the larger opening of the socket site may accommodate insertion of an implant with larger projecting retentive elements 2030 positioned in the third section 2025 without disruption of the bone of the socket site. Further details regarding projecting retentive elements 2030 and divots 2040 are provided below with regard to FIGS. 20I-20L.

In step 1750, a connector portion, like connector portion 407, may be added to the top (coronal) portion of the modified model of the tooth root of step 1745 above the root line. The connector portion may be configured to reside above the rim of the socket site when the manufactured implant is inserted into the socket site but, below the gum line. In some cases, the connecter portion may be added to the three-dimensional image and/or scan of an extracted tooth root by adding (or extruding) a lower connector section that is approximately 0.5-1.5 mm in height to the top of the three-dimensional image and/or scan of an extracted tooth root that is constricted over its length by 0.5-1 mm along the length (e.g., a cross-sectional area of the lower connector section may be gradually reduced along its length from a bottom of the lower connector section to a top of the lower connection section). An exemplary lower connector section of a connector portion is shown FIG. 4A, as reference number 408 and in FIG. 18M-18O as reference number 1848. A first section of the connector portion may be added and positioned on top of the lower portion of connector portion. The first section of the connector portion may extend approximately 0.5-1.5 mm in height above the upper edge of the third section as shown in, for example, FIGS. 18N and 18O as reference number 1850 and/or as reference number 409 in FIG. 4A. The first section may expand outwards along its length (e.g., a cross-sectional area of the upper connector section may be gradually increased along its length from a bottom of the upper connector section to a top of the upper connection section) by, for example, 0.5-1.5 mm along its height thereby generating a sideways oriented “v” shaped depression. An exemplary sideways oriented “v” shaped depression 415 is shown in FIG. 4A and may be seen in FIGS. 18N and 18O as reference number 1852. In some embodiments, the connector portion may be configured so that it enables a “platform switching” effect. Alternatively, the connector portion may be designed by extending the top of the three-dimensional image and/or scan of an extracted tooth root by, for example, 1-3 mm in a cylinder-like manner and then constricting a portion of the cylinder in between the top and bottom of the cylinder (e.g., to create a sideways “v”-like shape).

In step 1755, an abutment, like abutment 410, may be added to the top of the connector portion of the modified model of the tooth root of step 1750. Another exemplary abutment 1852 is shown in FIG. 18N. In some embodiments, the abutment may be a margin for a crown that may be positioned on top of the implant when it is inserted into the socket site. In some cases, the abutment may be a predesigned chamfer shape of an appropriate size (e.g., cross-sectional area, height, etc.). In some cases, a height for the abutment may be selected using information (e.g., height of teeth adjacent to the extracted tooth, chewing habits of the patient who had his or her tooth extracted, strength or thickness of bone making up the socket site, and/or whether the patient has gum disease) provided by a dental professional (e.g., the dental professional who extracted the tooth). Additionally, or alternatively, the height of the abutment may be selected using a model, impression, and/or scan of the patient's full mouth prior to the extraction.

Another exemplary connector portion 2050 and abutment 2055 is shown in FIG. 20I, which provides an illustration of model 2011A, which is one example of a final model that may be used to generate a corresponding implant. Model 2010A includes model 2009 with connector portion 2050 and abutment 2055. A lower (as shown in FIG. 20I) edge of connector portion 2050 may be configured to sit below a rim of socket site 1925. Abutment 2055 may be shaped and configured to cooperate with a crown or other restorative device (not shown) that may replace the extracted tooth above the rim of the socket site. In some embodiments, abutment 2055 may be configured to couple to and/or cooperate with a carrier/mount like carrier/mount 530 (not shown) that may, for example, facilitate handling of the implant by a dental professional who, for example, removes the implant from packaging and/or inserts the implant into a socket site.

In step 1760, a final model of the implant may be generated using the modified model of the tooth root of step 1755. Step 1760 may include additional finalization steps for generating complete model of the implant (e.g., converting the modified model into an appropriate format for fabrication). In some embodiments, step 1760 may be optional, and the method may skip from step 1755 to step 1765 (e.g., with the modified model of step 1755 being the final model).

An exemplary final model implant 2011A is shown in FIG. 20I, discussed above. Additional exemplary final implant models 2011B-2011D are provided by FIGS. 20J-20L, some of which show implant models with ridges on an exterior surface of first section 2015 and different shapes, sizes, and arrangements of projecting retentive elements and divots and combinations thereof. More particularly, FIG. 20J provides a model 2011B that is similar to model 2011A except that model 2011B has set of ridges 2060 that project out from the exterior surface of first section 2015. Set of ridges 2060 may be configured to engage with the bone at the rim of the socket site in order to, for example, anchor the implant in the socket site and/or form a tight seal between the implant and the top of the socket site in order to, for example, prevent bacteria and other particles from entering the socket site. Set of ridges 2060 may have any appropriate number (e.g., 1-8) of ridges and the ridges may project, for example, 0.1-2 mm from the exterior surface of first section 2015. FIG. 20K is an illustration of final implant model 2011C, which shows projecting retentive elements with four rows of three-dimensional diamond-shaped projecting retentive elements 2031 and three rows of oval-shaped divots 2041 positioned between the rows of three-dimensional diamond-shaped projecting retentive elements 2031. FIG. 20L is an illustration of final implant model 2011D, which shows projecting retentive elements with six rows of projecting retentive elements 2030 interleaved with divots 2040 in an alternating pattern across each row.

In step 1765, a design check of the final model implant may be performed to determine whether the implant is appropriately designed. Execution of the design check may include, for example, comparison of the final model of the dental implant to the original three dimensional image and/or scan of the extracted tooth root, comparison of the final model of the dental implant to design parameters for dental implants, and/or comparison of the final model dental implant to an image, a three-dimensional scan, and/or impression of the socket site from which the tooth root was extracted. In some embodiments, the design check may involve steps to determine whether the implant will function appropriately, have, for example, adequate surface area for osseointegration and/or adequate strength (e.g., for durability and functionality). For example, the design check may include comparing parameters of the final model against standards set by a regulatory agency such as the U.S. Food and Drug Administration (FDA). For example, the design check may include comparing a surface area of a tooth root portion of the final model and/or the strength of the implant at different points (e.g., which may be mathematically modeled) against standards specified by the FDA.

If the final model does not pass the design check (step 1770), an error analysis of the final model may be run so that adjustments may be made to the final model (step 1775) and step 1765 may be executed again. If the final model does pass the design check (step 1770), the final model may be formatted for manufacturing (step 1780). In some embodiments, execution of step 1780 may also include generation of one or more instructions for the manufacture of the implant based on the final model. In some cases, execution of step 1780 includes translating the final model into CAM software for communication to a manufacturing device (e.g., a milling device, CNC machine, and/or three-dimensional printer). In some embodiments, the CAM software may be machining software that creates the milling protocols for the drills to make an implant based on the final model. In some embodiments, execution of step 1780 may include receiving, or adapting, the instructions to generate the implant based on a material (e.g., titanium or other biocompatible material) and/or a shape of a material (e.g., a rod, cube, and/or pre-milled stock) used to manufacture the implant and, in some cases, the model may be digitally, or virtually, placed within the material (i.e., the final model may be superimposed on a digital model of the stock material that will be used to generate the implant) in order to, for example, determine if the material is the right shape and/or size for milling, or otherwise fabricating, the implant.

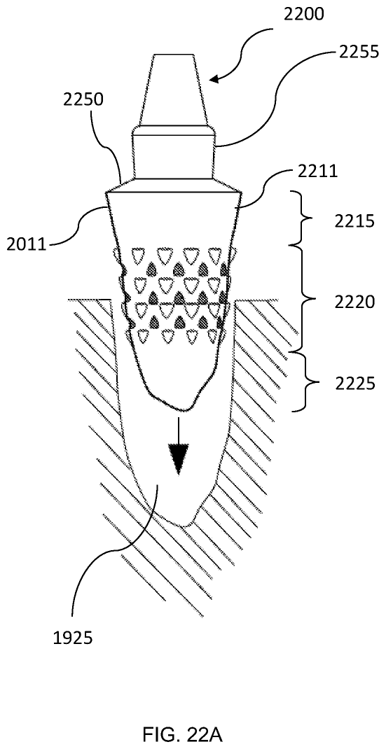

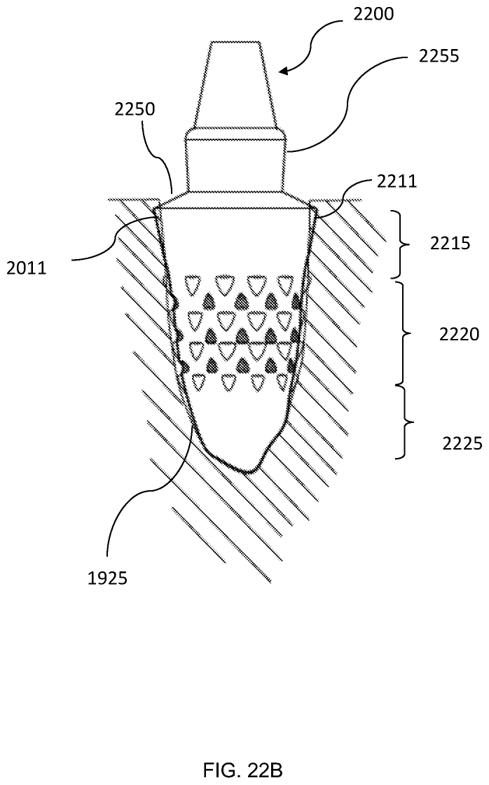

FIGS. 22A and 22B provide a series of cross sectional views of a progression for placement for an implant 2200 generated via execution of process 1700 into socket site 1925. Implant 2200 includes a first section 2215, which corresponds to first section 2015 of one of the models disclosed herein, a second section 2220, which corresponds to second section 2020 of one of the models disclosed herein, and a third section 2225, which corresponds to third section 2025 of one of the models disclosed herein. First section 2215 of implant 2200 includes a taper 2211 that corresponds to a taper 2011 of one of models disclosed herein, a connector portion 2250 that corresponds to a connector portion 2050 of one of the models disclosed herein, and an array of projecting retentive elements 2230 and depressed retentive elements (i.e., divots) 2240, which correspond to projecting retentive elements 2030 and divots 2040 of the models disclosed herein.

In FIG. 22A, implant 2200 is positioned partially within socket site 1925. FIG. 22B shows implant 2200 fully seated in socket site 1925 with cortical taper and projecting retentive elements engaged with, and pressing up against, the walls of socket site 1925. In some instances, fully seating implant 2200 in socket site 1925 may be done with the aid of an implant insertion tool like implant insertion tool 500. In these instances, implant 2200 may be manually placed into socket site 1925 by a dental professional using, for example, a carrier/mount like carrier mount 530, and pushed partially into socket site 1925 until, for example, natural resistance of the socket site is met. Then, the dental professional may apply energy (e.g., ultrasonic energy) from implant insertion tool 500 to abutment 2055 which may vibrate implant 2200 so that it may be pushed fully into the socket site as shown in FIG. 22B.

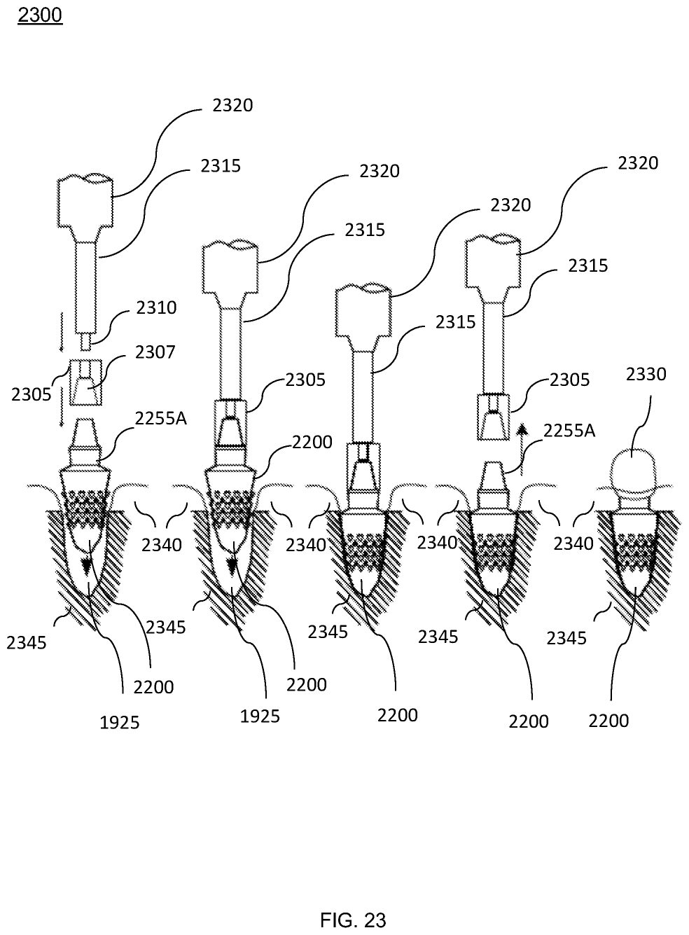

FIG. 23 illustrates a five-part process 2300 to place implant 2200 into a layer of gingiva 2340 and socket site 1925 using a carrier/mount 2307. Carrier/mount, may be configured to cooperate with (e.g., fit over) an abutment portion 2255A of implant 2200 and may be further configured to cooperate with a post 2310, which is attached to a handpiece 2315 of an implant insertion tool (not shown) like implant insertion tool 500 by way of a recess 2307 shaped, configured, and positioned for acceptance of post 2310 and abutment portion 2255A.

In step 1 of FIG. 23, implant 2200 may be placed (e.g., manually) with in socket site 1925 and carrier/mount 2305 and post 2310 may be aligned for insertion into socket site 1925. In step 2, carrier/mount 2305 may be placed over top of abutment portion 2255A so that the portion of recess 2307 configured to accept insertion of abutment portion 2255A covers all, or a portion of, abutment portion 2255A. Post 2310 may be inserted into a portion of recess 2307 configured for acceptance of post 2310. In step 3, implant insertion tool may deliver vibrations and/or one or more impacts over time to post 2310, which may be transferred to carrier/mount 2305 and implant 2200 thereby driving implant 2200 fully into socket site 1925. In step 4, carrier/mount 2305 and post 2310 may be removed from implant 2200 and in step 5, a crown 2330 may be placed on top of abutment 2255A.

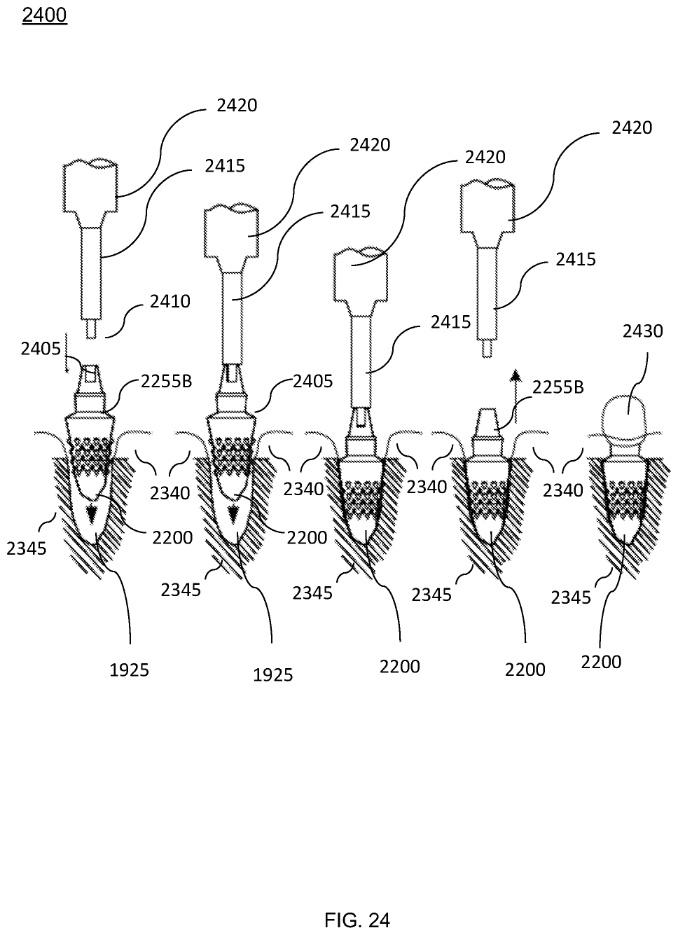

FIG. 24 illustrates a five-part process 2400 to place implant 2200 into a layer of gingiva 2340 and socket site 1925 using a recess 2405 in abutment configured for acceptance of post 2310 instead of using a carrier/mount 2307 to seat implant 2200 in the socket site.

In step 1 of FIG. 24, implant 2200 may be placed (e.g., manually) with in socket site 1925 and post 2310 may be aligned for insertion into recess 2405. In step 2, post 2310 may be inserted into recess 2405 and, in step 3, implant insertion tool may deliver vibrations and/or one or more impacts over time to post 2310, which may be transferred to abutment 2255B thereby driving implant 2200 fully into socket site 1925. In step 4, post 2310 may be removed from recess 2405 and in step 5, a crown 2430 may be placed on top of abutment 2255B. In some cases, placing of crown 2430 may include filling in recess 2405 with a corresponding extension provided by crown 2430 and/or using a compound (e.g., cement) to fill in recess 2405.

1. A dental implant designed using a three-dimensional scan of an extracted tooth root, the three-dimensional scan of the extracted tooth root including a horizontally-oriented edge that is at the same level as a rim of a socket site from which the tooth root was extracted, the socket site comprising bone the tooth is extracted from and not including gingiva, wherein the socket site is unmodified following extraction of the tooth, the dental implant comprising:
a first section having a size and shape defined by a shortened first portion of the three-dimensional scan of the extracted tooth root so that a horizontally-oriented edge of the first section that corresponds to the horizontally-oriented edge of the first portion of the three-dimensional scan is recessed below the rim of the socket site when the dental implant is fully seated within the socket site, a degree of recessing of the horizontally-oriented edge of the first portion being configured to anticipate bone loss proximate to the rim of the socket site during recovery from extraction of the tooth root from the socket site, the first section corresponding to a region of the extracted tooth root that is proximate to the rim of the socket site;
a second section defined by a second portion of the three-dimensional scan of the extracted tooth root, the second portion of the three-dimensional scan being positioned between the shortened first portion and a third portion of the three-dimensional scan; and
a third section having a size and shape defined by the third portion of the three-dimensional scan of the extracted tooth root, the third portion corresponding to an apex of the extracted tooth root, wherein the dental implant is fully seated in the socket site via pushing the dental implant into the socket site until an apex of the third section is positioned proximate to a corresponding apex of the socket site.

2. The dental implant of claim 1, further comprising:
a plurality of retentive elements positioned on an exterior surface of the second section.

3. The dental implant of claim 1, wherein an exterior surface of the first section has a taper along the length of the first section with a largest circumference of the first section occurring proximate to the horizontally-oriented edge of the first section.

4. The dental implant of claim 1, wherein the shortened first portion of the three-dimensional scan of the extracted tooth root corresponds to the shortened first section of the three-dimensional scan, wherein the shortened first portion of the three-dimensional scan has had at least 0.05 mm in length removed from a portion of the three-dimensional scan proximate to the rim of the socket site.

5. The dental implant of claim 1, wherein the second section has a circumference that is 3-7% smaller than the second portion of the three-dimensional scan of the extracted tooth root.

6. The dental implant of claim 1, wherein the third section is configured to have a size and shape substantially similar to the third portion of the three-dimensional scan of the extracted tooth root.

7. The dental implant of claim 1, wherein the third section is configured to have a circumference that is 0.1-7% smaller than the third portion of the three-dimensional scan of the extracted tooth root.

8. The dental implant of claim 1, further comprising an abutment section configured to attach to a carrier/mount, the carrier/mount being configured to attach to an implant insertion tool configured to vibrate the dental implant as the dental implant is inserted into a socket site of a patient from which the tooth was extracted.

9. The dental implant of claim 1, wherein a length of the first section is in the range of 2-4 mm.

10-17. (canceled)

18. A dental implant root section, the dental implant root section being configured, sized, and shaped to fit within an unmodified socket site from which a tooth has been extracted when the dental implant root section is pushed into the unmodified socket site and fully seated within the unmodified socket site, wherein a horizontal edge of the dental implant root section proximate to the rim of the unmodified socket site is recessed within the unmodified socket site below the rim of the unmodified socket site when the dental implant root section is fully seated in the unmodified socket site, a degree of recessing of the horizontally-oriented edge of the first portion being configured to anticipate bone loss proximate to the rim of the socket site during recovery from extraction of the tooth root from the socket site and the unmodified socket site not including gingiva.

19. The dental implant root section of claim 18, wherein the horizontal edge of the dental implant is recessed at least 0.05 mm below the rim of the unmodified socket site.

20. The dental implant root section of claim 18, wherein an exterior surface of a section of the dental implant root section proximate to the horizontal edge of the dental implant root section has a taper that extends along a portion of a length of the dental implant root section.

21. The dental implant root section of claim 18, further comprising an abutment section configured to attach to a dental crown.

22. The dental implant root section of claim 18, further comprising an abutment section configured to attach to a carrier/mount, the carrier/mount being configured to attach to an implant insertion tool configured to vibrate the dental implant as the dental implant is inserted into a socket site of a patient from which the tooth was extracted when seating the dental implant root section and abutment within the unmodified socket site.

23. The dental implant root section of claim 18, wherein an exterior surface of the first section includes at least one groove positioned on the exterior surface of the first section, the at least one groove being positioned and configured to engage with bone positioned proximate to the rim of the socket site when the dental implant is resident within the socket site.

24. The dental implant of claim 1, wherein an exterior surface of the first section includes at least one groove positioned on the exterior surface of the first section, the at least one groove being positioned and configured to engage with bone positioned proximate to the rim of the socket site when the dental implant is resident within the socket site.

25. A dental implant designed using a three-dimensional scan of an extracted tooth root, the three-dimensional scan of the extracted tooth root including a horizontally-oriented edge that is at the same level as a rim of a socket site from which the tooth root was extracted, the socket site comprising bone the tooth is extracted from and not including gingiva, wherein the socket site is unmodified following extraction of the tooth, the dental implant comprising:
a first section having a size and shape defined by a shortened first portion of the three-dimensional scan of the extracted tooth root so that a horizontally-oriented edge of the first section that corresponds to the horizontally-oriented edge of the first portion of the three-dimensional scan is recessed below the rim of the socket site when the dental implant is fully seated within the socket site, an exterior surface of the first section including at least one groove positioned on the exterior surface of the first section, the at least one groove being positioned and configured to engage with bone positioned proximate to the rim of the socket site when the dental implant is resident within the socket site, the first section corresponding to a region of the extracted tooth root that is proximate to the rim of the socket site;
a second section defined by a second portion of the three-dimensional scan of the extracted tooth root, the second portion of the three-dimensional scan being positioned between the shortened first portion and a third portion of the three-dimensional scan; and
a third section having a size and shape defined by the third portion of the three-dimensional scan of the extracted tooth root, the third portion corresponding to an apex of the extracted tooth root, wherein the dental implant is fully seated in the socket site via pushing the dental implant into the socket site until an apex of the third section is positioned proximate to a corresponding apex of the socket site.

26. The dental implant of claim 25, wherein the horizontal edge of the dental implant is recessed at least 0.05 mm below the rim of the unmodified socket site.

27. The dental implant of claim 25, wherein an exterior surface of a section of the dental implant root section proximate to the horizontal edge of the dental implant root section has a taper that extends along a portion of a length of the dental implant root section.

28. The dental implant of claim 25, further comprising an abutment section configured to attach to a dental crown.

29. The dental implant of claim 25, wherein an exterior surface of the first section includes at least one groove positioned on the exterior surface of the first section, the at least one groove being positioned and configured to engage with bone positioned proximate to the rim of the socket site when the dental implant is resident within the socket site.
